(19) United States
(12) Patent Application Publication
(10) Pub. No.: US 2025/0209911 A1
(43) Pub. Date: Jun. 26, 2025

(54) SYSTEMS AND METHODS FOR TRAINING AND OR USING MACHINE LEARNING MODELS TO DETECT TRAFFIC ACCIDENTS ON ROADS

(71) Applicants: UT-Battelle, LLC, Oak Ridge, TN (US); Alliance for Sustainable Energy, LLC, Golden, CO (US)

(72) Inventors: Andreas Silvan Berres, Lakewood, CO (US); Haowen Xu, Knoxville, TN (US); Jibonananda Sanyal, Littleton, CO (US); Pablo Moriano, Knoxville, TN (US); Sarah Ann Tennille, Oak Ridge, TN (US); Rajesh Paleti Ravi Venkatadurga, Knoxville, TN (US)

(73) Assignees: UT-Battelle, LLC, Oak Ridge, TN (US); Alliance for Sustainable Energy, LLC, Golden, CO (US)

(21) Appl. No.: 18/985,913

(22) Filed: Dec. 18, 2024

Related U.S. Application Data
(60) Provisional application No. 63/613,087, filed on Dec. 21, 2023.

(51) Int. Cl. G08G 1/01; G06N 20/00

(52) U.S. Cl. CPC G08G 1/0133; G06N 20/00; G08G 1/0116

(57) ABSTRACT

Systems and methods for training a machine learning model (MLM) for detecting traffic accidents, comprising: obtaining traffic flow data, traffic accident data and topology data for roadside sensors; processing traffic accident data and topology data to identify roadside sensors closest to each traffic accident identified in the traffic accident data and obtain an order of identified roadside sensors relative to a driving direction; fusing the traffic flow data, traffic accident data and topology data to produce accident data samples and non-accident data samples based on accident proximities to the roadside sensors (wherein each of the accident data samples and non-accident data samples comprises traffic flow data for ones of the roadside sensors that are neighboring sensors); combining the accident data samples and non-accident data samples to obtain a training dataset; and training MLM for detecting patterns in input data indicating a probability/likelihood of a traffic accident/incident on a road segment.

### CROSS-REFERENCE TO RELATED APPLICATION(S)

The present application claims priority to and the benefit of U.S. Provisional Patent Application Ser. No. 63/613,087 which was filed on Dec. 21, 2023. The content of this Provisional Patent Application is incorporated by reference in its entirety.

### STATEMENT REGARDING FEDERALLY SPONSORED RESEARCH AND DEVELOPMENT

The technologies described herein were developed with government support under Contract No. DE-AC05-00OR22725 awarded by the U.S. Department of Energy. The government has certain rights in the described technologies.

### BACKGROUND

### Description of the Related Art

The recent emergence of advanced information, communication, and traffic monitoring technologies has increased the availability, spatiotemporal resolution, and quality of transportation and mobility data in many urban areas. These technologies enable real-time and continuous collection and integration of traffic-related data (e.g., vehicle volume, speed, trajectories, and intersection performance) with large spatial coverage in the United States. These solutions include a wide variety of sensing technologies, such as radar detection systems, loop detectors, onboard GPS, mobile sensing apps, and IoT-connected cameras. These devices generate large amounts of urban mobility data, which creates opportunities for diverse, innovative, and big-data driven transportation management and smart city applications that can improve transportation efficiency, help investigate mobility dynamics, promote urban livability and sustainability, and enhance traffic safety in cities.

Among these applications, the development of automatic incident detection (AID) methods enable the accurate detection of traffic accidents to support time-critical emergency response (e.g., dispatch medical and police resources to prevent fatality and severe infrastructure damage or reroute drivers to incident-free roadways to reduce congestion). As the number of traffic accidents has increased to represent a significant fraction of deaths among people in the United States and around the world, there is a growing urgency to more rapidly detect their occurrences and learn patterns that might be useful for predicting and preventing accidents. To that end, the AID methods aim for quick accident detection and high-quality predictions.

Many recent AID applications depend on traffic sensors to capture traffic conditions and accidents. Among them, a variety of methods that aim to automatically detect accidents focus on the use machine learning (ML) classifiers to mine traffic patterns from vast amounts of traffic data. Significant progress has been made to maximize classification performance, which is usually measured through metrics such as recall, false positive rate, and area under the receiver operating characteristic curve (AUC-ROC).

### SUMMARY

The present disclosure concerns implementing systems and methods for training and/or using machine learning model(s) for detecting traffic accidents. The methods comprise: obtaining, by a processor, traffic flow data, traffic accident data and topology data for roadside sensors; processing, by the processor, the traffic accident data and topology data to identify a number of roadside sensors that are closest to each traffic accident identified in the traffic accident data and obtain an order of the identified roadside sensors relative to a driving direction; fusing, by the processor, the traffic flow data, traffic accident data and topology data to produce accident data samples and non-accident data samples based on accident proximities to the roadside sensors (wherein each of the accident data samples and non-accident data samples comprises traffic flow data for the neighboring roadside sensors); combining, by the processor, the accident data samples and non-accident data samples to obtain a training dataset; and training, by the processor using the training dataset, the machine learning model for detecting patterns in input data indicating a probability or likelihood of a traffic accident or incident on a road segment.

The present disclosure also concerns a system comprising: a processor; and a non-transitory computer-readable storage medium comprising programming instructions that are configured to cause the processor to implement a method for training machine learning model(s) for detecting traffic accidents. The programming instructions comprise instructions to: obtain traffic flow data, traffic accident data and topology data for roadside sensors; process the traffic accident data and topology data to identify a number of roadside sensors that are closest to each traffic accident identified in the traffic accident data and obtain an order of the identified roadside sensors relative to a driving direction; fuse the traffic flow data, traffic accident data and topology data to produce accident data samples and non-accident data samples based on accident proximities to the roadside sensors (wherein each of the accident data samples and non-accident data samples comprises traffic flow data for ones of the roadside sensors that are neighboring sensors); combine the accident data samples and non-accident data samples to obtain a training dataset; and train, using the training dataset, the machine learning model for detecting patterns in input data indicating a probability or likelihood of a traffic accident or incident on a road segment.

### BRIEF DESCRIPTION OF THE DRAWINGS

The present solution will be described with reference to the following drawing figures, in which like numerals represent like items throughout the figures.

FIG. 1 provides an illustration of a framework of the present solution.

FIG. 2 provides graphs shown a number of accidents during an observation period on two roads.

FIG. 3 provides an illustration showing locations of radar detectors in a geographic region (e.g., a region around Chattanooga, TN).

FIG. 4 provides an illustration of traffic impact from an accident, which is marked by a spiky red symbol. Sensor placement is illustrated with circles next to the road, and vehicle data is represented by small vehicle symbols. The extent of traffic impact is visualized by using dark yellow for strong impact, light yellow for some impact, and light blue for little to no impact. In the illustration, nearby vehicles upstream from the accident are affected most. Upstream vehicles that are farther away and have just passed the accident and sometimes nearby vehicles in the opposing traffic direction may experience some impact (e.g., slowing down or speeding up). Vehicles even farther away continue at their usual travel speed.

FIG. 5 provides an illustration of a highway junction, where one highway (vertical) branches off of another highway (diagonal). Road-side radar sensors are represented as circles, and their corresponding range is represented by a colorful overlay. An accident (marked in red) occurs near the junction point on the diagonal highway. Based on the range assigned to each sensor, it should be assigned to the blue sensor. A purely proximity-based approach would assign a sensor that overlooks the opposite traffic direction (dark yellow). Other nearby sensors which are closer than the blue sensor are shown in light yellow. The potentially affected road segments are highlighted in blue and yellow respectively.

FIGS. 6A-17D each provide graphs showing different classification metrics for DR, FAR, AUC-ROC, and AUC-PR. FIGS. 6A-6D are collectively referred to as “FIG. 6”. FIGS. 7A-7D are collectively referred to as “FIG. 7”. FIGS. 8A-8D are collectively referred to as “FIG. 8”. FIGS. 9A-9D are collectively referred to as “FIG. 9”. FIGS. 10A-10D are collectively referred to as “FIG. 10”. FIGS. 11A-11D are collectively referred to as “FIG. 11”. FIGS. 12A-12D are collectively referred to as “FIG. 12”. FIGS. 13A-13D are collectively referred to as “FIG. 13”. FIGS. 14A-14D are collectively referred to as “FIG. 14”. FIGS. 15A-15D are collectively referred to as “FIG. 15”. FIGS. 16A-16D are collectively referred to as “FIG. 16”. FIGS. 17A-17D are collectively referred to as “FIG. 17”.

FIGS. 18 and 19 show a summary of feature importance based on classifier predictions in I-75 and I-24, respectively.

FIG. 20 provides an illustration of a system implementing the present solution.

FIG. 21 provides an illustration of an environment in which the present solution is implemented.

FIGS. 22A-22B (collectively referred to as “FIG. 22”) provides a flow diagram of an illustrative method for detecting traffic accidents and controlling electronic device(s).

FIG. 23 provides a block diagram showing an illustrative architecture for a mobile platform.

FIG. 24 provides a block diagram showing an illustrative architecture for a computing device.

FIG. 25 provides an illustration that is useful for understanding neighboring sensors.

### DETAILED DESCRIPTION

Quick and reliable automatic detection of traffic accidents is of paramount importance to save human lives in transportation systems. However, automatically detecting when accidents occur has proven challenging, and minimizing the time to detect accidents (TTDA) by using traditional features in machine learning (ML) classifiers has plateaued. It has been hypothesized that accidents affect traffic farther from the accident location than previously reported. Therefore, leveraging traffic signatures from neighboring sensors that are adjacent to accidents should help improve their detection. This hypothesis has been confirmed by using verified ground-truth accident data, traffic data from radar detection system sensors, and light and weather conditions. It has been shown that the TTDA can be minimized while maximizing classification performance by considering spatiotemporal features of traffic. Specifically, the performance of different ML classifiers (i.e., logistic regression, random forest, and XGBoost) are compared when controlling for different numbers of neighboring sensors and TTDA horizons.

During testing of the hypothesis, data from interstates 75 and 24 in the metropolitan area that surrounds Chattanooga, Tennessee were used. The results show that the XGBoost classifier produces the best results by detecting accidents as quickly as one minute after their occurrence with an area under the receiver operating characteristic curve of up to 83% and an average precision of up to 49%.

In this document, the feasibility of detecting traffic accidents within a much shorter TTDA (i.e., as quickly as one minute) is considered while maintaining high operational performance (i.e., AUC-ROC up to 83% and an area under the precision and recall curve [AUC-PR] or average precision up to 49%). In doing so, pervasive and generic roadside traffic sensor measurements (e.g., vehicle speed, traffic volume, and lane occupancy) are used along with lighting and weather conditions. Specifically, an ML-powered framework is described that employs spatiotemporal data to automate the timely detection of traffic accidents in large geographic areas. A workflow for efficient data mining is described. An ML is also described to optimize the analysis of complex traffic data over spatiotemporal dimensions without the need for costly high-performance computing infrastructure.

The present technologies can explore the impact that accidents have on traffic measurements at sensors near the accident location. This means that the measurements of immediate upstream and downstream sensors can be used, as done in literature, but measurements from more distant sensors (i.e., from sensors more than one hop apart from accidents) can also be used to help inform ML classifiers to reduce TTDA while maintaining high operational performance. The focus is on automatically detecting accidents as soon as possible after they occur. That means that other types of traffic incidents or non-recurrent events (such as disabled vehicles, spilled loads, temporary maintenance and construction activities, signal and detector malfunctions, or other unusual events that disrupt the normal flow of traffic) are not focused on herein, but the present solution may be used to detect the same.

Herein, validation is made of a conjecture about the practical utility of using adjacent traffic sensor measurements to reduce TTDA while maintaining high operational performance. It will be shown that using data from a series of sensors (e.g., more distant neighboring sensors—both upstream and downstream with respect to the accident locations) helps achieve this objective. It is observed that the TTDA decreases and performance increases up to a threshold of diminishing returns. To do so, a quantification is made of the joint effect that more distant sensors (i.e., more distant hops) along with different TTDA horizons have on the classification task. A comparison is made of the classification performance under similar conditions, using different ML classifiers, including logistic regression, random forest, and XGBoost. Then, verification is made of the hypothesis in more complex classification models such as random forest and XGBoost as opposed to logistic regression. XGBoost results exhibit the best trade-off between TTDA and other performance metrics.

Results are provided herein on the importance of individual features in the accident detection task by using SHapley Additive exPlanations (SHAP). SHAP is a model-agnostic, game-theoretic framework used to explain the output of ML models. SHAP results are provided herein for XGBoost, which is the best performing classifier.

Specifically, it is shown that traffic-related features (i.e., vehicle speed, traffic volume, and lane occupancy) from both upstream and downstream distant sensors, as opposed to only upstream sensors, are the most important features that drive classification performance. This means that they support the objectives of minimizing TTDA while maximizing performance—at most 11% in AUC-ROC (from 72% to 83%) and 26% in AUC-PR (from 23% to 49%). Following traffic-related features, it is shown that weather- and lighting-related features have a less significant impact on the likelihood of accident occurrence.

Results are reported herein on two different datasets that correspond to two major interstates (i.e., I-75 and I-24) in the Chattanooga, TN metropolitan area. The disclosed framework is applied to these datasets and show that the hypothesis can be verified. The framework allows for verifiable results when using the extended neighborhood, which includes measurements from more distant sensors, to minimize TTDA and maximize performance. The entire data processing workflow is explained below, including handling the unbalanced nature of the datasets by using the Synthetic Minority Over-Sampling TEchnique (SMOTE), which has some history of use in the field. In addition, a comparison of classification performance is made using AUC-PR, which copes with unbalanced data.

This document focuses on better feature design guided by the intuition that accidents affect regular traffic up to a certain distance from their location. The disclosed framework is applied to historical accident data to understand basic conditions for quicker detection of future accidents. The present approach enables quicker and more accurate accident detection.

There are two broad categories of AID methods differentiated by the type of models they use to represent traffic variables: (1) time series analysis (TSA) and (2) ML. These methods only consider the immediate neighborhood of the sensor (direct upstream and downstream neighbors) whereas the present solution takes advantage of a wider neighborhood. On the one hand, TSA-based AID focuses on profiling the historic behavior of traffic variables to forecast their future values. TSA methods raise an alarm to represent an anomaly when the expected/predicted values are significantly different than the actual values. In general, TSA methods focus on identifying anomalous traffic changes, which means that incidents are usually identified as anomalies in the traffic stream. On the other hand, ML-based AID frames the problem of detecting incidents as a binary classification problem in which each data sample is a feature vector derived from traffic variables (e.g., vehicle speed, traffic volume, and lane occupancy). This is done for each segment of the road at a particular time (i.e., each road segment is labeled as having an incident or not). In general, ML methods are flexible and can find complex patterns of traffic variables encoded in a representative dataset that contains incidents. Our disclosed framework employs ML.

Literature compared support vector machine (SVM) and probabilistic neural network (PNN) classifiers to detect accidents by using weather conditions, accident data, and loop detector data. It was found that the PNN tended to outperform the classification performance of the SVM. Specifically, the PNN had the best performance when using training data from four minutes before to five minutes after accidents occur. Data from the Eisenhower expressway in Chicago, IL was used to compare the classifiers.

Other literature proposed a hybrid method that uses a random forest-recursive feature elimination algorithm and a long-short term memory (LSTM) network optimized by Bayesian optimization for incident detection. It focused on using traffic variables and their combinations. Its approach was tested and compared with other state-of-the-art ML classifiers, including SVM, and showed that its approach outperforms the other approached in multiple evaluation criteria. Its method was testing with data from the I-880 freeway in California.

Other literature used an XGBoost classifier to detect accidents by using traffic, network, demographic, land-use, and weather features. Additionally, SHAP was used to analyze the importance of each feature. It was found that that the most important feature was the speed difference at the upstream location before and after accidents. Its framework was tested with data from Chicago, IL's metropolitan expressways.

Compared to the studies mentioned above, the disclosed technologies combine spatiotemporal features of traffic with weather and lighting conditions to find the best sensor configuration that minimizes the TTDA while maximizing classification results. Building upon this idea, a comparison is made of the classification performance of three distinct ML classifiers (logistic regression, random forest, and XGBoost). It is shown how additional neighboring sensor measurements help reduce the TTDA. This is unlike literature that focused only on the temporal dimension.

A finer TTDA resolution (i.e., 30 seconds) is used to train and test the classifiers. This allows for finer control and helps us better understand the temporal conditions that minimize the TTDA as much as 1.0 minute while maximizing classification performance as much as 83% in AUC-ROC and up to 49% in AUC-PR. In addition, in contrast with the previous, closely related work, results in two different traffic and accident datasets (including two major highways in the metropolitan area surrounding Chattanooga, TN (i.e., I-75 and I-24)) are detailed and contrasted.

Other literature used double exponential smoothing (DES) to forecast traffic-related signals and report incidents when there are significant deviations from the actual values. Data from the lodge freeway in Detroit, MI was used. Other literature compared different neural network (NN) architectures to classify lane-blocking freeway incidents by using simulated and field data from the SR-91 riverside freeway in Orange County, CA.

Other literature used a multilayer feedforward (MLF) NN trained and tested offline in a dataset from Tulla-marine freeway in Melbourne, Australia. This document also investigated the model's fault tolerance under corrupt and missing data conditions.

Other literature introduced a Bayesian-based probabilistic NN framework and explored its transferability without the need for explicit offline retraining in the new location. This document showed that the performance of its method competes with the MLF while being computationally faster in training. The approach of this document was tested on a large set of simulated incidents and real incident datasets from the I-880 freeway in California and the I-35W in Minnesota.

Other literature proposed a hybrid, fuzzy-logic genetic algorithm technique that required less time to detect incidents and provided higher detection rates than the MLF. The approach of this document was tested along the SR-91 riverside freeway in Orange County, CA. Other literature proposed a constructive probabilistic neural network (CPNN) architecture for incident detection. The model of this document is based on a mixture Gaussian model and trained by a dynamic decay adjustment algorithm. The model was trained and tested on a simulated incident detection database from Singapore. The transferability of the CPNN was tested on the I-880 freeway in California.

Other literature introduced and applied support vector machine (SVM) classifiers for arterial roads and freeways. Overall, SVM performed at least as well as the MLF when using data from the I-880 freeway in California. Other literature used cumulative sum for change-point detection in traffic-related data. The approach of this document was tested on data from the I-880 freeway in California. Other literature proposed an improved non-parametric regression method to forecast traffic flow and report incidents based on the standard normal deviation (SND) rule. This approach was validated by using traffic simulations. Other literature proposed a reduced multivariate polynomial-based NN to classify traffic conditions. The model of this document was trained and tested with real traffic data from the I-880 freeway in California. Other literature proposed an SVM ensemble to combine individual SVM classifiers based on certainty to outperform a single SVM. The ensemble methods were tested on data from the I-880 freeway in California. Other literature proposed a hybrid approach that uses TSA and ML. Specifically, DES was used to model trends in the normal traffic and then to forecast normal traffic. An SVM was then used to distinguish between normal and incident-related traffic. This hybrid approach was tested with data from the I-880 freeway in California.

Other literature extended the SND rule to account for robust univariate speed thresholds using historic traffic data. The thresholds were denoised by using the spatiotemporal correlations of adjacent sensors. The approach of this document was tested with data from interstates I-80, I-35, and I-235 in Des Moines, IA. Other literature used kernel density estimates of raw density-flow data to define a contour of typical behavior in which normal traffic lies. It was shown that deviations from this contour can be used to infer the presence of significantly anomalous behavior in the segments of a road associated with traffic incidents. This approach was validated to detect labeled incidents on London's M25 motorway. Other literature proposed a deep ensemble framework to combine the prediction of deep learning techniques, including long-short term memory, gated recurrent unit, and deep learning networks, to detect accidents. Traffic, accident, and weather condition data was used. It was found that multilayer perceptron and random forest classifiers perform best to create an ensemble of the output of the deep learning techniques. The method of this document was tested by using data from Chicago's metropolitan expressways.

### Dataset

The dataset used here focuses on the highway system in the Chattanooga, TN metropolitan area, including I-75, I-24, and US-27. The junction between interstates I-75 and I-24 is ranked 10th in the top 100 truck bottlenecks according to American Transportation Research Institute (ATRI). Additionally, the junction between I-24 and US-27 is ranked 29th.

In this section, different data sources are discussed that constitute ML inputs. The methodology which used to distill an input dataset will also be discussed herein.

Accident data, radar-based traffic data, and weather and lighting condition data is used from an observation period of six months from November 2020 to April 2021. Below, a description is provided of the data sources and how they were used to synthesize a dataset to train the ML classifiers for accident detection.

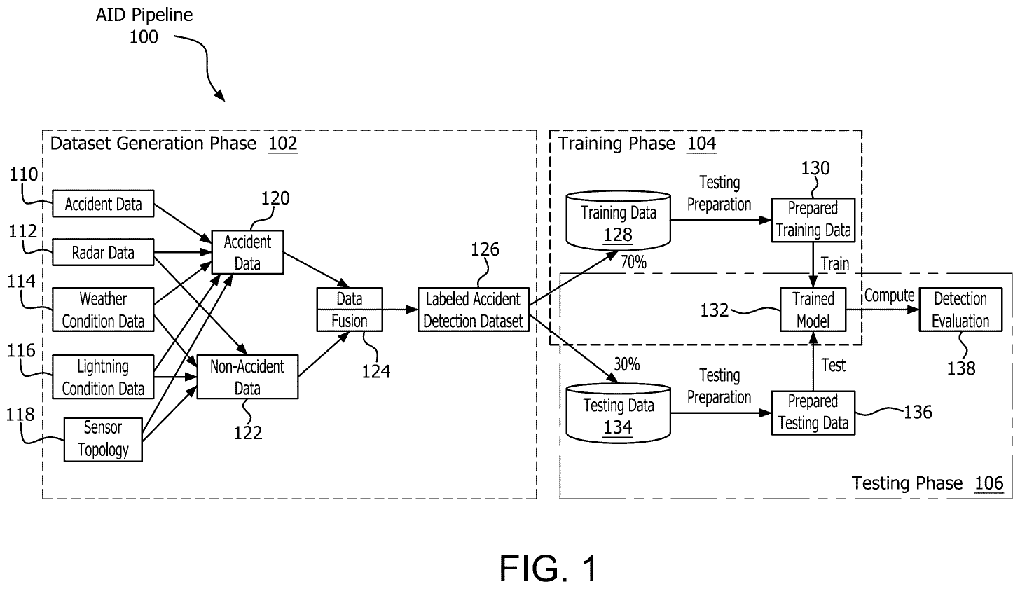

An overview of the proposed framework is presented in FIG. 1. The present method is composed of three main phases: a dataset generation phase 102, a training phase 104, and a testing phase 106. In the dataset generation phase 102, a labeled dataset is built by combining accident data 110, radar data 112, weather condition data 114, lighting condition data 116, and sensor topology data 118. These datasets are combined to produce accident data samples 120 based on their proximity to radar sensors and non-accident data samples 122. The accident data samples 120 are fused in block 124 with the non-accident data samples 122 to come up with a fused dataset 126 ready for ML classification. The fused dataset 126 gets split into training and testing data. The specifics of dataset 126 are described in detail below. During the training phase 104, the training data 128 is processed by conducting data preparation in block 130, model training in block 132, and selection on a subset of classifiers. During the testing phase 106, the testing data 134 is prepared in block 136 and fed it into the trained model of block 132. Predictions from the classifiers are used to estimate the quality of the predictions in block 138. The main idea here is that part of the known data is omitted (126—it is known that for each of these events whether it's an accident or not) so the trained model does not include them (i.e. cannot memorize them which could happen if overtrained). Then, that separated testing data can be used to evaluate how well the model does. The ground truth is knowns and compared with what the machine learning algorithm computes.

### Accident Data

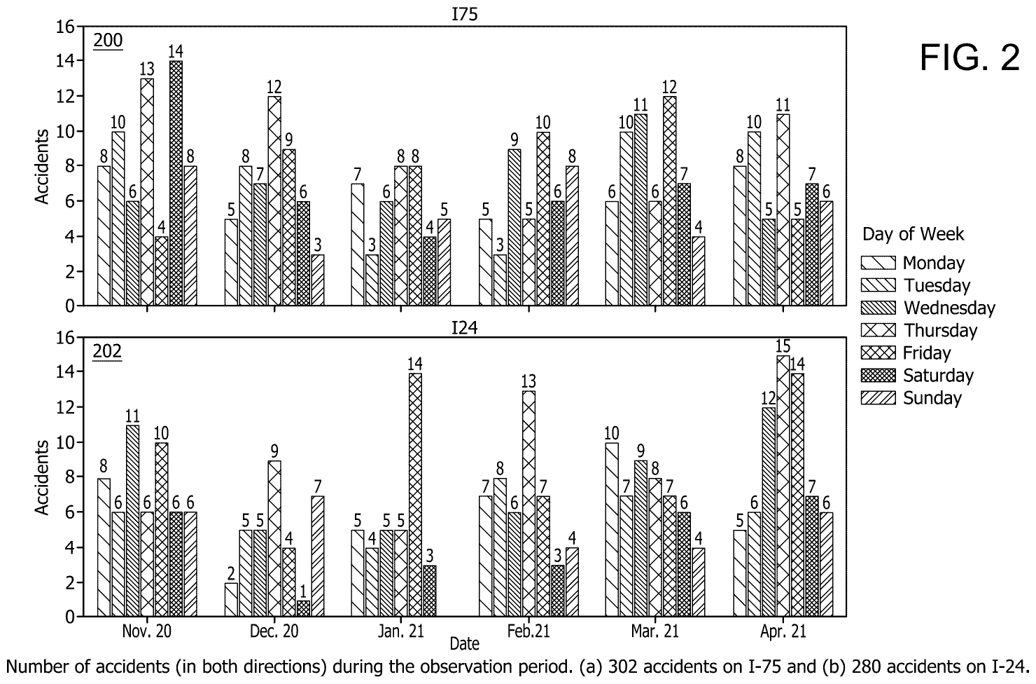

The accident data 110 can include, but is not limited to, data provided by the Tennessee Department of Transportation (TDOT) through the Enhanced Tennessee Roadway Information Management System (E-TRIMS) (Berres et al., 2021b). This dataset contains information from 518,660 accidents that occurred throughout Tennessee from 2018 to 2021. This dataset may be filtered down to a subset of accidents from the area of interest. For example, accidents may be selected along the main highways in the eight counties of the Chattanooga metropolitan area: Bledsoe, Bradley, Hamilton, Marion, McMinn, Meigs, Rhea, and Sesquatchie. This may result in a total of 9,644 accidents. Further specifying the time frame as November 2020 to April 2021 and focusing on I-75 (308 accidents) and I-24 (286 accidents) may net a total of 594 accidents. FIG. 2 shows the distribution of accidents (in each weekday) during the observation period for I-75 (See graph 200) and I-24 (See graph 202).

E-TRIMS is an extract of the Tennessee Integrated Traffic Analysis Network (TITAN) dataset, which is a rich dataset published quarterly. TITAN contains personally identifiable information. E-TRIMS is updated weekly and contains all the relevant data for accident detection without the privacy concerns inherent in the TITAN dataset. E-TRIMS is a rich tabular dataset with detailed information on each recorded accident. In the following, the information is listed that would be available in a real-time detection scenario, as the goal of the disclosed technologies is to detect accidents.
Date and time the accident was reported
Geographic location of each accident: county, route name, and geo-coordinates
Type and severity of crash: property damage, suspected minor/major injury, fatality
Lighting and weather conditions.

### Radar Data

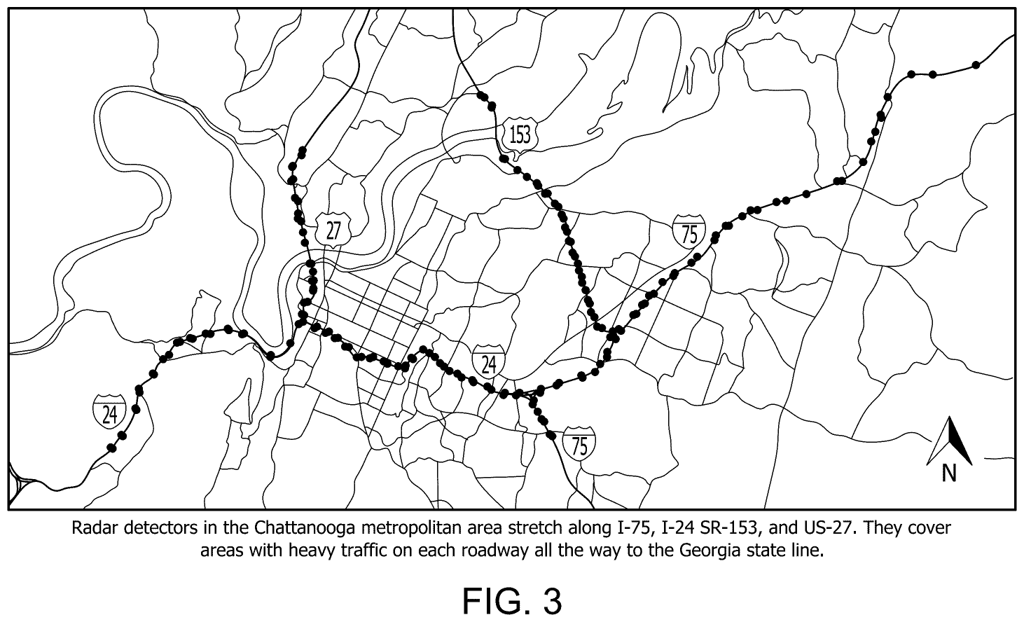

The Tennessee highway system has TDOT-maintained and operated radar detectors placed at intervals of roughly one mile along the major highways in each of Tennessee's four metropolitan areas, as shown in FIG. 3.

The Tennessee highway system has TDOT-maintained and operated radar detectors placed at intervals of roughly one mile along the major highways in each of Tennessee's four metropolitan areas, as shown in FIG. 3. These radar detectors emit low-energy microwave radiation that is reflected by the vehicles and can be captured by the sensor at lane-by-lane resolution. For each lane, the sensors capture the number of vehicles passing by, their speeds, and the lane occupancy, with each aggregated to 30-second intervals. The specific radar sensors used in this study are SmartSensor V by Wavetronix. These radar sensors provide true eight-lane detection of vehicle speed, traffic volume, and lane occupancy. These sensors are an important component of the SmartWay highway traffic information system enabling situational awareness and travel time estimation. Their typical accuracy per direction for vehicle speed, traffic volume, and lane occupancy is in the range of ±5 mph, 96%-98%, and ±10% respectively.

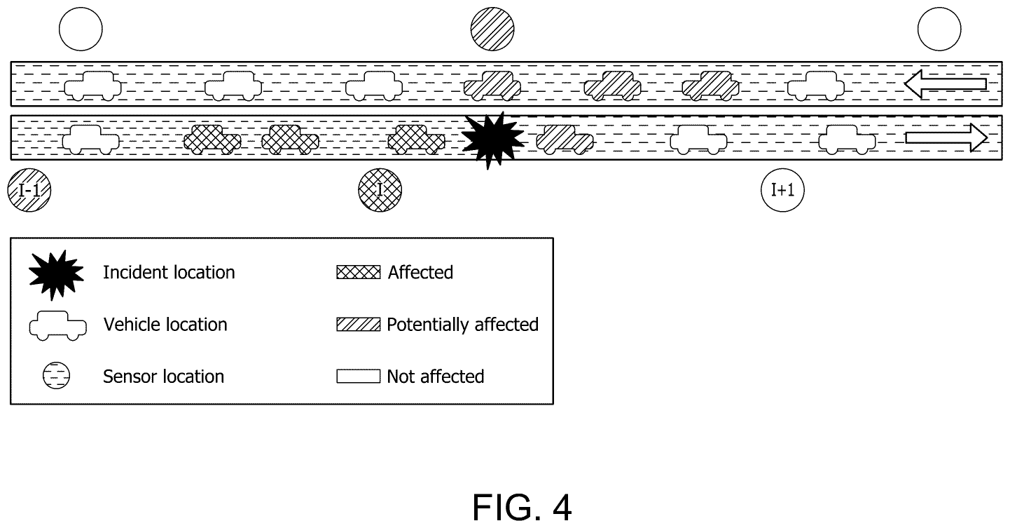

It has been hypothesized that when an accident occurs, it will affect measurements of neighboring radar detectors. FIG. 4 illustrates the impact that was observed in traffic and how hypothesis of it translates to sensor measurements was made. Data from sensors upstream and downstream of the accident location was considered in addition to the data from the nearest sensor.

For I-75, this study focused on forty-one radar detectors on a northbound stretch and forty-six radar detectors on the southbound stretch. These sensors divide up this I-75 stretch into forty northbound segments (average length of 0.9 miles) and forty-five southbound segments (average length of 0.8 miles). For I-24, the study focused on twenty-eight radar detectors on an eastbound stretch and twenty-five radar detectors on the westbound stretch. These sensors divide up this I-24 stretch into twenty-seven eastbound segments (average length of 0.5 miles) and twenty-four westbound segments (average length of 0.5 miles).

### Weather Condition Data

Weather has an impact on driving behavior and traffic safety, as reported by the (US DOT Federal Highway Association (FHWA), a). E-TRIMS provides weather condition data as one of its variables. This provides information on conditions when accidents occurred, but it does not provide information on what the weather conditions were like when there was no accident. To obtain this information, meteorological data was used to augment the feature space and aid in accident classification. Specifically, data from the Prediction of Worldwide Energy Resources (POWER) project funded by the National Aeronautics and Space Administration (NASA) was used to supplement weather information for non-accident training data (NASA). For the sake of consistency, this data was used as a source of weather conditions for both accident input data and non-accident input data.

The original E-TRIMS weather condition information has the following categories: clear, cloudy, rain, fog, sleet/hail, snow, blowing snow, severe crosswinds, blowing sand/soil/dirt, smog/smoke, other, and unknown. As a first step, these categories may be simplified to rain, snow (snow, sleet/hail, blowing snow), wind (severe crosswinds, blowing sand/soil/dirt), and unknown (clear, other, unknown). When multiple categories were possible (e.g., blowing snow could be wind or snow in this scenario), the category with a bigger traffic impact was selected based on FHWA's report.

POWER data was used to reproduce these categories from the hourly measurements. The following variables were used from this dataset.
Temperature (C): Average air (dry bulb) temperature at 2 meters above the surface.
Precipitation (mm/hour): Average of total precipitation at the surface, including water content in snow.
Wind Speed (m/s) at 2 m: Wind speed at 2 meters above the surface.
   These basic measurements were used to synthesize weather conditions comparable to the E-TRIMS weather conditions.

First, precipitation was determined. According to the United States Geological Survey (USGS), a “heavy (thick) drizzle” is defined as 1 mm of precipitation per hour, and it can impair visibility. Therefore, 1 mm was used as the threshold for a precipitation classification. Temperature was used to distinguish between snow and rain. Next, the definition from the National Weather Service (NWS) for wind advisories was used to determine when to use the wind classification. Finally, if the category was neither rain, snow, nor wind, precipitation was set unknown. The category wind may be used, for example, if wind speeds exceeded 13.5 m/s (30 mph).

### Lighting Condition Data

Lighting has a big impact on traffic accidents. Only 25% of travel occurs after dark. However, about 50% of all fatalities occur at night. Although drowsy driving and intoxication account for some of these accidents, decreased visibility can also contribute to this problem because drivers are more likely to have an accident if they cannot see a hazard (US DOT Federal Highway Association (FHWA), studies have shown that drivers often do not adjust their speed to lighting conditions. In addition to full darkness, dusk and dawn are also hazardous due to the glare from sunrise and sunset, and the sharp contrast between bright sky and dark roads and environment can make it difficult for drivers to see.

The original E-TRIMS lighting condition data contains the categories daylight, dusk, dawn, dark (lighted, not lighted, unknown lighting), other, and unknown. Applying the same reasoning used for weather data, the feature space was augmented with solar data to aid in accident classification and to have consistent data for both accidents and non-accidents. The sunrise-and-sunset (Sunrise Sunset) dataset was selected as the external data source for light. The times for civil twilight start, sunrise, sunset, and civil twilight end was used to aggregate the lighting conditions to dawn, daylight, dusk, and dark.

Artificial lighting was not considered in this study because information on lighting along highways is not always available. Furthermore, artificial lighting along the highway remains the same throughout the study's time frame. Therefore, the presence or absence of artificial lighting along the highways should not affect the results of our ML classifiers. As discussed below, the non-accident data mirrors the times and locations of the accident data.

### Sensor Topology

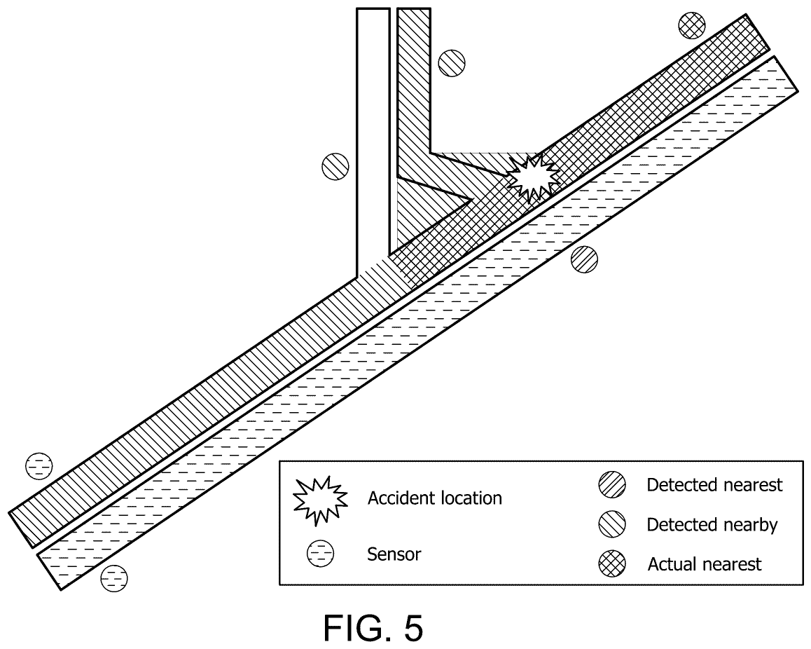

Along each highway, radar detectors are placed at intervals between 0.5 to 1.0 mile for each travel direction. The highway was split into segments at the mid-point between each pair of adjacent sensors such that each sensor corresponds to the highway segment that is closer to this sensor than any other sensor. In areas with highway junctions, the sensor name (which contains the name of the highway it relates to) was cross-referenced to ensure that close proximity does not result in incorrect assignments. FIG. 5 demonstrates the necessity of such a step.

In this step, two datasets are produced which are needed for further processing. First of all, a topological representation is created of the network of sensors, which stores each sensors upstream and downstream neighbors. Second, a geometry file is created consisting of polygons which allow a determination of the nearest sensor for any given accident location.

### Synthesizing Non-Accident Data

The ML algorithm needs examples of accidents and non-accidents. To synthesize non-accident data, a determination is made as to which sensors are affected by accidents throughout all times within the entire 6-month study. This information was saved as a matrix of (Number of time steps)×(Number of sensors) to enable fast lookup. The data was checked to see which of the similar time frames (same location, same day of the week, same times) are free of accidents. A list of non-accidents was then created. Within the given time frame (27 weeks), a maximum of 26 non-accidents can exist for any given accident. This ensures that the solution accounts for factors that are specific to a location (e.g., speed limits, artificial lighting), day of the week (e.g., different traffic patterns on weekdays vs. weekends), and time of day (e.g., rush hour). All properties are mirrored for the accident data with the exception of the type, which is set to None. Moving forward, data is referred to as being either an accident or a non-accident as an event.

### Data Fusion

An ML algorithm is trained to detect accidents. The input for this ML algorithm is fused data, which combines event data with traffic data. For each event, a dedicated machine learning input was provided by fusing the different data sources into a single tabular format with the following columns.
Time steps (rows): Data collection begins 15 minutes prior to the accident time and ends 15 minutes after the event time.
Event data (columns):
1. A Boolean signifies whether the event is an accident (i.e., 1) or a non-accident (i.e., 0). 2. The road that the original accident occurred on and the mile marker it occurred at (e.g., 00I75S and 4.8 if the original accident occurred near mile marker 4.8 on I-75 southbound).
3. The type of event (e.g., Prop Damage [over]) for an accident with property damage over a predefined threshold. If the event is a non-accident, this column is set to None.
4. The event's date, time (e.g., 18:35) and hour (e.g., 18). These columns have the date/time/hour of the accident recorded in E-TRIMS, and they remain the same value for the entire file.
5. The sensor data's time. This column contains the timestamp of the sensor data contained in each row.
6. Triplets of vehicle speed(i), traffic volume(i), and lane occupancy(i) for each sensor from 5 sensors upstream to 5 sensors downstream (e.g., speed(i-5), volume(i-5), occupancy(i-5) . . . , speed(i), volume(i), occupancy(i), . . . , speed(i+5), volume(i+5), occupancy(i+5)) from the data.
7. Weather and lighting conditions (e.g., Rain and Dusk).

### Final Dataset

To train the ML classifiers used in this research, non-accident samples were randomly selected during the same observation period. Specifically, non-accident events were selected by looking at the day and time of accident events and randomly sampling twenty-four non-accident events per accident with similar date, time, and day of the week given the strong temporal component of traffic data. After filtering missing data caused by gaps in radar data (e.g., missing windows of several hours), the full dataset consists of 302 accidents and 7, 455 non-accident events on I-75 and 280 accidents and 6,916 non-accident events on I-24.

A subset of this data was used that focuses on accidents in which the nearest radar detector could be one of up to five available upstream or downstream sensors. This subset also has an accident type of either suspected minor and/or major injury or fatality because they have greater impact on traffic conditions. With those parameters, the dataset consists of 24 accidents and 3,039 non-accident events on I-75 and 31 accidents and 4,852 non-accident events on I-24.

TABLE 1 details the set of explanatory variables used herein, including their description. They include traffic data (i.e., vehicle speed, traffic volume, and lane occupancy) and environmental data (i.e., weather and light). This study focused on using traffic variables from neighboring radar detectors instead of leveraging predictions based on historical data. Specifically, up to five neighboring sensors in upstream and downstream directions on each roadway were used. The classifiers were trained to detect accidents by using different TTDA from 0 to 7 minutes after the occurrence of accidents.

TABLE 1

| Variable | Description |
|---|---|
| Traffic Data | |
| Speed | Speed of up to five neighboring radar detectors in upstream and downstream directions. |
| | We used speed measurements from 4 minutes before up to n minutes after an accident/non-accident. |
| Volume | Volume of up to live neighboring radar detectors in upstream and downstream directions. |
| | We used volume measurements from 4 minutes before up to n minutes after an accident/non-accident. |
| Occupancy | Occupancy of up to live neighboring radar detectors in upstream and downstream directions. |
| | We used occupancy measurements from 4 minutes before up to n minutes after an accident/non-accident. |
| Environmental data | |
| Weather | One hot encoded representation of clear, cloudy, and rain/snow weather conditions. |
| Light | One hot encoded representation of daylight, dark, and dawn light conditions. |

TABLE 1 shows exemplary variable used in the research along with their descriptions. n differs from 0 to 7 minutes in 30-second intervals.

### Methods

This section describes the mathematical foundation of the algorithms used to perform the research.

### Study Setup

Each classifier was trained on 70% of the data and tested on the remaining 30%. The testing data was only used once for computing the performance of the classification task. The disclosed framework was implemented with the scikit-learn, imbalanced-learn, and SHAP APIs. As detailed below, after the train/test split, the data was prepared and the model is built and optimized. Finally, the optimized accident model is applied to the test dataset.

### Data Preparation

With 24 accidents vs. 3,039 non-accident events (≈0.8%) on I-75 and 31 accidents vs. 4,852 non-accident events on I-24 (≈0.6%), the dataset is highly imbalanced. Oversampling the minority class tends to perform better for ML than under-sampling. Specifically, SMOTE was used to handle this imbalance through oversampling. SMOTE processes each sample in the minority class to generate new synthetic samples by joining them to their k-nearest neighbors. Regular SMOTE was used with k=5 because of its simplicity and high performance.

### Build Model

The classification models were trained by using the labeled training dataset. Each of the classifiers is described below.

### Optimize Model

To achieve optimal performance, each classifier was tuned to find the optimal set of hyperparameters that maximizes the AUC-ROC. A grid search was used to test a small combination of parameters with reasonable values and performed a 5-fold cross validation with the training data. The training data was randomly split into five subsamples, and four of these subsamples were used for training, and the remaining subsample was withheld for validation. This procedure was repeated five times until each subsample was used once for validation purposes. This allowed the measurement of the classifier performance consistently across the entire training dataset.

### Apply Model

The optimized accident classification models are applied to the testing dataset. For each traffic sample in the testing dataset, the proposed classification model predicts whether the traffic sample is likely to represent an accident and then outputs a binary label.

### Classification Models

Three different classifiers were used that have shown promising results in AID. The classifiers include: (1) logistic regression (a regression-based classifier); (2) random forest (an ML-based classifier); and extreme gradient boosting (XGBoost) (an ML-based classifier). Here, it is assumed that for each road segment in a given direction, accident detection can be viewed as a binary classification problem. Without loss of generality, suppose that the accident data has n samples (xi, yi), i∈1, . . . , n, where xi=(xi1, xi2, . . . , xid) contains d explanatory variables or features (as described in Table 1), and yi is a dependent variable that represents an accident indicator (i.e., where one means that an accident is caused by the explanatory variables, and zero means that no accident occurred). The classifiers used below include: logistic regression, random forest, and XGBoost.

### Logistic Regression

Logistic regression is an extension of linear regression for classification problems with binary outcomes. Logistic regression represents class-conditional probabilities by using a linear combination of the explanatory variables as shown in mathematical equation (1).

$$log ( \frac{Pr ( {y}_{i} = 1 )}{Pr ( {y}_{i} = 0 )} ) = {β}_{0} + {β}_{1} {x}_{i 1} + … + {β}_{d} {x}_{id} = {β}_{0} + {x}_{j}^{T} β , \qquad ( 1 )$$

where β=β1+/β2+ . . . +βd is a vector of coefficients to be estimated, and Pr(yᵢ=1) and Pr(yᵢ=0) are the probabilities of class labels one and zero, respectively. A grid search was performed over the inverse of the regularization strength parameter: C∈[0.01, 0.1, 1.0, 10, 100], and we found that the optimal value is 100.

### Random Forest

Random forest is an ensemble method based on bagging (or bootstrap aggregation) that trains a B number of decision trees from subsets of the original dataset with the same size sampled with replacement. Thus, each of these trees focuses on a random subset of features. To make a prediction on a new sample, xᵢ, let C^{b}(xᵢ) be the class prediction of the b^{th} random-forest tree. The random forest then aggregates each of the results from the trees to make a final decision by using the majority vote method shown by mathematical equation (2).

$${\hat{C}}_{n}^{B} ( {x}_{i} ) = majority vote {\{ {\hat{C}}_{b} ( {x}_{i} ) \}}_{1}^{B} . \qquad ( 2 )$$

A grid search of trees was performed in the forest parameter: n estimators ∈[10, 100, 1000]. The optimal value was 100.

### XGBoost

XGBoost is an implementation of gradient-boosted decision trees designed for speed and performance. Boosting is an ensemble method in which K models are added iteratively to predict a dependent variable in accordance with mathematical equation (3).

$${\hat{y}}_{i} = {\sum }_{k = 1}^{K} {f}_{k} ( {x}_{i} ) , {f}_{k} ∈ ℱ , \qquad ( 3 )$$

where ƒk is an independent tree structure with a continuous score in each leaf, and F is the space of trees. A grid search was performed of the learning rate parameter, learning rate ∈[0.001, 0.01, 0.1], and of the number of trees in the forest parameter, n estimators ∈[10, 100, 1000]. The optimal set of values is 0.01 for the learning rate and 1,000 for the number of trees.

### Detection Evaluation

The comparison of different classifiers and conditions is based on counting the number of samples that are labeled as follows. True positive (TP) indicates that an accident instance is correctly detected. False positive (FP) indicates that a non-accident instance is incorrectly detected as an accident. False negative (FN) indicates that an accident instance is missed. True negative (TN) indicates that a non-accident instance is correctly classified as non-accident.

The classifiers were used to compute widely accepted metrics for accident detection. Detection rate (DR), or recall, indicates the actual proportion of accidents that have been detected. False alarm rate (FAR), or FP rate, indicates the proportion of non-accidents detected over the total number of non-accidents. The AUC-ROC indicates the overall performance of a classifier based on the variation of DR with respect to FAR at various thresholds. Due to the overly optimistic view provided by AUC-ROC estimates in highly imbalanced scenarios, such as accident detection, the AUC-PR, or average precision, is also reported to indicate the overall performance of a classifier based on the variation of correctly identified accidents out of the total (precision) with respect to recall (or DR) at various thresholds. AUC-PR changes with the ratio of positive and negative instances capturing the susceptibility of classifiers to imbalanced datasets, thereby placing more importance on the detection of the minority class (accidents). Because of that, AUC-PR was used as a single metric to compare classifier performance. Notably, the baseline of the AUC-PR is given by the proportion of accidents: 0.8% for I-75 and 0.6% for I-24. The accuracy was not reported to indicate the proportion of correctly predicted accident and non-accident instances, given the imbalanced nature of the dataset. The following definitions were used for each of the above metrics.

$$DR = \frac{Number of true accident reports}{Total number of accidents} = \frac{TP}{TP + FN} \qquad ( 4 )$$

$$FAR = \frac{Number of false accident reports}{Total number of accidents} = \frac{FP}{TN + FP} \qquad ( 5 )$$

$$Precision = \frac{Number of true accident reports}{Total number of predicted accidents} = \frac{TP}{TP + FP} \qquad ( 6 )$$

### Feature Importance Analysis

Feature importance refers to computing a score for all predictors of a given classifier. Scores quantify the importance of each feature for the prediction task. Thus, the higher the score, the larger the effect that a particular feature has on a classifier that is used to predict a certain variable. In this study, SHAP was used to estimate feature importance. SHAP is a game theoretic approach used to explain the output of any ML classifier. SHAP focuses on connecting optimal credit allocations with local explanations through Shapley values from game theory. In SHAP, feature values of a data sample act as players, and Shapley values indicate how to fairly distribute predictions among features. Thus, the contribution, φᵢ∈R, of an individual feature, i, is based on their marginal contribution. It specifies the explanation through a linear function of binary functions, g, defined by mathematical equation (7).

$$g ( {z}^{′} ) = {ϕ}_{0} + {\sum }_{j = 1}^{M} {ϕ}_{j} {z}_{j}^{′} , \qquad ( 7 )$$

where z′∈{0, 1}^{M} is the coalition vector (i.e., equals one when a feature is observed and zero otherwise), and M is the number of input features.

In this study, the feature importance was computed for the best performing classifier (XGBoost) and focus on AUC-PR. Note that this procedure does not reflect the intrinsic predictive value of the features themselves but rather how important the features are for a particular classifier. This means that the most important features may differ depending on which classifier is used. Other methods to compute feature importance include mean decrease impurity (MDI) and permutation feature importance. These two methods were not used in the study because MDI tends to be strongly biased toward high cardinality features, and because permutation feature importance may produce misleading values on strongly correlated features.

### Results

The results of the impact of neighboring measurements on accident detection will now be discussed. Two different but complementary analyses are performed.

First, a spatiotemporal sensibility analysis is performed on the impact that neighboring sensor measurements and TTDA have on the accident detection task. This is done for each classifier considered in the study: logistic regression, random forest, and XGBoost. Specifically, classification results are compared by computing the effect that neighboring sensors have under two settings. In Setting 1, up to five neighboring sensors located upstream from the accident are used. In Setting 2, symmetric sensors located upstream and downstream from the accident location (up to five sensors in each direction) are used. An hypothesis is made that accidents significantly affect upstream and downstream traffic up to a certain distance, so using these features helps to design better classifiers. To study the effect of the number of sensors and their settings, classifiers were trained and results were reported on the test data by controlling the influence of neighboring sensors placed at incremental distances from accidents. In each of these settings, results were computed when using different TTDAs, from 0 minutes to 7 minutes at 30 second intervals.

An optimal combination of neighboring sensor arrangements and TTDA were found for achieving the best classification results (using the AUC-PR metric). Specifically, the classification performance increases as more distant sensors are considered, but it starts reaching a point of diminishing results. Adding more sensors (upstream and downstream for Setting 2) produces marginal improvements at 4-5 hops. In addition, along with a specific neighboring sensor configuration, TTDA matters. In particular, it was found that using traffic data up to one minute after accidents produces reasonably good results for the best performing classifier in the richer dataset (i.e., I-24). In the analysis, XGBoost classifiers produce the best results over logistic regression and random forest.

Second, a feature importance analysis was performed to better understand the most influential features that drive the results, (i.e., how much each feature contributed to the prediction). This was done for the best performing classifier (XGBoost) under Setting 2 (i.e., up to five upstream and downstream sensors) at 1.5 minutes TTDA for I-75 and 1.0 minutes TTDA for I-24. The most influential features contributing to the predictions are traffic-related variables, (e.g., vehicle speed, traffic volume, and lane occupancy) from locations farther from the accidents, including those up to five sensors apart. This supports the hypothesis that adding further sensors improves classification results and reduces TTDA. Overall, features related to weather and lighting seem to be less important to the classification results. Although weather and lighting conditions can contribute to the occurrence of accidents, they are expected to factor in more significantly in general predictions of how likely accidents are to occur, and this can help better allocate local law enforcement and emergency response services. In contrast, the disclosed technologies focus on detecting accidents that have already happened and are actively affecting traffic measurements.

### Spatiotemporal Sensitivity Analysis

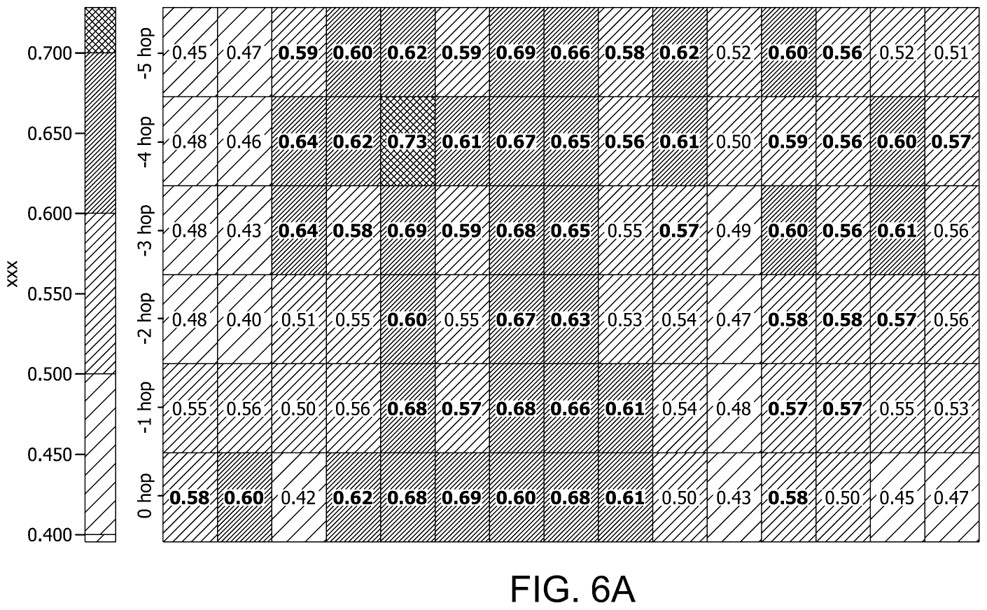

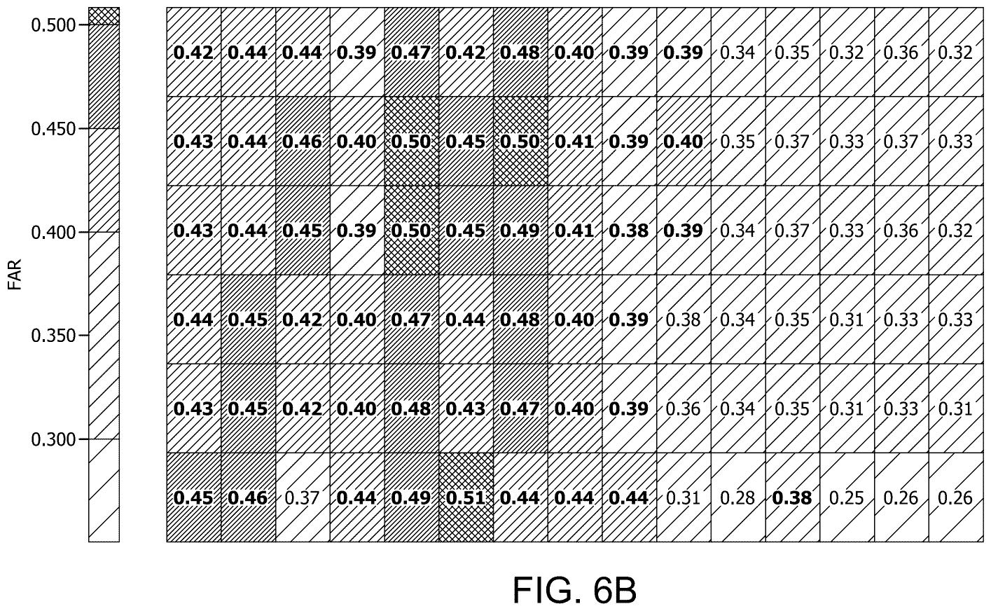

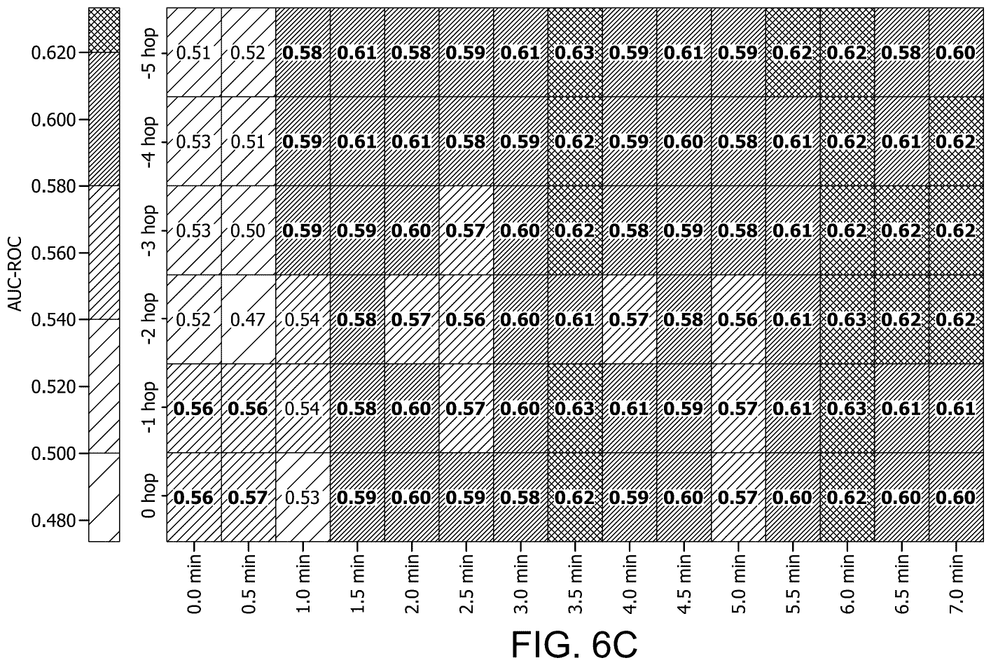

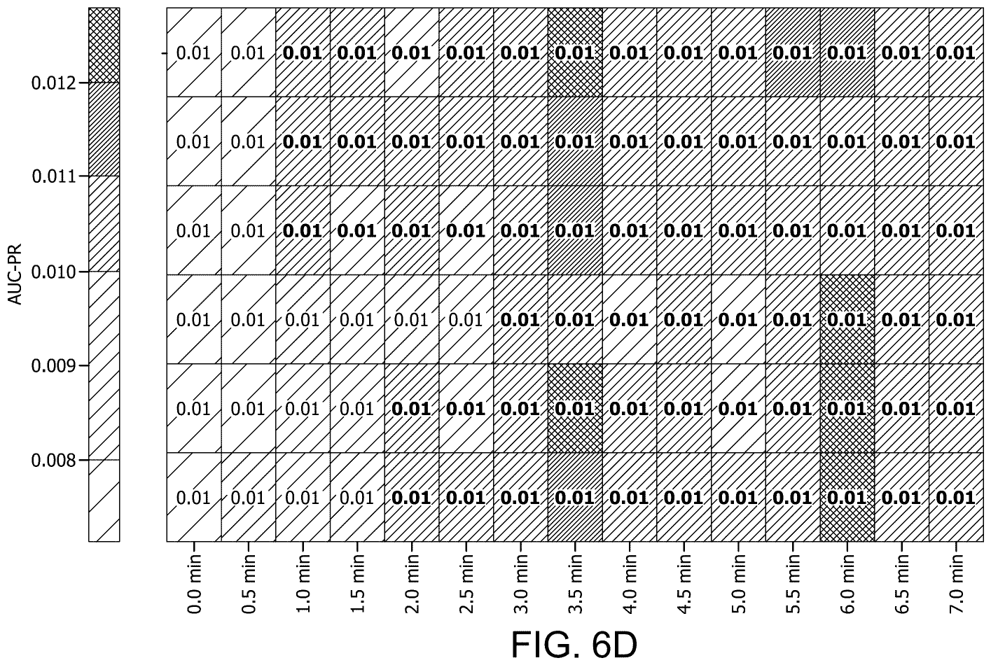

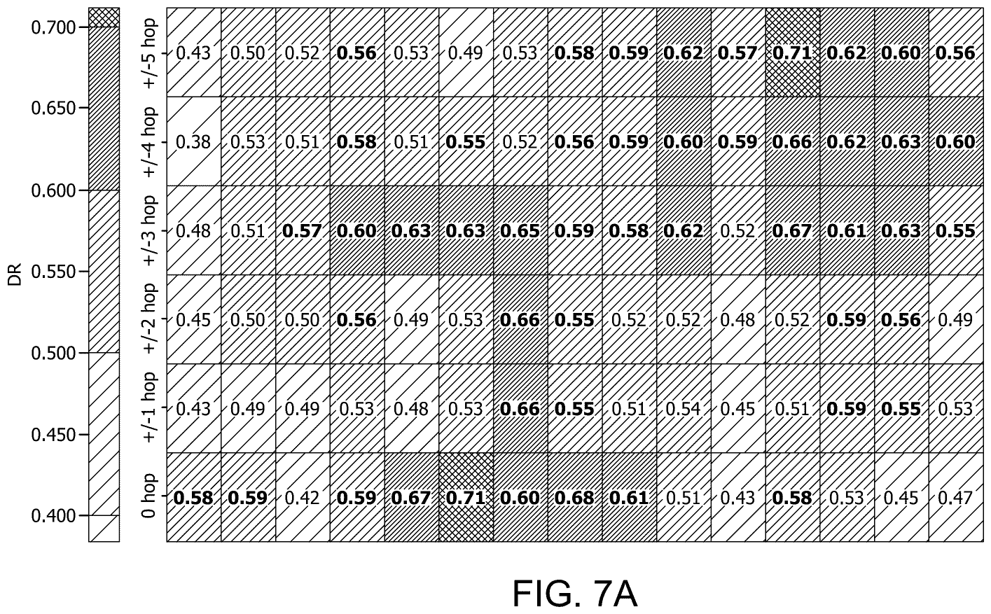

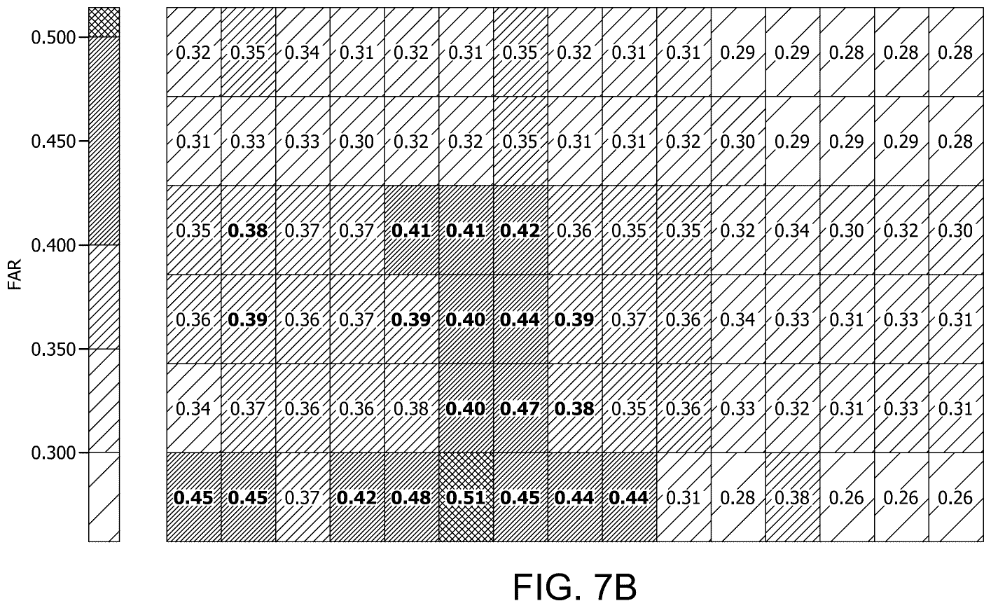

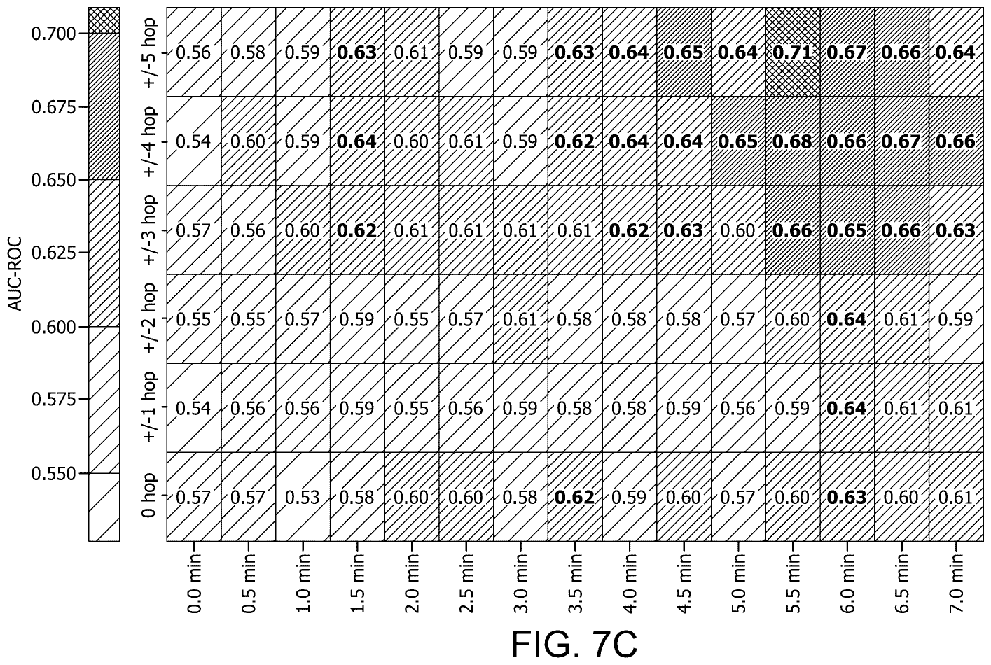

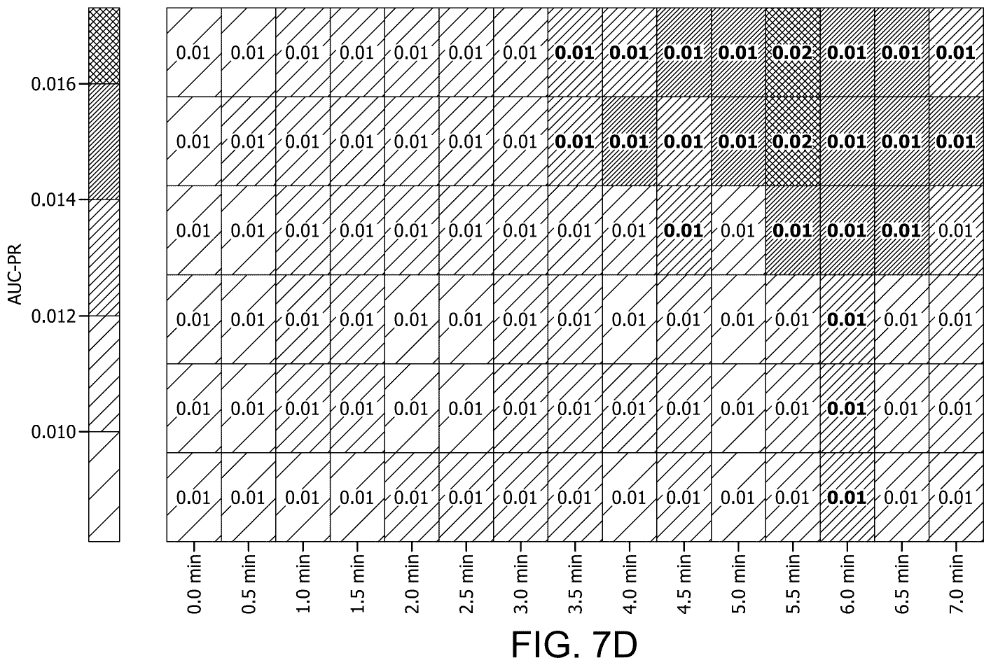

FIGS. 6-17 visualize different classification metrics for DR (See FIGS. 6A, 7A, 8A, 9A, 10A, 11A, 12A, 13A, 14A, 15A, 16A, 17A), FAR (See FIGS. 6B, 7B, 8B, 9B, 10B, 11B, 12B, 13B, 14B, 15B, 16B, 17B), AUC-ROC (See FIGS. 6C, 7C, 8C, 9C, 10C, 11C, 12C, 13C, 14C, 15C, 16C, 17C), and AUC-PR (See FIGS. 6D, 7D, 8D, 9D, 10D, 11D, 12D, 13D, 14D, 15D, 16D, 17D). Each cell of the heat maps depicts a single performance metric value for a specific combination of neighboring sensors (i.e., Setting 1 or Setting 2) and TTDA. The results are rounded at two decimal places. The horizontal axis represents the TTDA (from zero to seven minutes at thirty second intervals). The vertical axis represents the number of neighboring sensors included for training and testing the classifiers in each of the settings: using sensors upstream from an accident (Setting 1) and using sensors upstream and downstream from an accident (Setting 2). The results are organized by road (I-75 and I-24) and classification algorithm (logistic regression, random forest, and XGBoost).

### I-75 Analysis

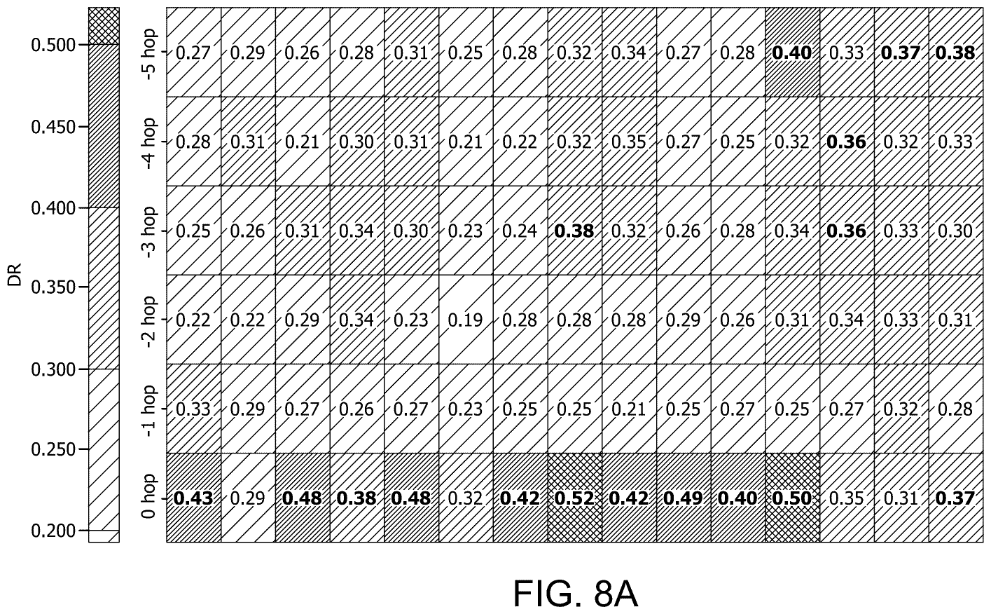

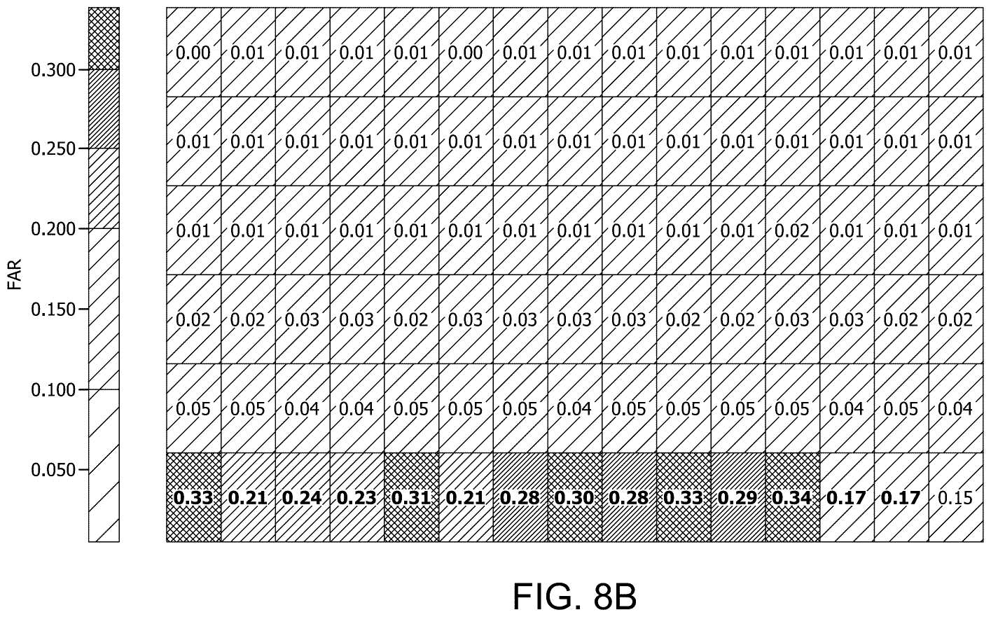

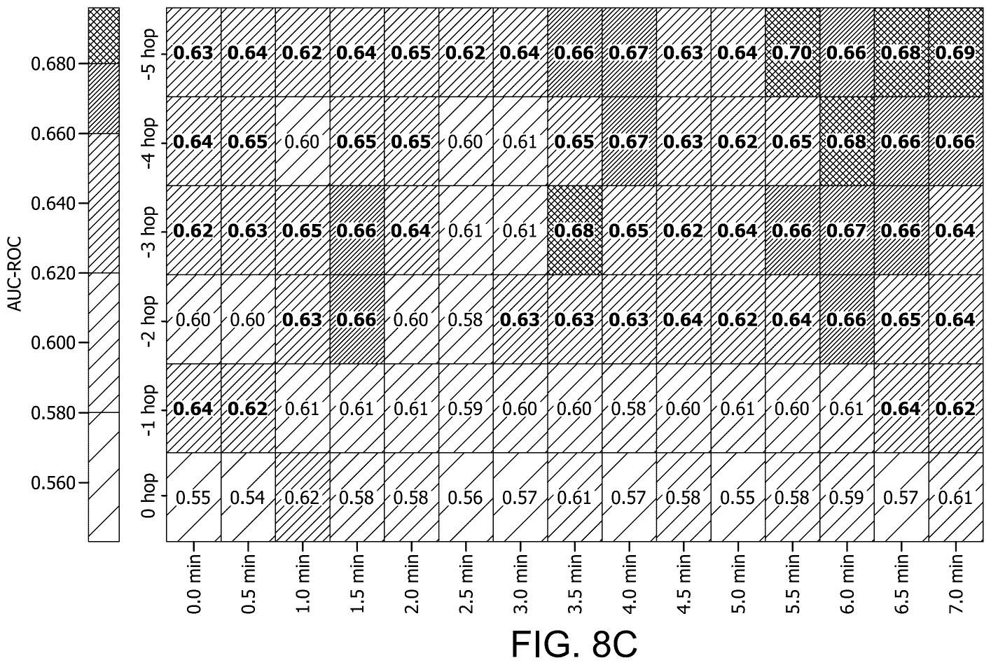

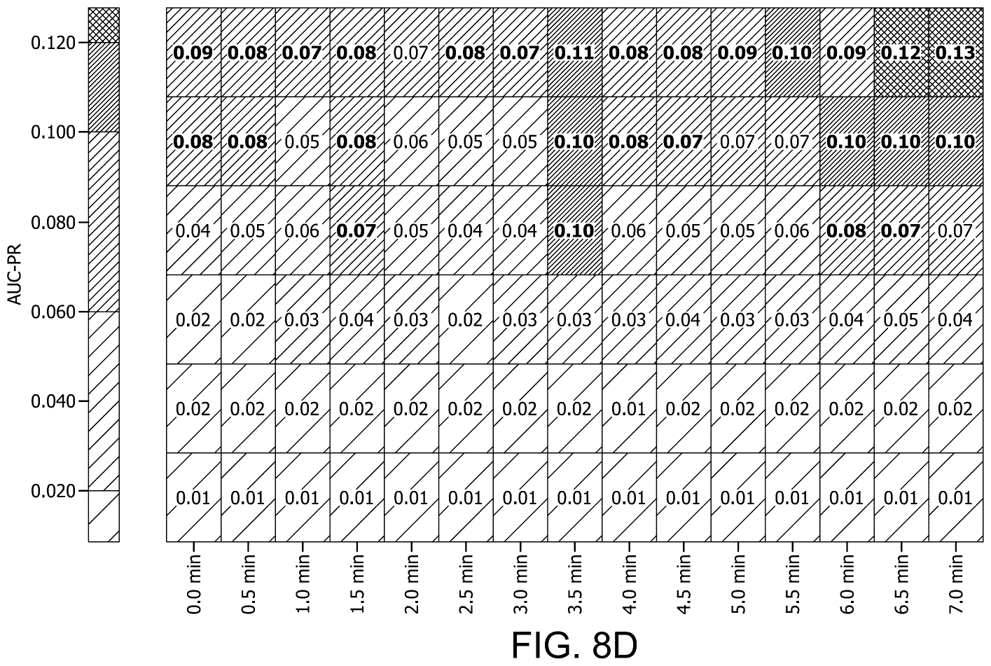

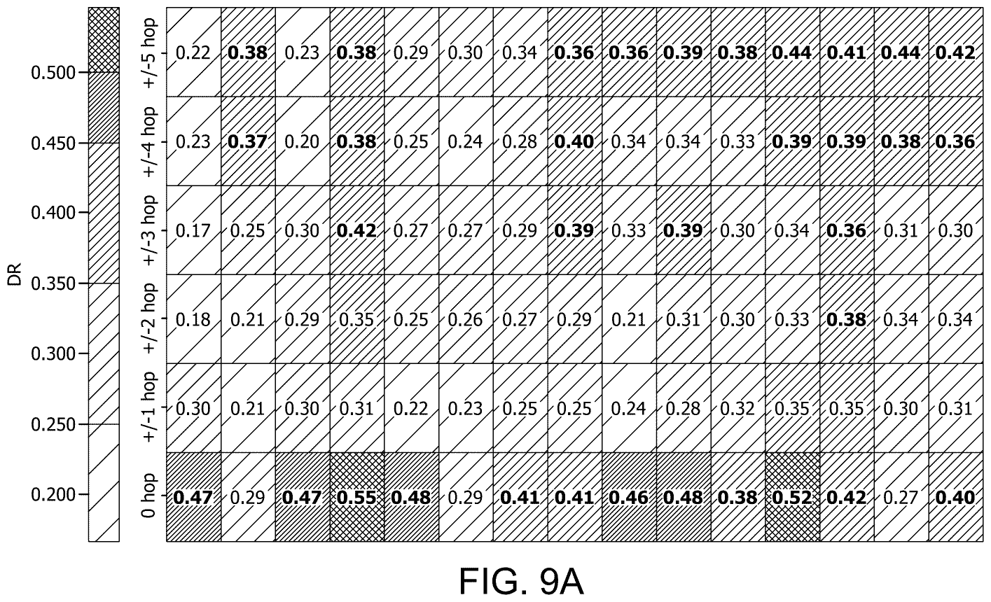

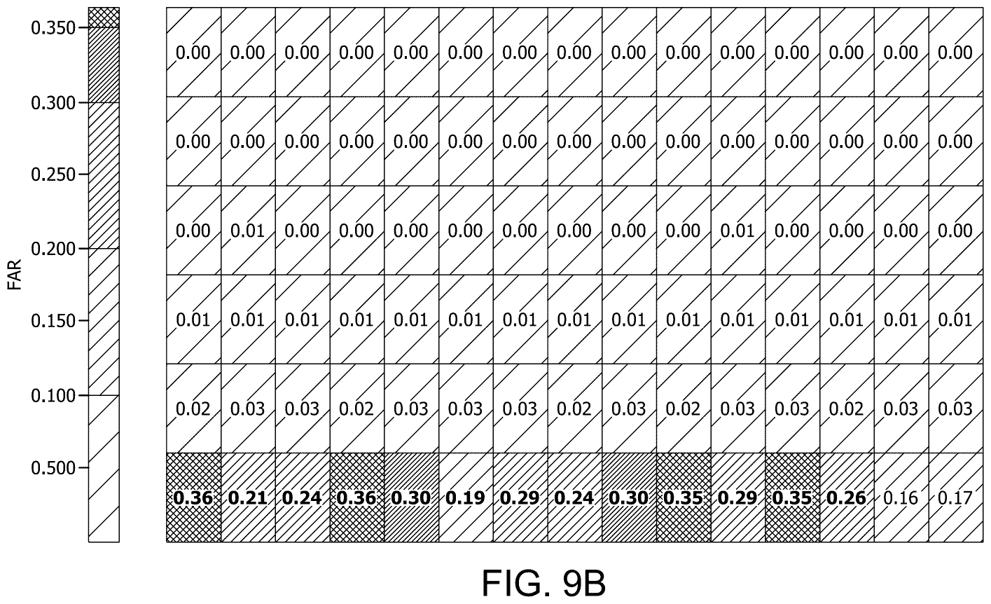

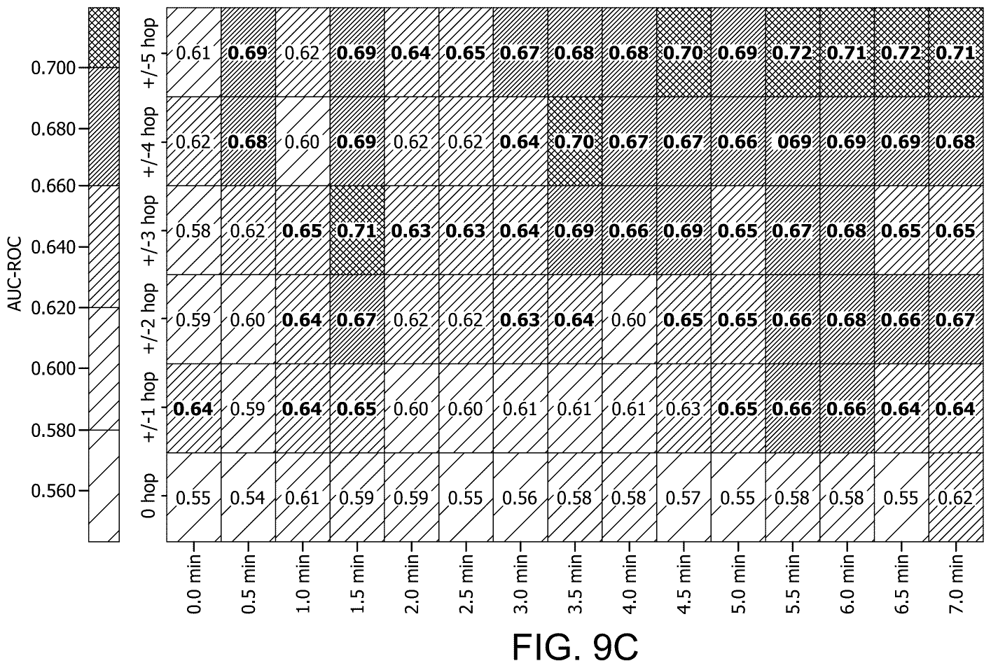

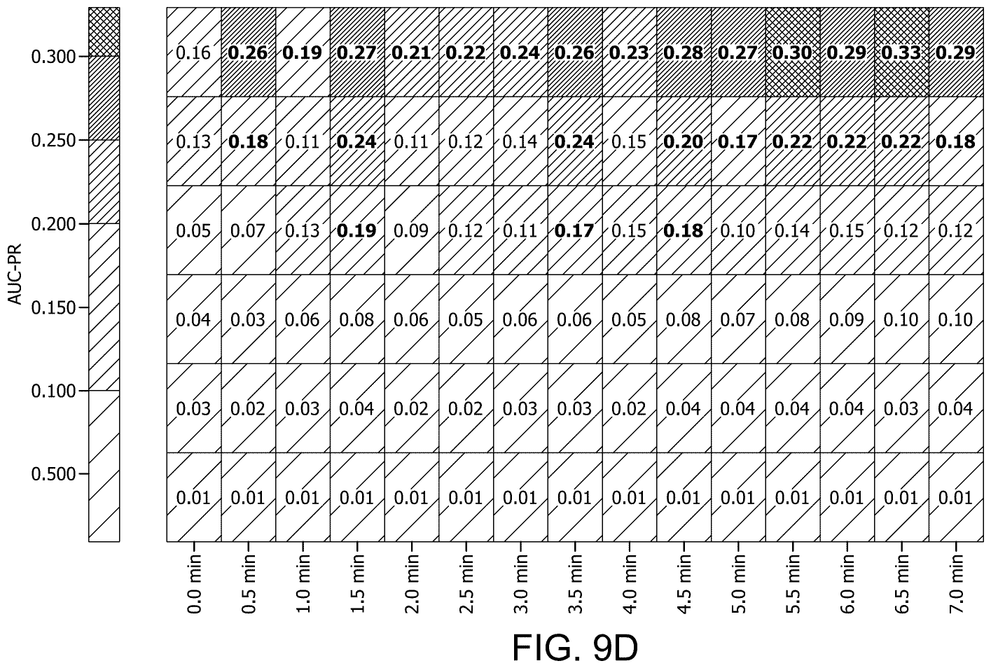

FIGS. 8 and 9 show the performance results when using a random forest classifier under Settings 1 and 2, respectively. Note that under Setting 1, considering more upstream sensors improves classification results across all metrics. In particular, there is an increasing trend in DR, AUC-ROC, and AUC-PR and a decreasing trend in FAR. The highest AUC-PR is 13%, which is achieved at seven minutes. Similarly, for Setting 2, considering more sensors (both upstream and downstream) helps improve detection metrics. Specifically, the AUC-PR can be as high as 33% and can be achieved at seven minutes. Leveraging Setting 2 on a random forest classifier represents an increase of as much as 20% (from 13% to 33%) in AUC-PR over Setting 1. Remember that the baseline for AUC-PR in the I-75 dataset is 0.8%.

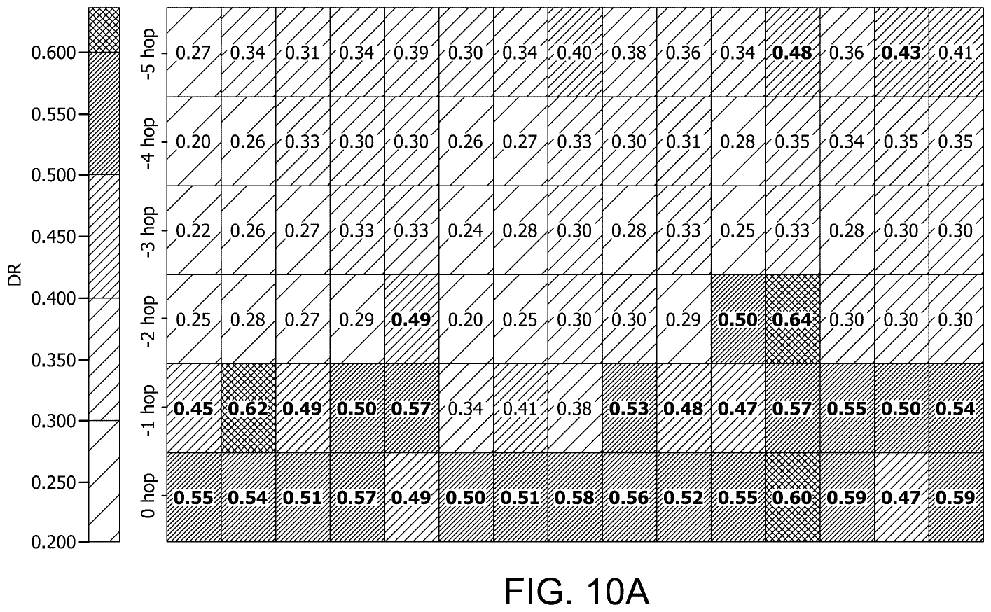

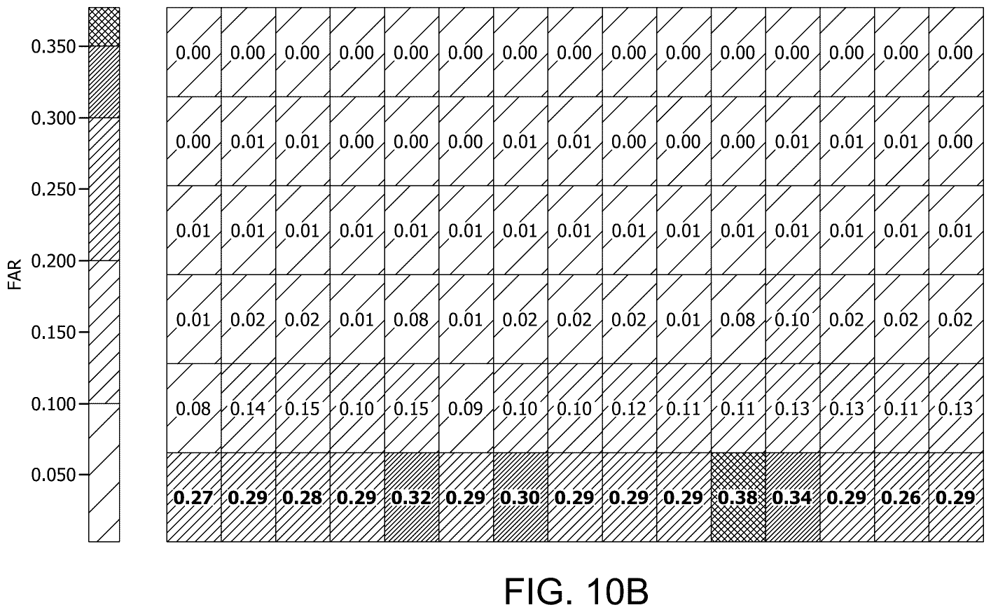

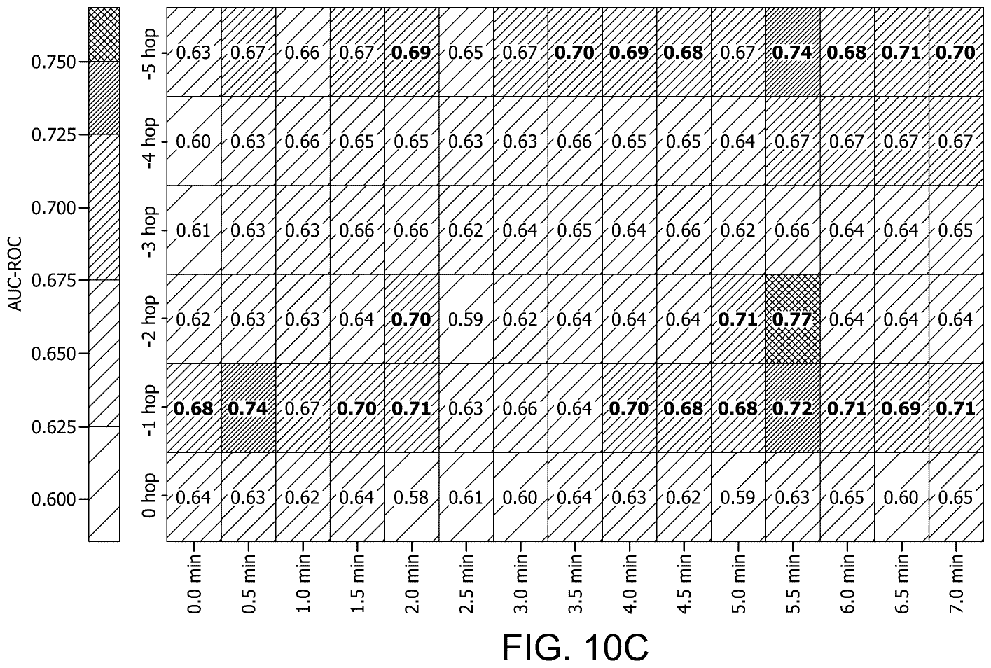

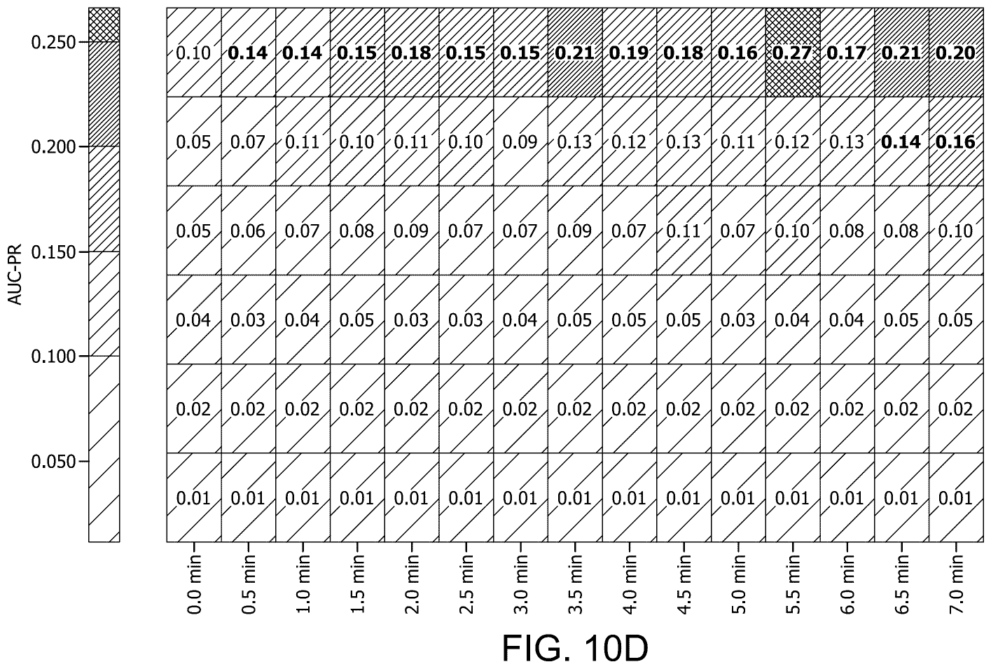

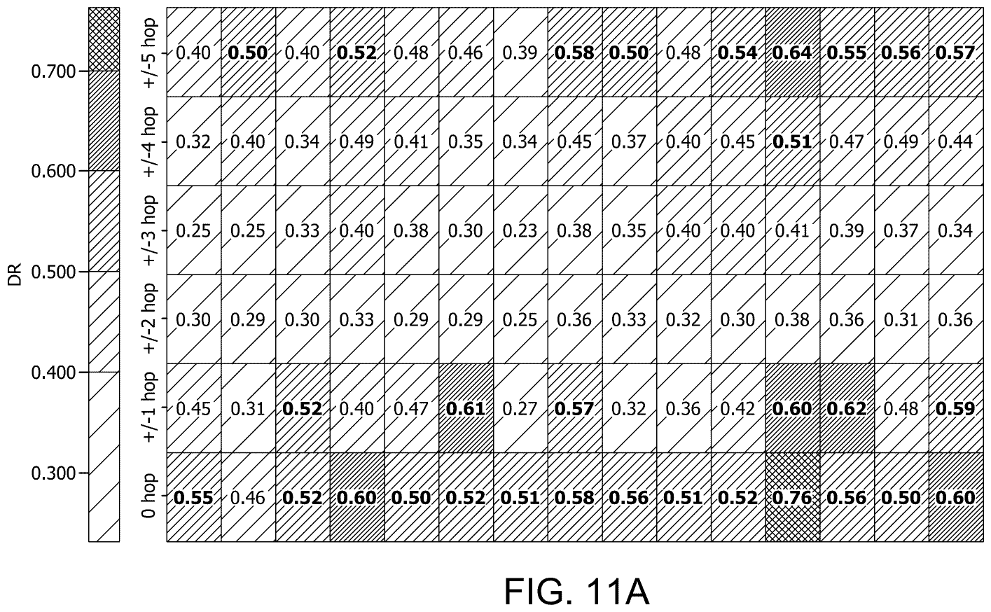

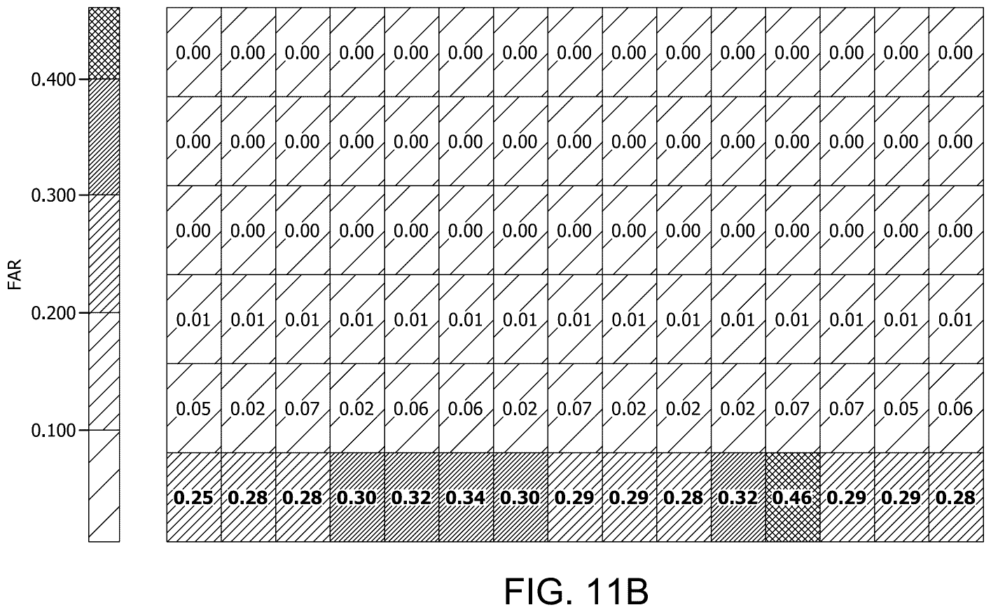

FIGS. 10 and 11 show the performance of the XGBoost classifier under Settings 1 and 2, respectively. For Setting 1, the DR degrades as more neighboring upstream sensors are used. This is the opposite of what was observed with logistic regression and random forest classifiers. The remaining metrics, including FAR, AUC-ROC, and AUC-PR, show a trend of performance improvement as we use data from more upstream sensors. Here, the 27% peak AUC-PR is achieved when using data up to five and a half minutes. On the other hand, for Setting 2, an improvement is seen in every performance metric. Here, the performance can be as good as 45% in AUC-PR (including 82% in AUC-ROC and almost negligible in FAR) and is achieved at five and a half minutes. This peak in performance represents an increase of as much as 18% over the same metric in Setting 1.

### I-24 Analysis

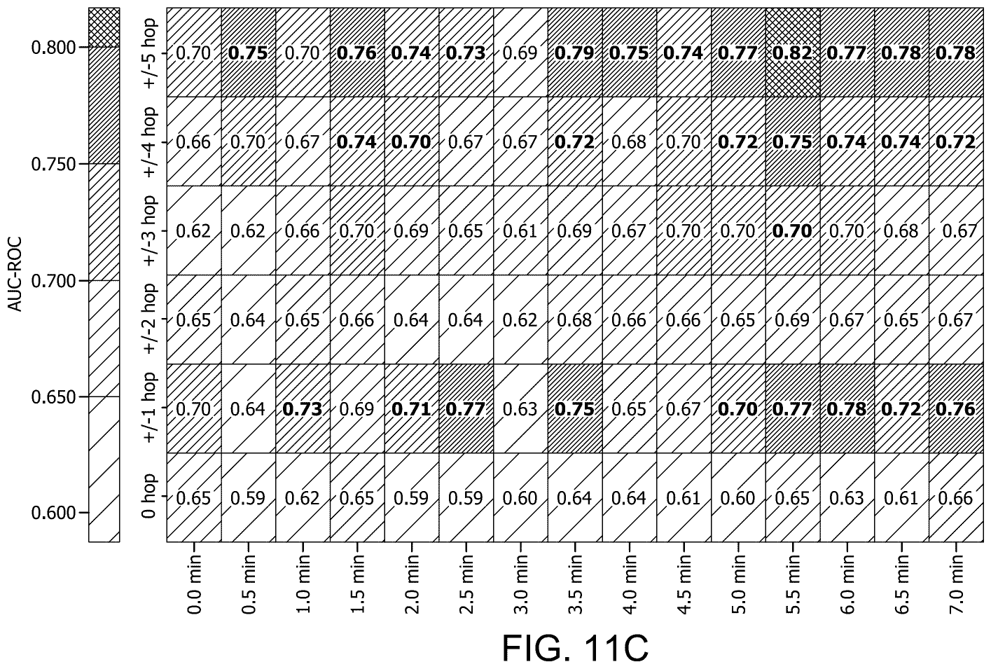

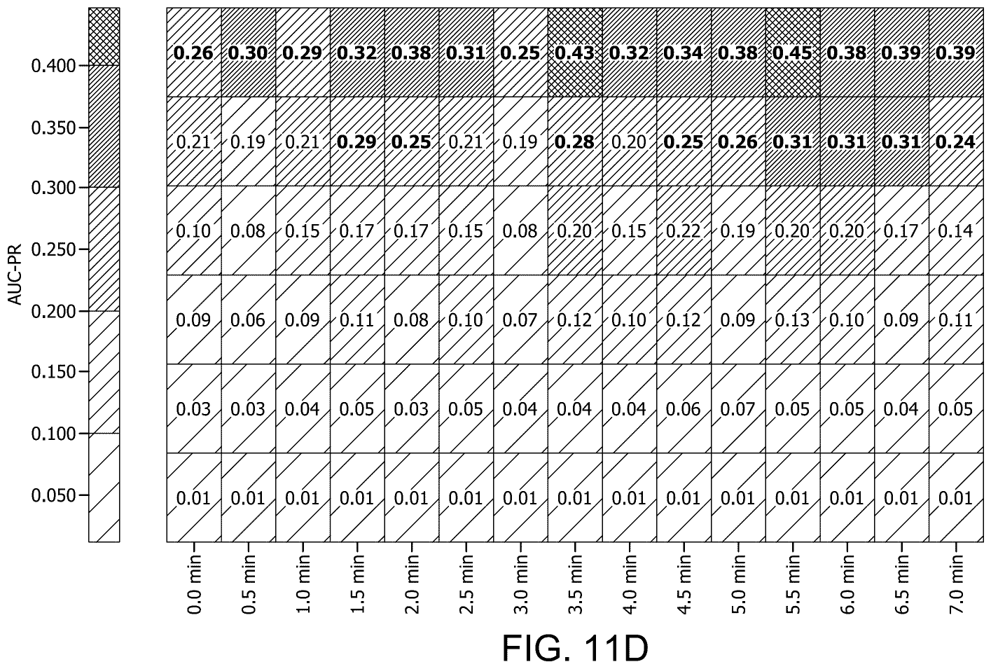

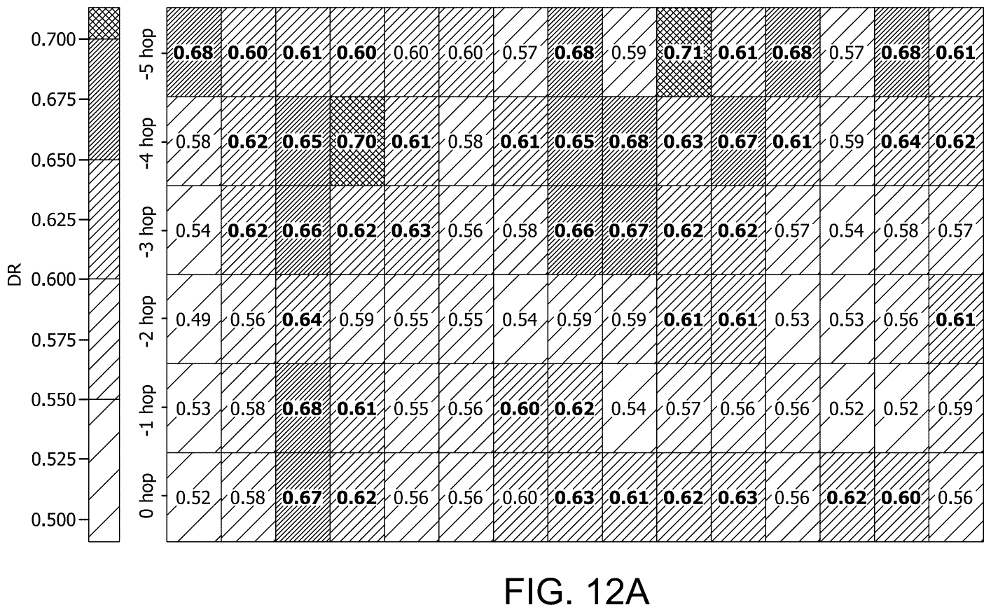

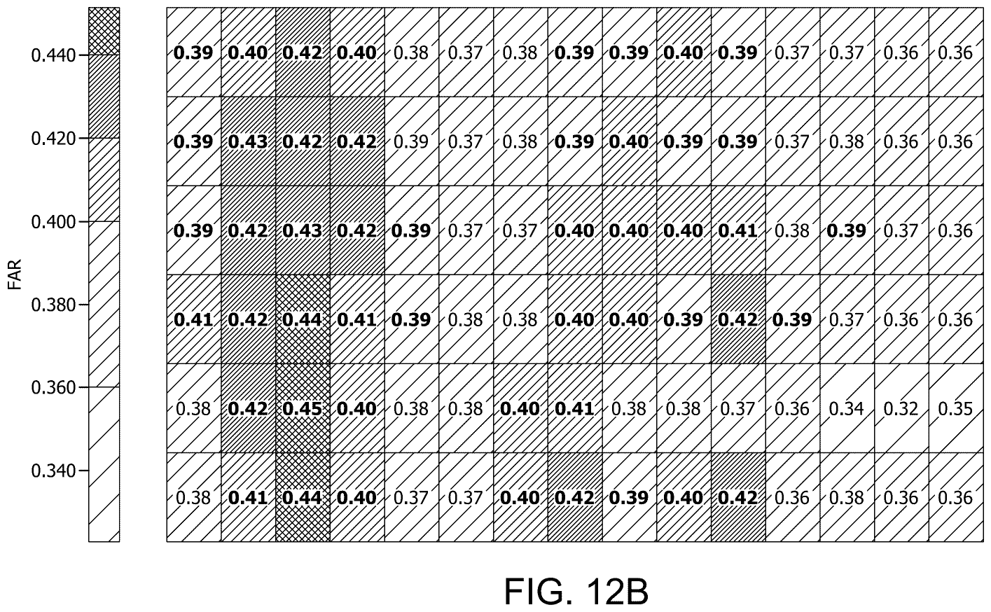

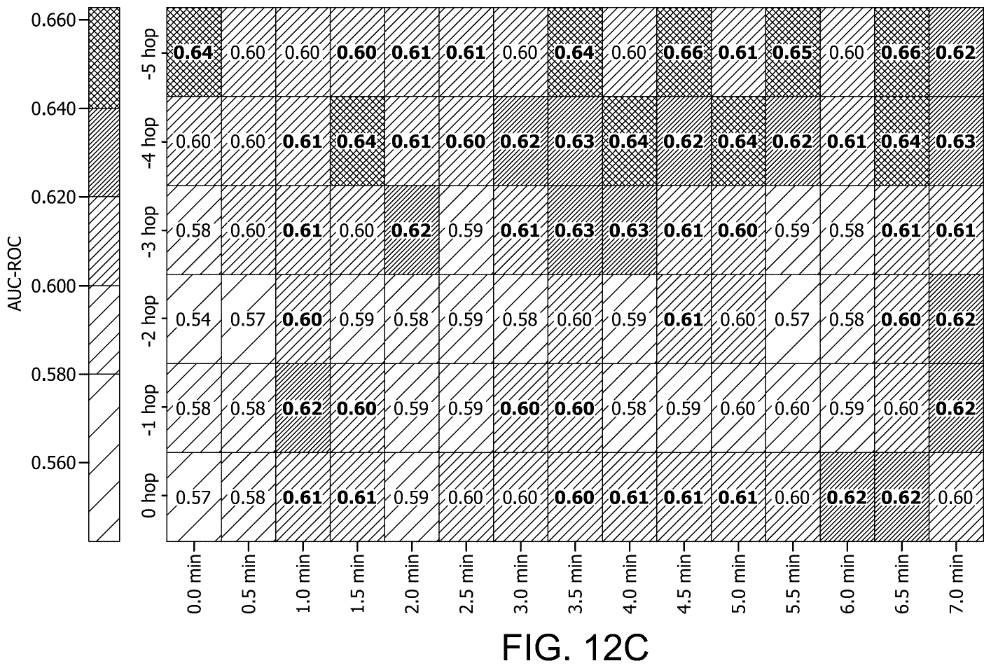

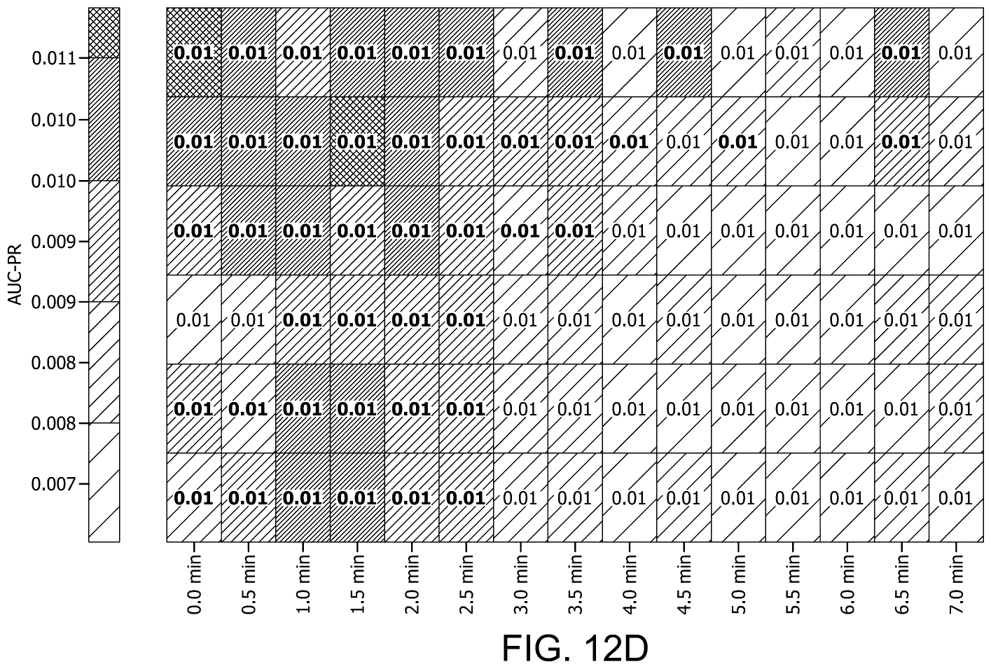

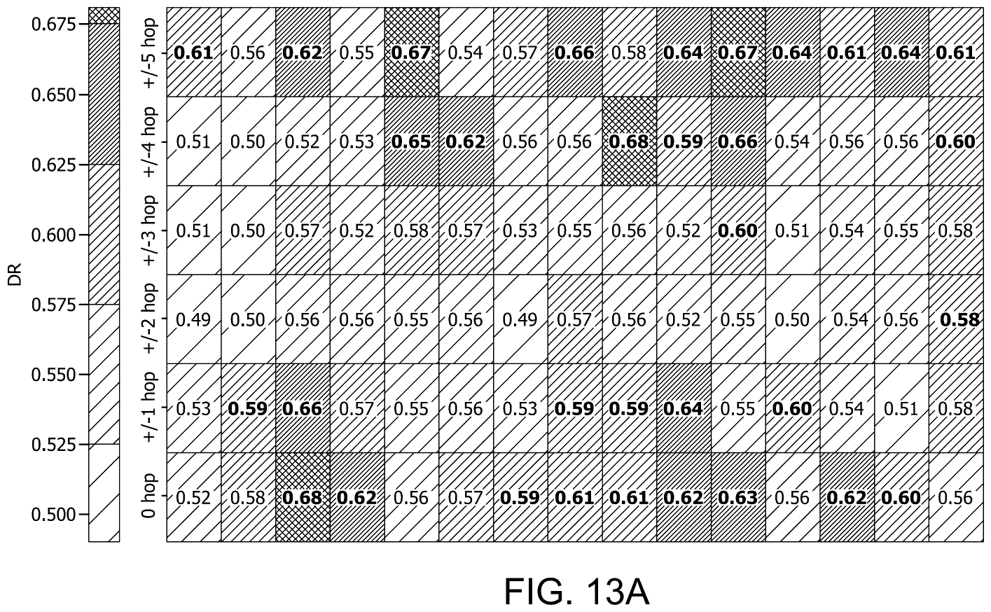

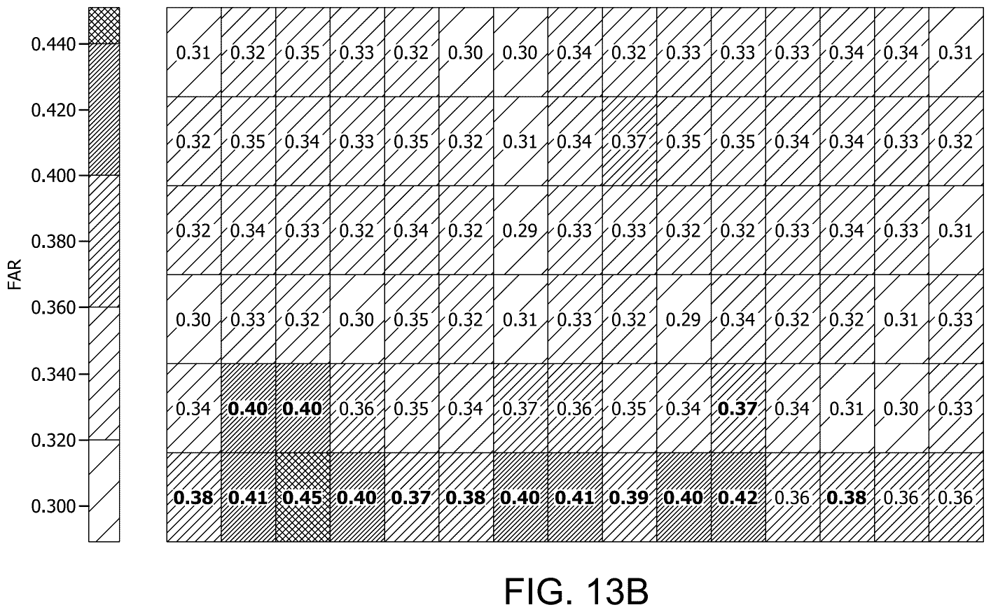

The I-24 analysis is similar to the I-75 case study. FIGS. 12 and 13 show performance results when using a logistic regression classifier under Settings 1 and 2, respectively. Under Setting 1, there is no particular advantage to using more upstream sensors in the classification task. In terms of AUC-PR, the metric plateaus at 1% regardless of how many sensors are used and the TTDA. This agrees with the results for I-75. Similar results are found under Setting 2. When using a logistic regression classifier, an improvement can be seen when including more sensors (upstream and downstream) or when considering extensive TTDA for training, but the improvements start stagnating as we increase the number of neighboring sensors.

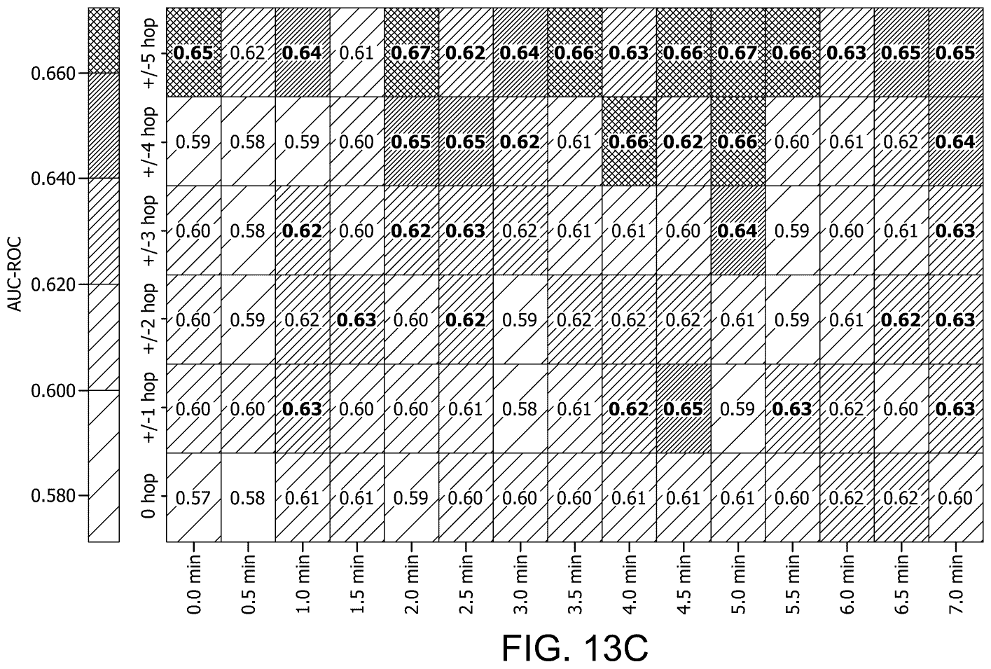

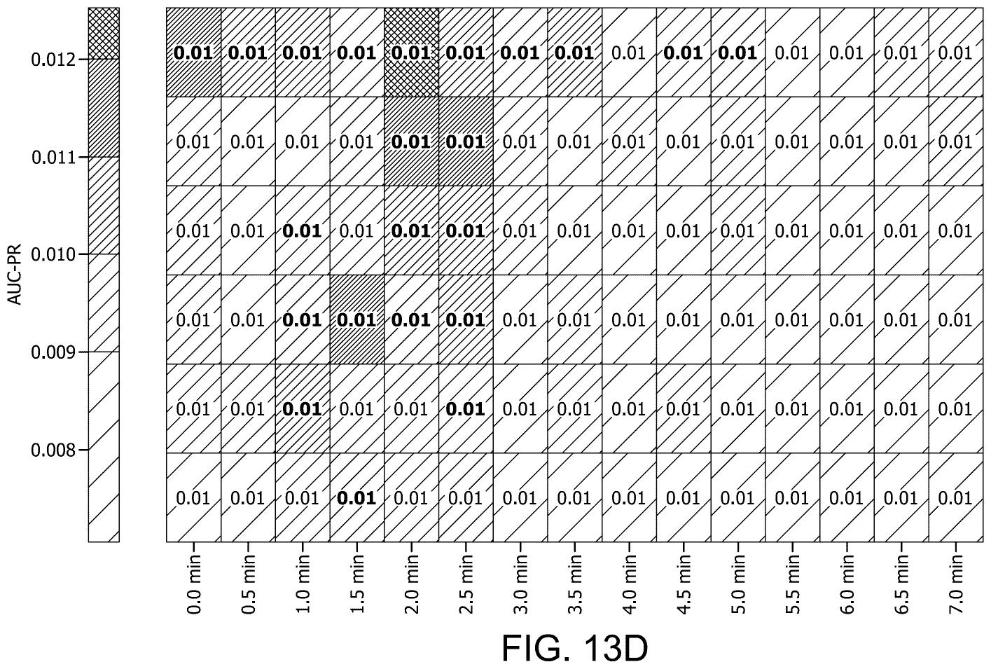

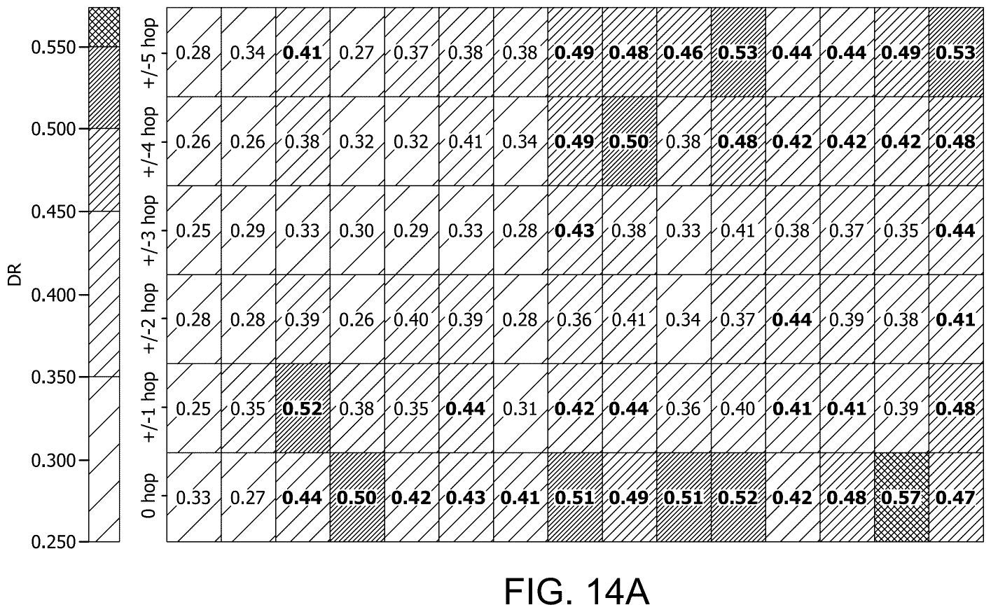

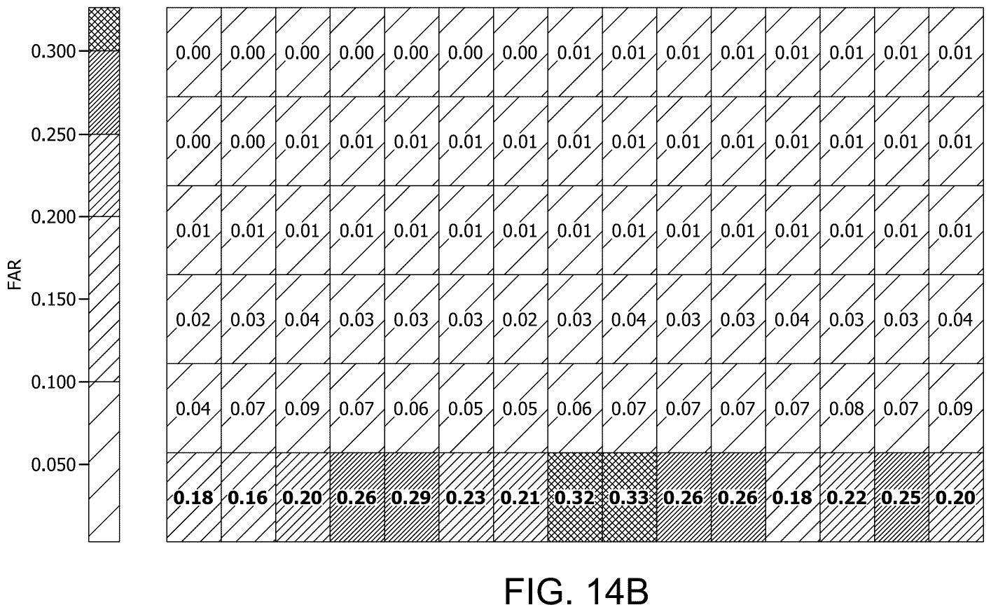

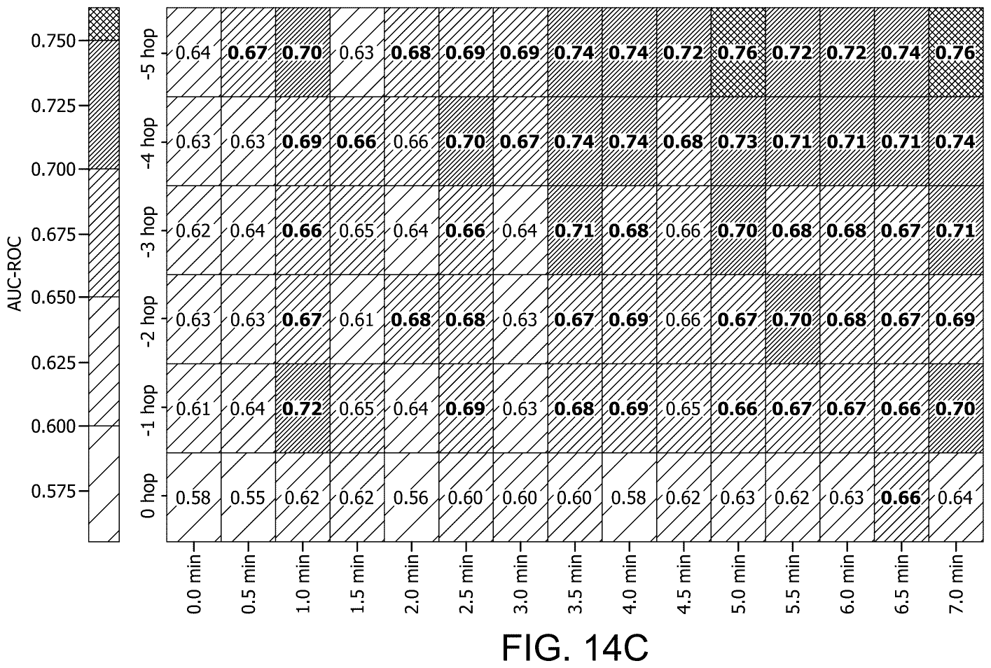

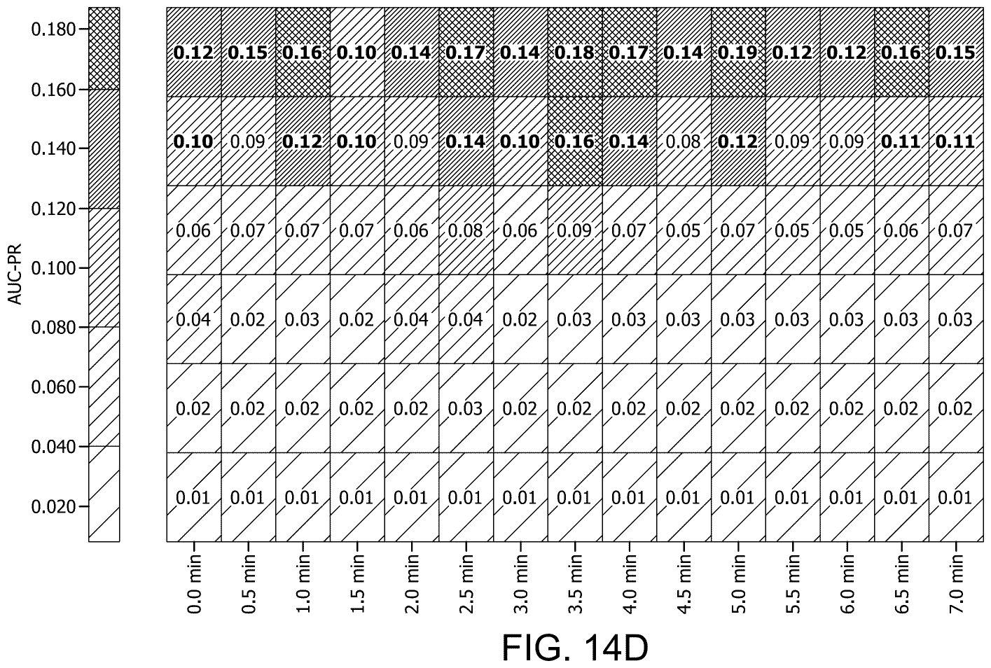

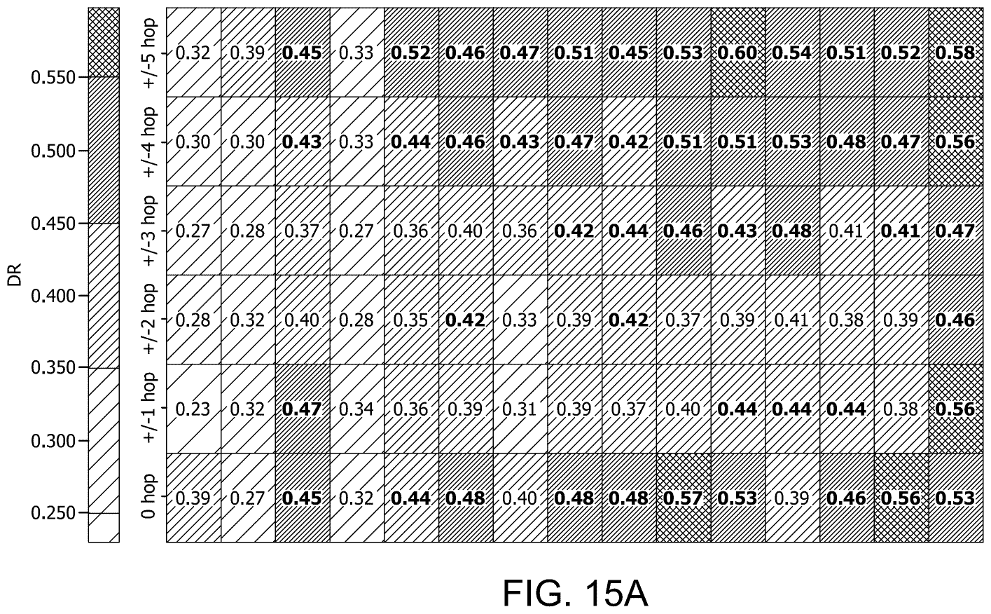

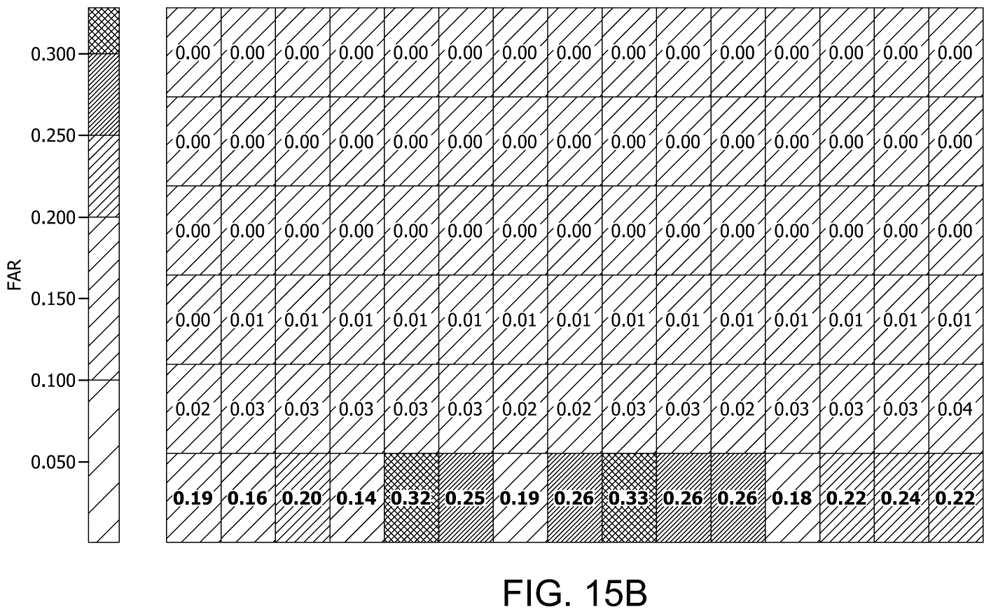

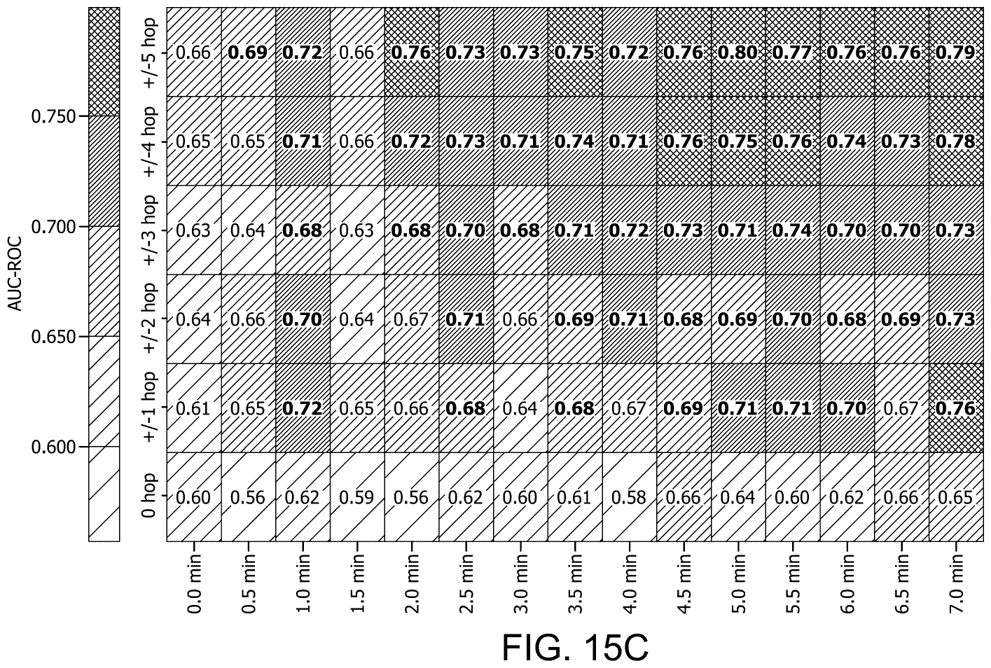

FIGS. 14 and 15 show classification results for a random forest classifier under Settings 1 and 2, respectively. Under Setting 1, using more upstream sensors helps improve every classification metric. Additionally, the 19% performance peak in AUC-PR (with a corresponding 76% in AUC-ROC and 1% of FAR) is reached five minutes after an accident occurs. Under Setting 2, the random forest classifier consistently produces better results after incorporating more sensors. The earliest/best performance for AUC-PR is 44% (with a corresponding 76% in AUC-PR and negligible FAR), which is reached at two minutes after an accident occurs.

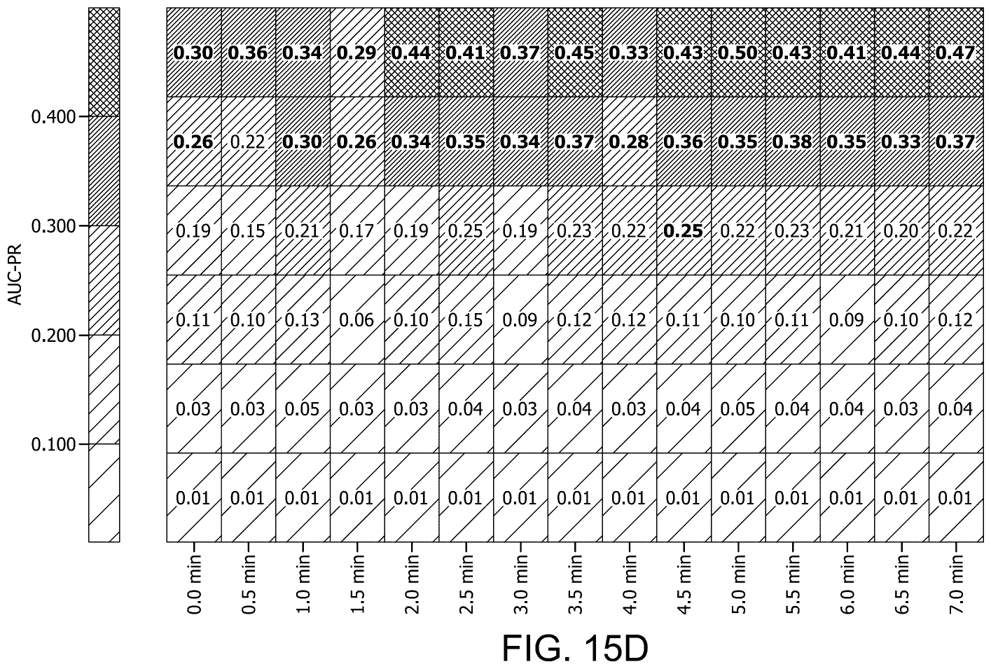

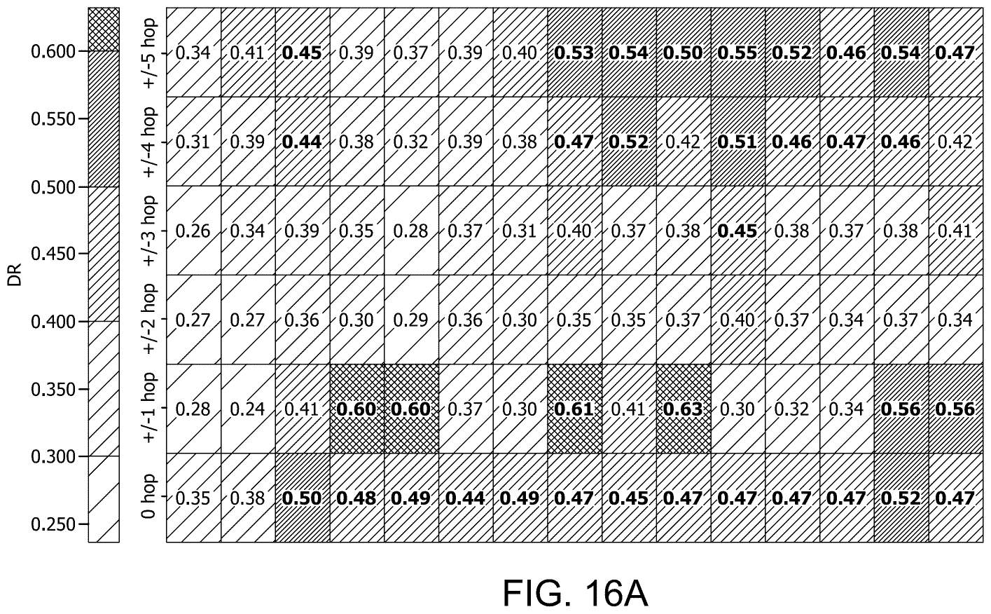

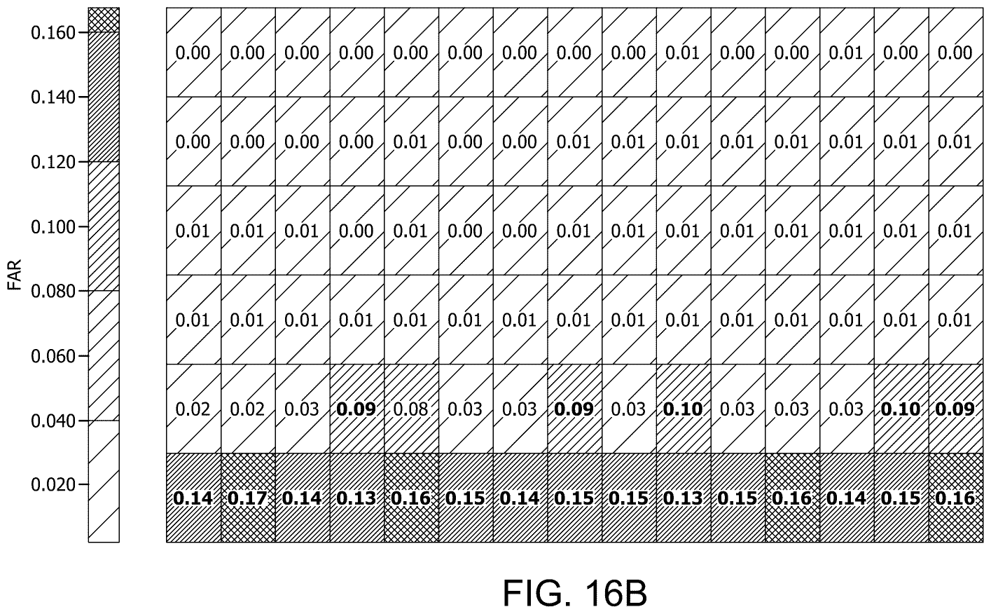

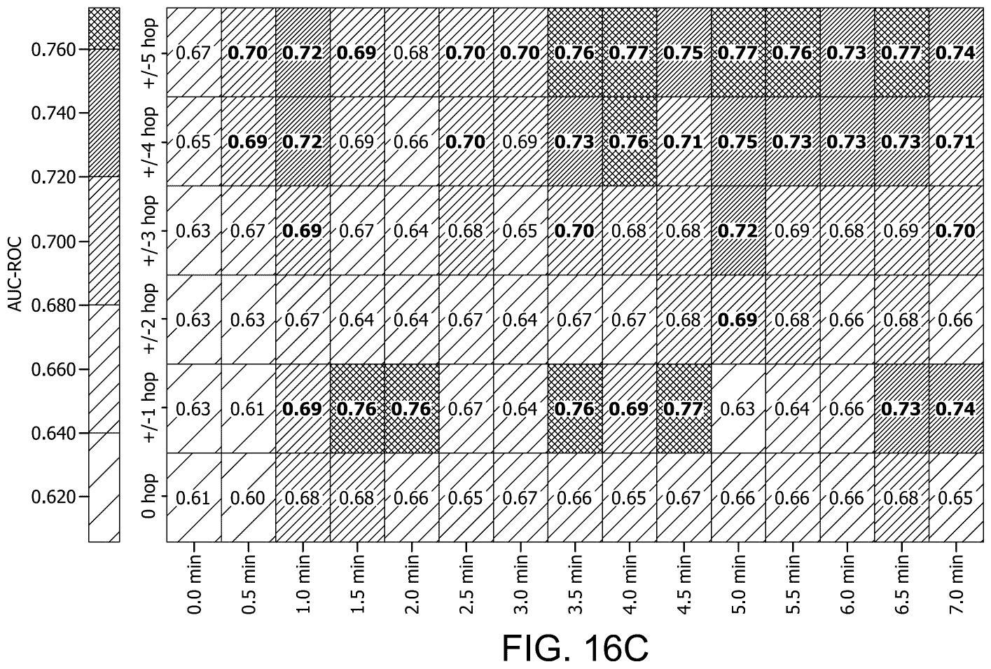

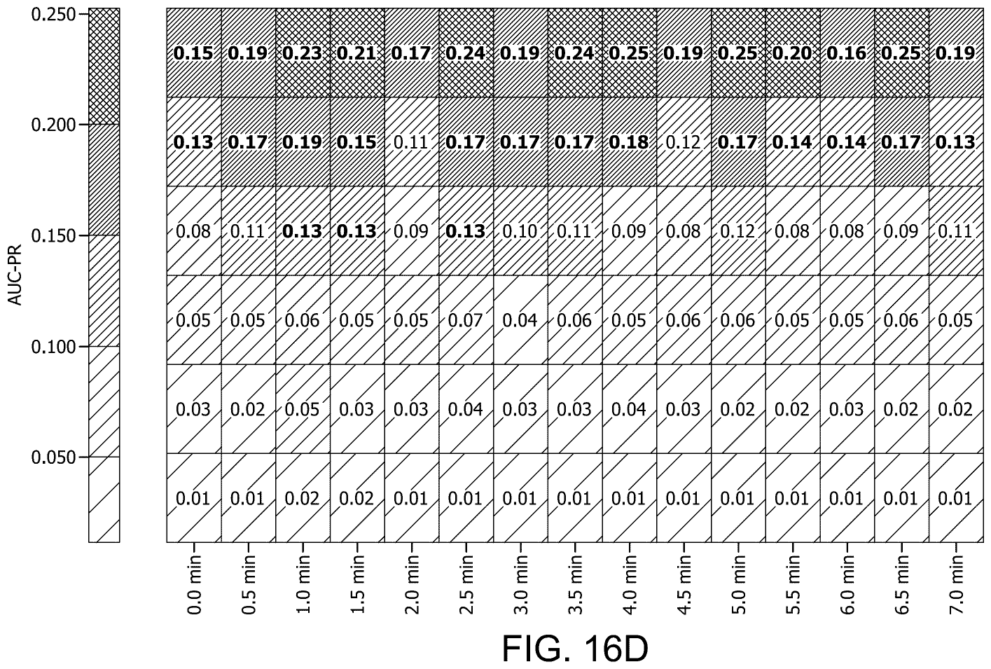

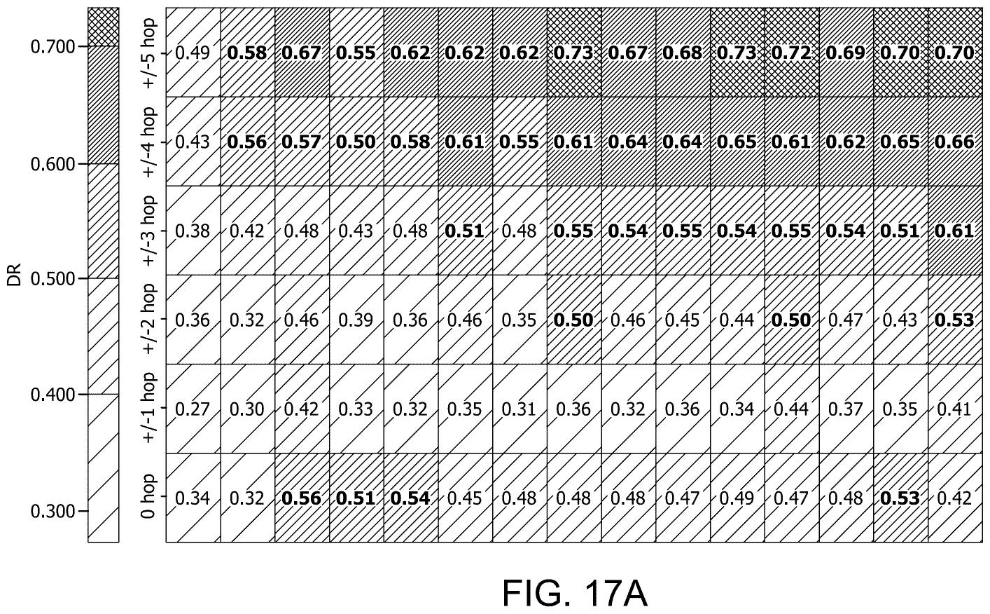

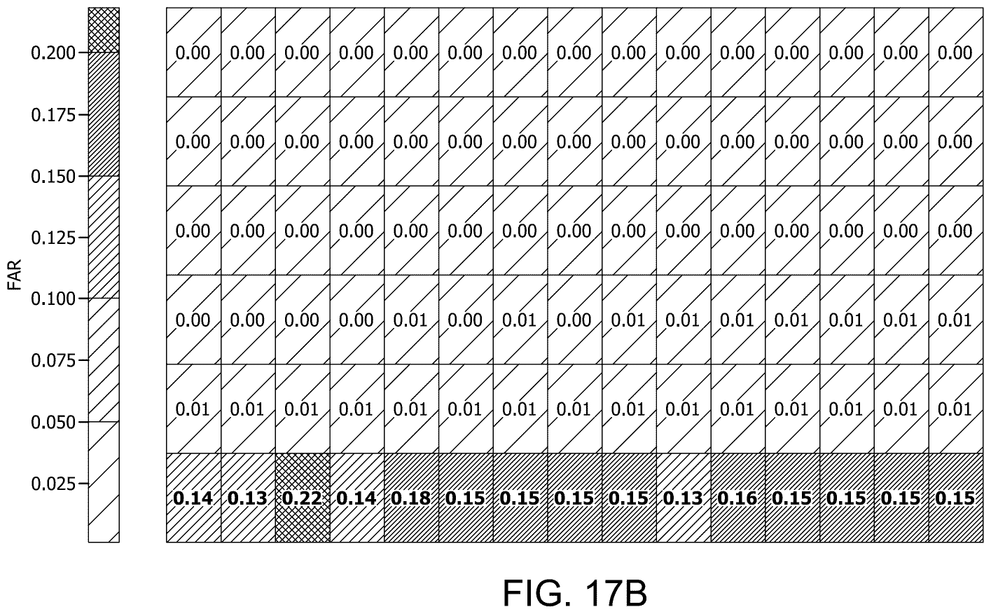

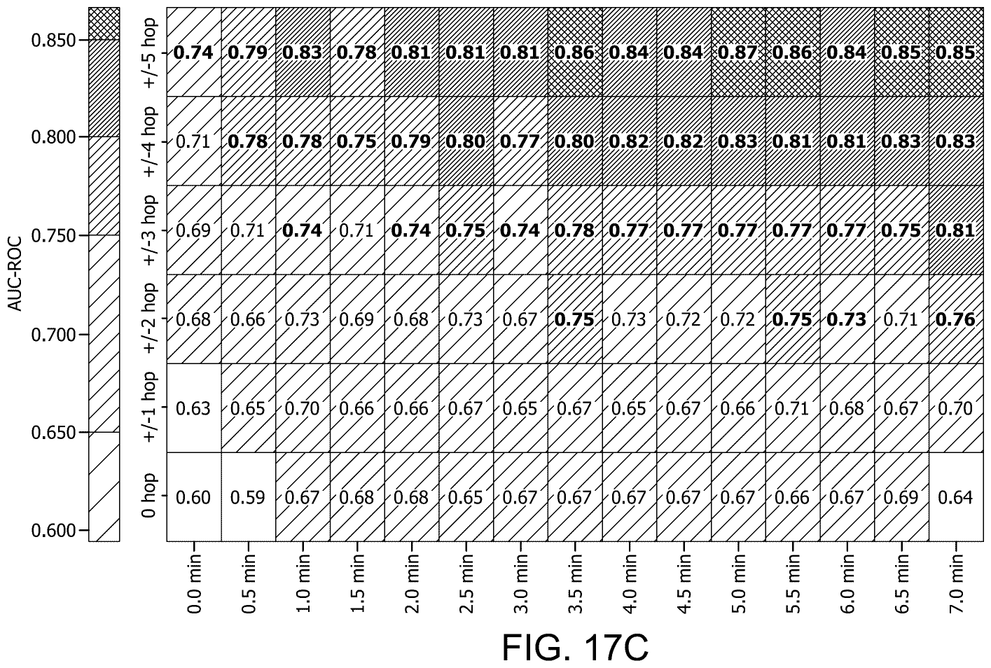

FIGS. 16 and 17 show classification results for an XGBoost classifier under Settings 1 and 2, respectively. Under Setting 1, using more upstream sensors improves classification metrics. Specifically, the earliest performance peak for AUC-PR is 23% (with a corresponding AUC-ROC of 72% and negligible FAR) reached at one minute. In agreement with experiments for I-75, under Setting 2, adding mores sensors (upstream and downstream) improves the overall detection of accidents vs. adding only upstream sensors. In Setting 2, the earliest performance peak for AUC-PR is 49% (with a corresponding AUC-ROC of 83% and negligible FAR) reached at 1.0 minutes after an accident. This represents an improvement of at least 26% in AUC-PR (from 23% to 49%) vs. Setting 1.

TABLE 2 summarizes the results for both settings, both datasets, and all classifiers. Note that even when reporting summary statistics such as the mean and median of performance metrics obtained with different sensor configurations and TTDA, we notice overall superior classification performance under Setting 2 and XGBoost classifier.

### Feature Importance Analysis

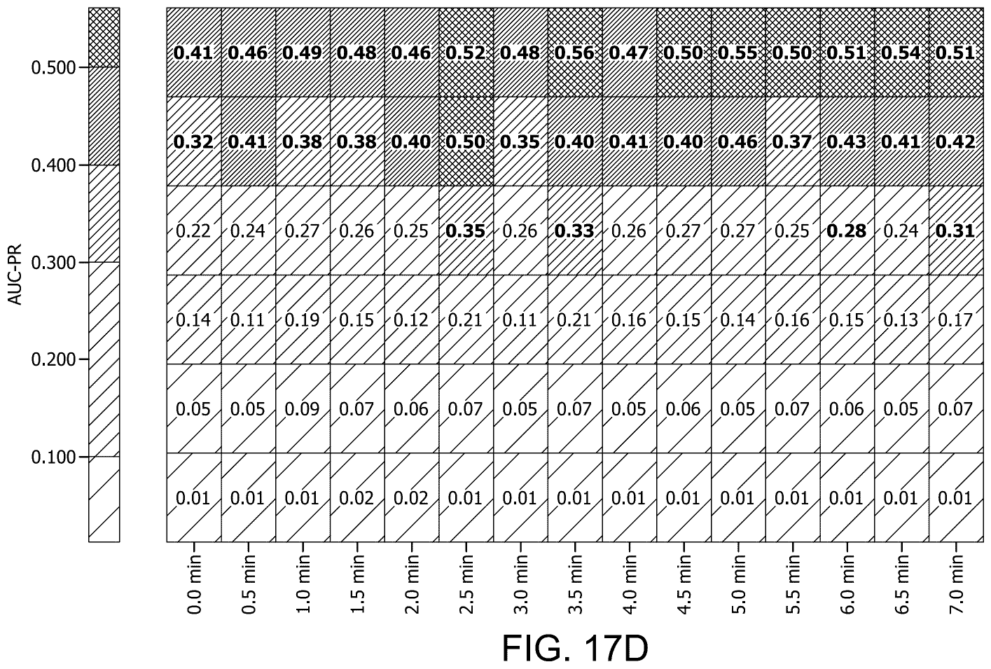

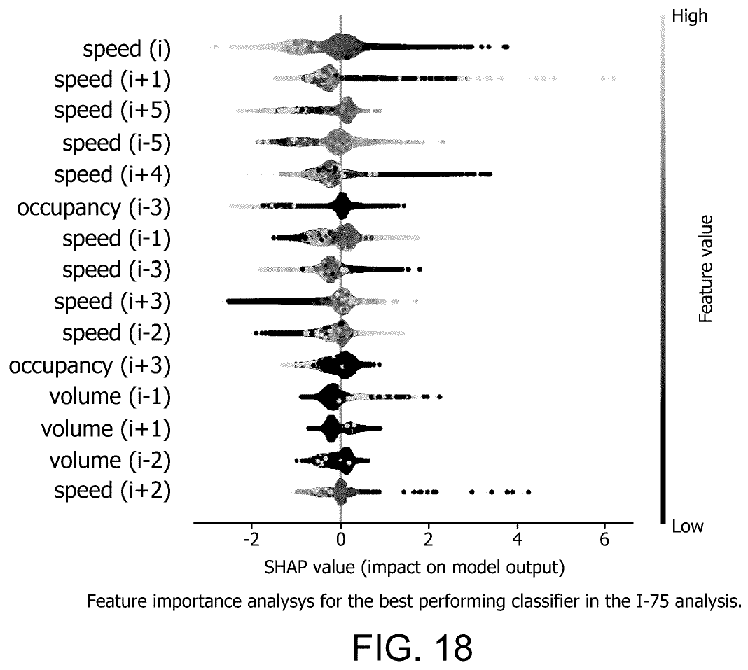

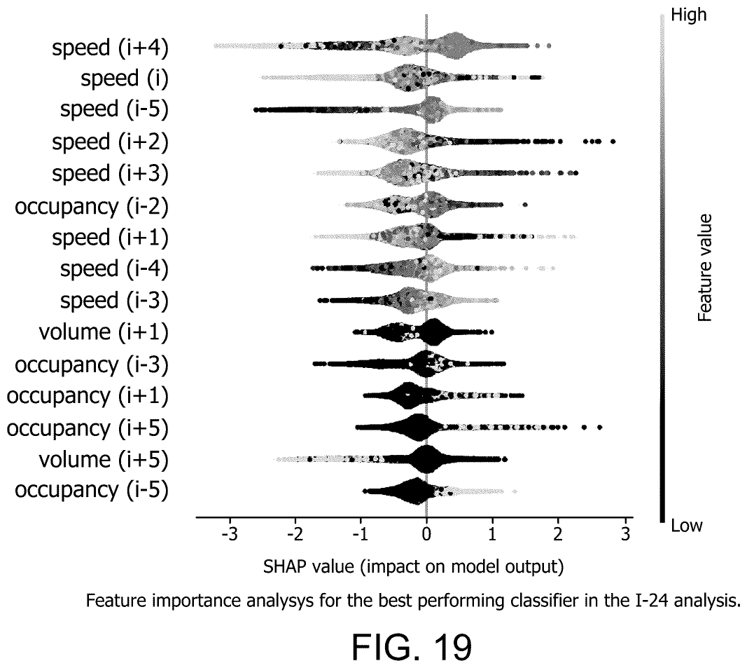

FIGS. 18 and 19 show a summary of feature importance based on classifier predictions in I-75 and I-24, respectively. Recall that SHAP was used to estimate feature importance. The horizontal axis depicts individual SHAP values. The greater the value, the higher the impact on the prediction. The vertical axis represents individual features. Note that features are in decreasing order of importance (from top to bottom). For each feature, the color of each point is determined by its SHAP value: points with higher values are redder, and points with lower values are bluer. The figures highlight the top-15 most important features for the best performing classifier in each case study (i.e., XGBoost under Setting 2) and 5.5 and 3.5 minutes TTDA.

It was observed that traffic-related features, including vehicle speed, traffic volume, and lane occupancy, from downstream and upstream locations have the greatest impact on classifier outputs. Note the importance of considering both upstream and down-stream features (Setting 2) vs. only upstream features (Setting 1). Accidents affect traffic features both upstream and downstream, so considering both helps improve classification performance and reduce TTDA. Additionally, measurements from sensors that are farther away from the accident locations (i.e., more than one hop apart) tend to have a stronger influence on classification results. In fact, perceived changes in traffic conditions from more distant sensors help discriminate between accidents and non-accident events vs. considering only the sensors closest to the accident. This reinforces the idea that a shock wave moves rapidly around neighboring locations after accidents.

Note also that higher SHAP values associated with higher feature values (redder points) correspond to higher accident probabilities. Conversely, higher SHAP values associated with lower feature values (bluer points) correspond to lower accident probabilities. In general, when present in the top fifteen of features, upstream measurements one-hop apart (i.e., −1 hop) tend to associate lower speed and lower volume values with higher chances of an accident. In contrast, downstream measurements one-hop apart (i.e., +1 hop) tend to associate higher speed and lower volume values with higher chances of an accident. This is consistent with previous empirical measurements on the topic.

Finally, weather- and lighting-related features tend to be less relevant features, and they do not appear in the top fifteen. That said, it was found that snow conditions have a slight positive impact on accident occurrence, followed by adverse lighting conditions (not shown in the figures).

Reducing accident response time is crucially important for saving lives. Recent progress has shown the potential of using ML classifiers and traffic-related data to achieve this goal. However, despite the use of more sophisticated classifiers, more progress must be made to reduce the TTDA and improve classification performance, both of which have plateaued. To that end, a novel automatic accident detection framework is described that exploits the topological deployment of sensors in the road and their associated data. Specifically, it is shown how using data from neighboring sensors around accidents, along with weather and lighting data, can reduce TTDA while improving classification performance. The disclosed framework shows how automatic accident detection can be optimized by combining spatiotemporal traffic data to minimize the TTDA and maximize classification performance.

To validate the effectiveness of the disclosed framework, accident detection was analyzed on two highway stretches over I-75 and I-24 in the Chattanooga metropolitan area. Different ML classifiers (logistic regression, random forest, and XGBoost) were tested over a dataset of twenty-four accidents and 3,039 non-accident events for I-75 and thirty-one accidents and 4,852 non-accidents events for I-24. After carefully balancing the dataset and using traffic data from both upstream and downstream locations, the best performing classifier (XGBoost) achieves 45% AUC-PR, 82% AUC-ROC, 64% DR, and negligible FAR at 5.5 minutes TTDA for I-75 and 56% AUC-PR, 86% ROC-AUC, 73% DR, and negligible FAR at 3.5 minutes TTDA for I-24.

An evaluation was made as to how different configurations of spatiotemporal traffic data affect the classification task for detecting accidents at road segments. Including both upstream and downstream traffic data up to a certain distance increases classification performance while reducing the TTDA. A similar analysis was performed by including only traffic data from upstream traffic and corroborated that adding traffic data from downstream sensors leads to more accurate accident detection and reduced TTDA. This key observation was tested by using different ML classifiers and computed the most important features that drive classification.

The disclosed framework provides insights on how to leverage traffic data to reduce accident response time and increase classification performance based on spatiotemporal analysis of traffic.

The present framework was trained and tested on empirical, static datasets. Results were reported on these datasets that showed, based on the configuration of sensors used in the classification task, it is possible to guarantee a peak in performance for a specific TTDA. A real-time field evaluation of the disclosed framework can be performed on real-time data feeds produced by a transportation agency.

Results were presented on the performance of classifiers trained and tested on static datasets. However, accident patterns continuously evolve, and classifiers must adapt based on updated traffic patterns of accident and non-accident conditions.

The incident datasets used contain only accident events and associated metadata. Although the traffic sensor data includes all scenarios for the studied time frame, the incident datasets did not include ground-truth data for other events that may influence traffic patterns (e.g., construction, special events in the city). This means that the accident detection presented herein cannot account for such incidents.

The study focused on a single linear neighborhood between sensors near junctions. However, incidents that occur close to junctions may affect upstream or downstream traffic on multiple highways. For instance, if there was an accident on I-75 southbound immediately north of its junction with I-24, then this would affect downstream traffic on I-24 westbound and I-75 southbound. Similarly, an accident in the northbound direction could affect upstream traffic from I-24 eastbound and I-75 northbound.

A grid search was performed over a subset of hyperparameters for the disclosed classifiers that had been explored in previous research. Additional hyperparameters may be explored that could further improve performance.

The results show how to reduce the TTDA by using ML classifiers and leveraging the traffic impact of accidents in upstream and downstream traffic conditions. Field experiments can be performed to validate the results based on the rich data sources readily available, as shown in the two case studies.

The utility of using spatiotemporal traffic data sources for the quick and accurate detection of accidents by leveraging different ML classifiers (i.e., logistic regression, random forest, and XGBoost) has been shown. As a complement to current automatic accident detection approaches, it has been demonstrated a proof-of-concept to reduce the accident response time while increasing classification performance to as early as one minute after accident occurrence with an AUC-ROC of up to 83% and an AUC-PR of up to 49%. The disclosed framework relies on empirical traffic data along with weather and lighting data sources. It has been demonstrated the benefits of using the present approach on a set of twenty-four accidents on I-75 and thirty-one accidents on I-24 in the Chattanooga metropolitan area. The framework described herein relies on accidents having a shock wave effect that expands to neighboring locations upstream and downstream from accidents. Thus, considering traffic data from more distant accident locations helps to more quickly identify accidents. Relying on this observation, an automatic accident detection framework is detailed based on ML classification for quick and accurate detection of accidents. Specifically, it was shown that the disclosed framework can detect accidents rapidly while still performing reasonably well. After two minutes TTDA, the system achieved 38% AUC-PR, 74% AUC-ROC, 48% DR, and negligible FAR for I-75. After one minutes TTDA, the system achieved 49% AUC-PR, 83% ROC-AUC, 67% DR, and negligible FAR for I-24.

The disclosed technologies can be used for the following applications.
Real-time incident detection: examine the effectiveness of the disclosed framework with real-time traffic data from radar detectors. It is expected that in the near future, this data can be readily available and accessible through APIs across different transportation authorities in the United States.
Integration in traffic analysis platforms: integrate the disclosed methods in data-driven platforms for transportation analysis, monitoring, and data visualization, such as the Regional Integrated Transportation Information System, which is coming online across many states.
Probe data: using probe data as an alternative to stationary sensors to obtain link-level speeds. As the penetration rates for most available probe data are fairly low (5-10% of all vehicles/devices in many areas), the resulting traffic counts may not be reliable and there could be delays in reporting speed changes due to the sparser sampling of vehicles. However, probe data have the advantage of not requiring traffic infrastructure to be in place.

In summary, an implementation of a prototype for automatic accident detection, based on the principles described here, should be feasible with the availability of real-time data from diverse traffic-related, data-driven platforms.

TABLE 2

| Configuration | | | DR | FAR | AUC-ROC | AUC-PR |
|---|---|---|---|---|---|---|
| Setting 1 | I-75 | LR | 0.57 (0.07)/0.57 | 0.40 (0.06) 0.40 | 0.59 (0.03)/0.59 | 0.01 (0.00)/0.01 |
| | | RF | 0.31 (0.07)/0.30 | 0.06 (0.09)/0.02 | 0.62 (0.03)/0.63 | 0.05 (0.03)/0.04 |
| | | XG | 0.39 (0.12)/0.34 | 0.08 (0.11)/0.01 | 0.66 (0.04)/0.65 | 0.07 (0.06)/0.05 |
| | I-24 | LR | 0.60 (0.05)/0.60 | 0.39 (0.02)/0.39 | 0.61 (0.02)/0.60 | 0.01 (0.00)/0.01 |
| | | RF | 0.39 (0.08)/0.40 | 0.06 (0.09)/0.02 | 0.67 (0.04)/0.67 | 0.06 (0.05)/0.04 |
| | | XG | 0.41 (0.09)/0.40 | 0.04 (0.05)/0.01 | 0.69 (0.04)/0.68 | 0.09 (0.07)/0.07 |
| Setting 2 | I-75 | LR | 0.55 (0.07)/0.55 | 0.35 (0.05)/0.34 | 0.60 (0.04)/0.60 | 0.01 (0.00)/0.01 |
| | | RF | 0.33 (0.08)/0.33 | 0.05 (0.10)/0.01 | 0.64 (0.04)/0.64 | 0.11 (0.09)/0.09 |
| | | XG | 0.43 (0.11)/0.41 | 0.06 (0.11)/0.01 | 0.69 (0.05)/0.68 | 0.15 (0.12)/0.12 |
| | I-24 | LR | 0.57 (0.05)/0.57 | 0.34 (0.03)/0.34 | 0.62 (0.02)/0.62 | 0.01 (0.00)/0.01 |
| | | RF | 0.42 (0.08)/0.42 | 0.05 (0.09)/0.00 | 0.69 (0.05)/0.69 | 0.18 (0.15)/0.15 |
| | | XG | 0.50 (0.12)/0.49 | 0.03 (0.06)/0.00 | 0.74 (0.07)/0.73 | 0.23 (0.18)/0.22 |

Table 2 shows a summary of performance. Numbers are presented as mean (standard deviation)/median. Classification methods are logistic regression (LR), random forest (RF), and XGBoost (XG).

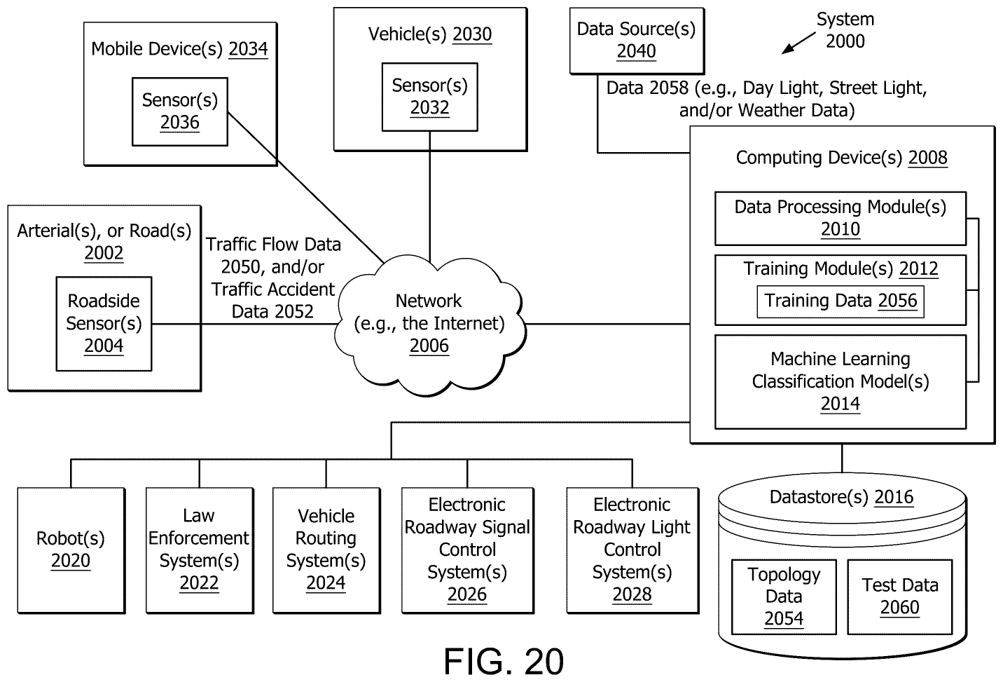

FIG. 20 provides an illustration of a system 2000 implementing the present solution. System 2000 is generally configured to train machine learning classification model(s) 2014 and implement the trained machine learning classification model(s) in the field. In this regard, system 2000 comprises a plurality of data sources. The data sources include, but are not limited to: roadside sensor(s) 2004 disposed on, adjacent to and/or in proximity to arterial(s) and/or road(s) 2002; sensor(s) 2036 of mobile device(s) 2034; sensor(s) 2032 of vehicle(s) 2030; data source(s) 2040; and/or datastore(s) 2016 storing at least topology data 2054 for roadside sensors 2004. Sensor(s) 2036, 2032 can include, but are not limited to, location sensor(s) (e.g., GPS), accelerometer(s), camera(s), microphone(s), and/or radar(s). Data source(s) 2040 can include any electronic device configured to provide day light information, street light information, and/or weather data. Vehicle(s) 2030 can be autonomous vehicle(s), semi-autonomous vehicle(s), manually operated vehicle(s), and/or teleoperated vehicle(s).

The roadside sensor(s) can include, but are not limited to, radar(s), camera(s), and/or microphone(s). The roadside sensor(s) are configured to generate traffic flow data 2050 and/or traffic accident data 2052. The traffic accident data 2052 can include, but is not limited to, accident data from 911 calls, operators and/or law enforcement. The data 2050, 2052 is communicated from the sensor(s) 2004 to remote computing device(s) 2008 via a network 2006 (e.g., the Internet). The traffic flow data sent from a given roadside sensor includes, but is not limited to, traffic volume, vehicle speed, lane occupancy, and/or a sensor location indictor (e.g., a sensor name). The traffic accident data can include, but is not limited to, timestamp(s), location(s), and traffic information.

Computing device 2008 is configured to train machine learning classification model(s) 2014 and use the trained machine learning model(s) to perform various operations for decreasing fuel usage of the vehicle(s) 2030, improve safety of the arterial(s) or road(s) 2002, improve personal safety of pedestrian(s) and/or occupant(s) of the vehicle(s) 2030, and/or improve comfort of occupant(s) of the vehicle(s) 2030. For example, the trained machine learning classification model(s) 2014 can be used in commercial trucking applications for routing trucks to avoid or travel around traffic to reduce the trucks fuel consumption. The trained machine learning classification model(s) 2014 can additionally or alternatively be used in consumer applications for routing vehicle(s) around traffic and/or controlling driving operations of the vehicle(s) such that occupant safety and comfort standards are met and/or maintained. The present solution is not limited to the particulars of these examples.

During operation of system 2000, computing device 2008 may perform the following operations: (i) obtaining the traffic flow data 2050, traffic accident data 2052, roadside sensor topology data 2054 and/or other data 2058 (e.g., day light data, street light data, and/or weather condition data); (ii) creating a training data 2056 based on the obtained data; (iii) using the training data 2056 to train the machine learning classification model(s) 2014; (iv) testing the trained machine learning classification model(s) 2014 using test data 2060; (v) analyzing outputs of the trained machine learning classification model(s) 2014 to obtain evaluation metrics; (vi) analyzing the evaluation metrics; and (vii) implementing the trained machine learning classification model(s) in the field as trained machine learning classification models. The machine learning classification model(s) 2014 can include, but are not limited to, logistic regression classifier(s), random forest classifier(s), XGBoot classifier(s), and/or other classifier(s).

The machine learning classification model(s) 2014 are trained to detect patterns in input data indicating that a traffic accident or incident has occurred (with a certain likelihood or probability) on a particular segment of a road. The input data can include, but is not limited to, real time traffic flow data, weather data, and/or light data. The real time traffic flow data can be considered from one roadside sensor or a plurality of neighbor roadside sensors. A roadside sensor may be considered a neighbor roadside sensor when it is located up to N (e.g., 1-5) hops away from a given roadside sensor, and/or is located within a given distance (e.g., M miles) from the given roadside sensor. N and M are integers greater than or equal to one. N and M may be the same integer or different integers.

Once a pattern is detected in the input data, the machine learning classification model(s) 2014 provides an output. The output of the trained machine learning classification model(s) 2014 can include, but is not limited to, a probability value indicating the probability that a traffic accident or incident has occurred or is occurring, and/or a likelihood value indicating the likelihood that a traffic accident or incident has occurred or is occurring.

The output of the machine learning classification model(s) 2014 can then be analyzed to determine whether a remedial measure should be taken. For example, the probability or likelihood value is compared to threshold value(s) to determine if a criterion has been met. If so, the computing device 2008 may then select one or more actions from a plurality of actions. The actions can include, but are not limited to: (i) controlling robot(s) to monitor the geographic area(s) where a traffic accident has probably/likely occurred or is probably/likely occurring; (ii) controlling law enforcement system(s) to update incident data and/or map(s) and/or cause personnel to be dispatched to the geographic area(s) where a traffic accident has probably/likely occurred or is probably/likely occurring; (iii) controlling vehicle routing system(s) to generate new route(s) for vehicle(s) or update current route(s) for vehicle(s) to avoid or travel around the geographic area(s) where a traffic accident has probably/likely occurred or is probably/likely occurring; (iv) controlling electronic roadway signal control system(s) to route traffic away from or around the geographic area(s) where a traffic accident has probably/likely occurred or is probably/likely occurring; and/or (v) controlling electronic roadway light control system(s) to adjust traffic flow (e.g., slow) in the direction of the geographic area(s) where a traffic accident has probably/likely occurred or is probably/likely occurring. Systems 2022, 2024, 2026 and 2028 are well known. Any known or to be known law enforcement system, vehicle routing system, electronic roadway signal control system, and/or electronic roadway light control system can be used here.

FIG. 21 provides an illustration of an environment 2100 in which the present solution is implemented. An arterial 2002 is located in the environment 2100. A vehicle 2030 is traveling on the arterial 2002 in a direction shown by arrow 2102. Roadside sensors 2004₁, 2004₂, . . . , 2004ₙ are disposed along the arterial 2002. Arterial 2002 has been segmented into a plurality of segments S1, S2, . . . , Sn based on the locations of the roadside sensors 2004₁, 2004₂, . . . , 2004ₙ. For example, each segment comprises a portion of the arterial 2002 that extends a certain distance on both sides of a respective roadside sensor. The present solution is not limited in this regard. One or more of the segments S1, S2 may be considered upstream segments relative to the vehicle 2030, and one or more of the segments Sn may be considered downstream segments relative to the vehicle 2030. Electronic roadway light(s) 2110 and/or electronic roadway signal(s) 2112 may be disposed along the arterial 2002. Any known or to be known electronic roadway light(s) and/or sign(s) can be used here.

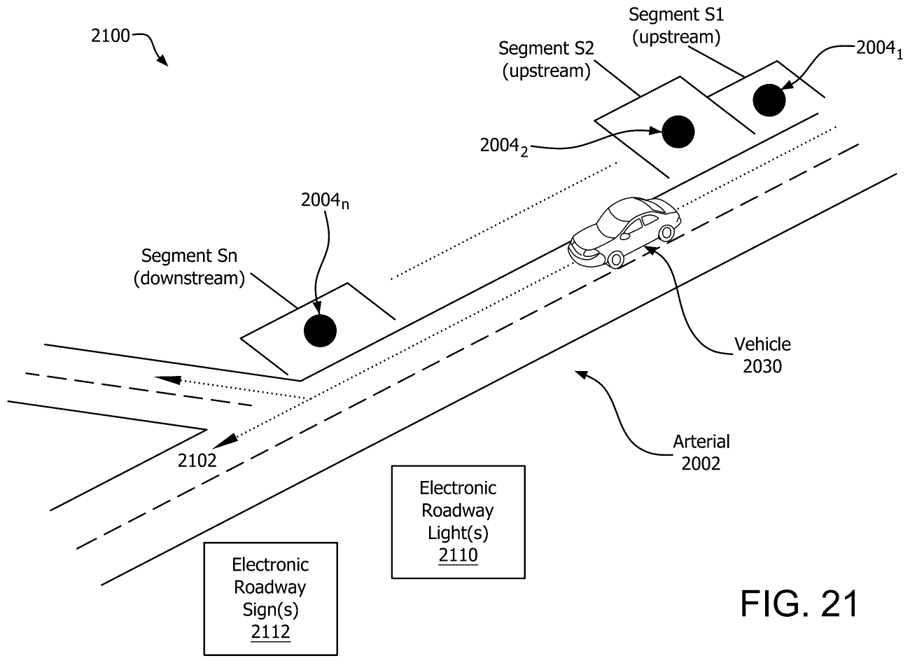

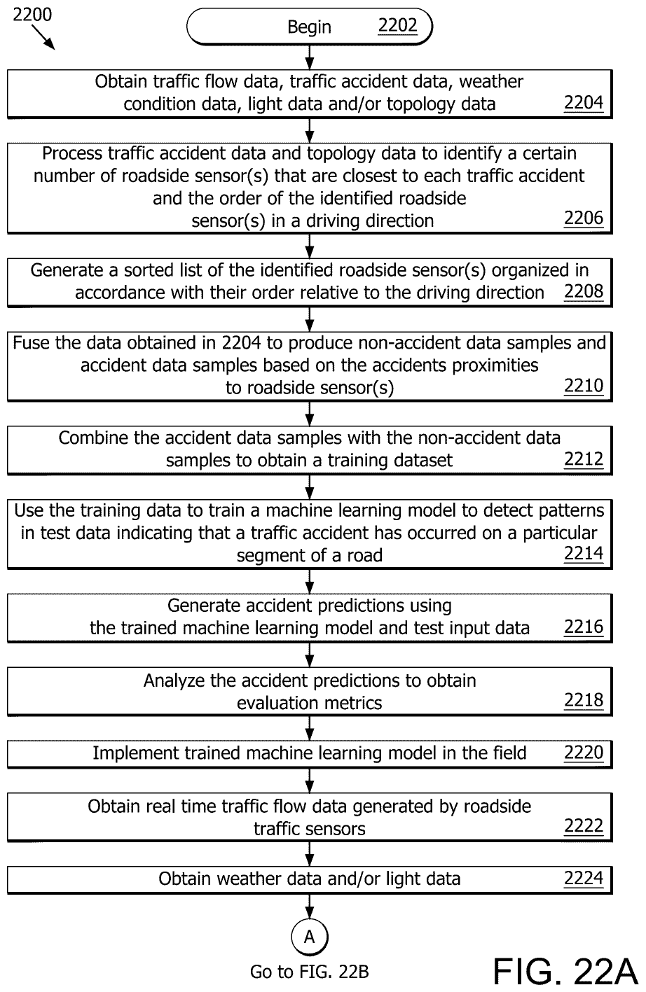

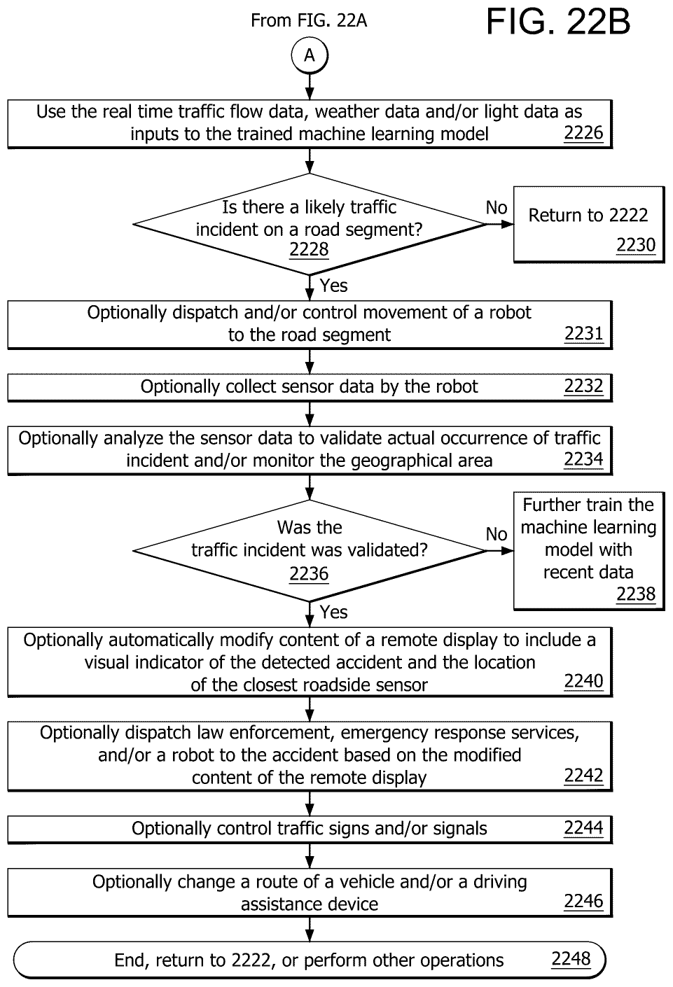

FIG. 22 provides a flow diagram of an illustrative method 2200 for detecting traffic accidents and/or incidents, and controlling electronic device(s) based on the detected traffic accidents and/or incidents. It should be noted that an incident is any event or condition which has an impact on traffic. An accident is a specific type of incident which involves a crash between a vehicle and another entity (another vehicle, an object, a person, an animal, etc.). Method 2200 implements the present solution for detecting the traffic accidents and/or incidents in a reduced amount of time as compared to conventional solutions. This reduced detection time provides the present solution with improved fuel usage, road safety, personal safety, and/or ride comfort in mobile platform applications.

Method 2200 begins with block 2202 and continues to block 2204 where the system (e.g., computing device 2008 of FIG. 20) obtains traffic flow data (e.g., traffic flow data 2050 of FIG. 20, traffic accident data (e.g., traffic accident data 2052 of FIG. 20), and/or topology data 2054 of FIG. 20). The traffic accident data and topology data are processed in block 2206 by the system to identify a certain number of roadside sensor(s) (e.g., roadside sensor(s) 2004 of FIG. 20) that are closest to each traffic accident identified in the traffic accident data and to obtain an order to the identified roadside sensor(s) relative to a driving direction of road(s) (e.g., road(s) 2002 of FIG. 20 and/or FIG. 21). Next in block 2208, the system generates a sorted list of the identified roadside sensor(s) organized in accordance with their order relative to the driving direction.

The data obtained in block 2204 is fused to produce non-accident data samples and accident data samples based on the accident proximities to roadside sensor(s). The traffic flow data, weather condition data and light condition data is fused with traffic accident data in a format that is relatively easy to process using machine learning tools, databases, or data workflows. The purpose of this data is to analyze, predict, and detect traffic patterns when accidents occur or are occurring. Each file contains a timeseries of traffic speeds, flows, and occupancies at the roadside sensor nearest to the accident, as well as N neighboring roadside sensors upstream and downstream from the accident. It also contains information about the accident type, date, and time. In addition to the accident data, baseline data is provided for typical traffic patterns during a given time of day. Overall, the dataset contains months of annotated traffic data. For example, in one study, the dataset may contain six months of annotated traffic data from November 2020 to April 2021. During this timeframe, and three hundred sixty-one accidents occurred in the monitored area around Chattanooga, Tennessee. This dataset served as the basis for a study on topology-aware automated accident detection. The present solution is not limited to the particulars of this example and/or study.

In some scenarios, the (non-)accident data samples may be stored one sub named accidents and one folder named non-accidents. The accidents folder contains one file per accident. The non-accidents folder contains files for the same location, day of the week and time as a corresponding accident, for each week during which there was no accident impact on the traffic.

The file names may be formatted as follows: yyyy-mm-dd-hhmm-rrrrrXaaa.a.csv, consisting of date (yyyy-mm-dd), time (hhmm in 24-h format), and sensor name (rrrrrXaaa.a), which consists of road name (rrrrr; 5 alphanumerical characters), heading (X), and mile marker (aaa.a). For example, the file 2020-11-03-1611-00124W182.8.csv contains data for an accident which occurred at 4:11 p.m. on Nov. 3, 2020, on I-24 Westbound near the radar sensor at mile marker 182.8.

The following TABLE 1 list the information which should be included in each (non-)accident data sample. The following TABLE 2 provides a summary of additional metadata that may be provided with the (non-)accident data sample.

TABLE 1
Columns of each timeseries file.

| Column name | Interpretation |
|---|---|
| incident at sensor(i) | 1 for yes (accidents folder), 0 for no (non-accidents folder). |
| road | Road name with heading, e.g., 00124E. |
| mile | Mile marker of nearest radar sensor, e.g., 182.8. |
| type | Accident type, e.g, “Prop Damage (over)” for property damage exceeding a threshold |
| | of $400. For non-accidents, the type is given as “None”. |
| date | Date of the data sample. For accidents, this is the date on which the accident occurred. |
| | For non-accidents, this is the date for which the non-accident data sample is collected. |
| incident_time | Time the reference accident was reported in hh:mm. This is the time which is |
| | provided in E-TRIMS as the time the 911 call was made. |
| incident_hour | Only the hour from the incident_time, in integer format. |
| data_time | Timestamp for the timeseries contained in the file in hh:mm:ss format. The timeseries |
| | consists of 30 s timesteps. |
| weather | Weather during data_time, based on data collected from NASA POWER. We used dry |
| | bulb temperature (° C.), precipitation (mm/h), and wind speed (m/s) from the raw NASA |
| | POWER data to produce the classifications of rain (at least 1 mm precipitation and |
| | temperatures above 2° C.), snow (at least 1 mm precipitation and temperatures at or |
| | below 2° C.) and wind (wind speeds over 30 mph or 13.5 m/s). If there were no |
| | inclement weather conditions, we set the category to “—”. |
| light | Light conditions during data_time. To produce this field, we collected sunrise, sunset, |
| | civil twilight start and civil twilight end times from https://sunrise-sunset.org, and |
| | derived the categories dawn, daylight, dusk, and dark using these start and end times. |
| Radar data | The last 33 columns contain radar data for the 11 sensors surrounding the accident or |
| | non-accident. For each sensor, we collected speed (mean over 30-s interval in miles |
| | per hour, or empty if no vehicles passed), volume (count of all vehicles passing during |
| | 30-s interval), and occupancy (mean % of occupancy over 30-s interval). These three |
| | variables are grouped in triples, of speed (k), volume (k), occupancy (k), where k |
| | indicates the sensor number relative to the closest sensor i to the incident, k < i |
| | indicate upstream sensors and k > i indicate downstream sensors. For example, speed |
| | (i − 5) refers to the mean speed at the sensor which is 5 hops upstream from the |
| | accident, and volume(i + 1) refers to the number of vehicles at the sensor |
| | immediately downstream from the accident. |

TABLE 2
Summary of additional metadata provided.

| Filename | Content |
|---|---|
| Accidents.csv | Cleaned-up accidents file with all accidents which happened on Chattanooga area |
| | highways between Nov. 1, 2020, and Apr. 29, 2021, We have removed accidents |
| | which happened on non-highway roads, and we have corrected the timestamps (which |
| | were in 12-h format but missing a.m./p.m. markers) by cross-referencing light and |
| | weather conditions. |
| WeatherDict.json | Dictionary containing the weather data synthesized from NASA POWER. |
| LightDict.json | Dictionary containing the light data synthesized from Sunrise-and-Sunset. |
| SensorTopology.csv | Neighborhood information for each radar sensor in the Chattanooga area. |
| SensorZones.geojson | Polygons used to determine the nearest radar sensor for each accident location. Each |
| | polygon is tagged with the corresponding radar sensor's name. |

The content of each file is a timeseries of roadside sensor data beginning X minutes (e.g., 15 minutes) prior to the reported accident or incident and ending X minutes after the reported accident or incident. It also contains metadata, such as the accident type, etc. Each file contains the columns in TABLE 1.

The proposed system depends on four other sources: accidents, traffic conditions, weather, and light, and the sensor topology. Each of these datasets will now be described as well as how the datasets can be transformed and synthesized to obtain a final dataset from the data sources.

The accident dataset is an anonymized extract of a richer dataset which TDOT maintain. This extract may be updated weekly and contains all the relevant data for accident detection. It may be tabular and contain numerous columns. Columns A-W contain original data whereas columns X-AJ contain augmented data. The original traffic accident data may have the columns defined in below TABLE 3.

TABLE 3
Accident data provided by E-TRIMS.

| Column Name | Definition |
|---|---|
| County | Full county name. |
| Route | 5-character road name, buffered with zeros between letter and number of the |
| | road. |
| Year of Crash | Year of Crash (yyyy). |
| Date of Crash | Date of Crash (m/d/yyyy). |
| Time of Crash | Time of Crash: hhmm (int); missing a.m./p.m. information. |
| Type of Crash | Identical to type in annotated data. |
| Relation to First Junction | Descriptor of road situation: acceleration/deceleration lane, intersection, |
| | driveway, rail grade crossing |
| Type and severity of crash | Most severe consequences of crash: Property damage, suspected minor/major |
| | injury, fatality. |
| Relation to First Roadway | Crash location with respect to road: On roadway, shoulder, median, parking |
| | lane, parking lot. |
| Total Killed | Number of deaths. |
| Total Inj | Number of individuals with injuries. |
| Total Incap Injuries | Number of individuals with incapacitating injuries. |
| Total Other Injuries | Number of individuals with other injuries. |
| Total vech | Number of vehicles involved in crash. |
| First Harmful Event | What was hit first? Various strictures and living beings one can collide with, |
| | such as fire hydrant, snowbank, curb, deer; other incidents like cargo loss or |
| | shift. |
| Manner of First Collision | How did the collision happen? Sideswipe, rear-end, head-on, angle. |
| Weather Cond | Weather conditions during the crash, e.g., clear, cloudy, rain, fog, sleet/hail, |
| | snow, blowing snow, severe crosswinds, blowing sand/soil/dirt, smog/smoke, |
| | other, and unknown. Most accidents (1105/1593) were reported during clear |
| | weather, 247 occurred during rain, 87 under unknown or undocumented (“—”) |
| | conditions, and 11 during other conditions (sleet/hail, snow, blowing debris, |
| | fog, or other). |
| Light Conditions | Light conditions during the crash, e.g. daylight, dusk, dawn, dark (lighted, not |
| | lighted, unknown lighting), other, and unknown. Most accidents were reported |
| | as daylight (990/1593), 467 occurred in the dark (200 in conditions with |
| | artificial lighting), 73 during twilight conditions, and 14 with unknown or |
| | other lighting conditions. |
| Locate type | How was the location entered? automatic (GPS) or manual. |
| Latitude | Geocoordinates. |
| Longitude | |
| HAZMAT Involved | Was hazardous material released? yes/no/unknown |
| Hit and Run | Yes/no (239 yes, 1354 no). |
| Hwy Const Zone | Highway construction, maintenance, other special conditions, “—”. |

The columns defined in TABLE 4 are augmented to the original data.

TABLE 4
Additional data provide, as described in this paper.

| Column Name | Definition |
|---|---|
| Date | yyyy-mm-dd. |
| Year | Integer. |
| Month | |
| Day | |
| Hour | |
| Minute | |
| Time_orig | Original time as hh:mm (instead of integer) in 12 h format. |
| Time_fixed | Updated time to supplement a.m./p.m. information, in 24 h format using the |
| | methods described below (part of light data processing). |
| Light_orig_simple | Original light data simplified to fewer categories. |
| Light_synth | Synthesized light data based on original time. |
| Light_fixed | Updated light data using the methods described below. |
| Weather_orig_simple | Original weather data simplified to fewer categories. |
| Weather_fixed | Weather_fixed: synthesized weather data. |

The traffic condition data may be collected from roadside sensors. The roadside sensor can include, but are not limited to, radars which emit low-energy microwave radiation that is reflected by the vehicles and captured by the roadside sensor at lane resolution. At 30-second intervals, these radar-based roadside sensors collect the following parameters: sensor name and ID; lane name and ID; average speed in miles per hour; vehicle count; lane occupancy; and vehicle class based on length. The sensor name may contain the road, heading, and mile marker in a fixed naming scheme.

To create the accident dataset, the data was for each separate lane and/or aggregated across lanes.

The weather condition data from the accident dataset may contain many different weather conditions. In a first step, these categories may be simplified to a smaller set which is reproducible using other data sources: rain, snow (snow, sleet/hail, blowing snow), wind (severe crosswinds, blowing sand/soil/dirt), and unknown (clear, cloudy, other, unknown). POWER data may then be used to reproduce these categories from the hourly measurements. The variables described in TABLE 5 from this dataset may be used.

TABLE 5
Relevant data obtained from NASA's POWER dataset.

| POWER Variable Name | Definition |
|---|---|
| Temperature (C.) | Average air (dry bulb) temperature at 2 m above the surface. |
| Precipitation (mm/hour) | Average of total precipitation at the surface, including warer content in snow. |
| Wind Speed (m/s) at 2 m | Wind speed at 2 m above the surface. |
| Surface Pressure (kPa) | Average pressure at the surface of the earth. |

Basic measurements may be used to synthesize weather conditions for the four categories, as outlined in TABLE 6.

TABLE 6
Weather conditions derived from POWER data.

| Weather Condition | Definition |
|---|---|
| Precipitation | According to the United States Geological Survey (USGS), a “heavy (thick) |
| | drizzle” is defined as 1 mm of precipitation per hour, and it can impair |
| | visibility. We therefore used 1 mm as our threshold to determine |
| | precipitation, and we classify it as |
| | Rain if the temperature was >2° C., or |
| | Snow if the temperature was ≤2° C. |
| Wind | According to the National Weather Service, sustained winds of 30 mph of |
| | wind gusts of 45 mph can make it difficult to drive high-profile vehicles, |
| | and small objects may be blown around. Based on this definition, we used |
| | the category wind if wind speeds exceeded 13.5 m/s (30 mph). |
| (unknown) | if the category was neither rain, snow, nor wind, we define it as unknown. |

When multiple categories were possible (e.g., blowing snow could be wind or snow in this scenario), we chose the category with a bigger traffic impact based on FHWA's report.

A dictionary may be created for efficient access by date and hour. This may allow relatively quickly look-ups of weather information for any given timestamp. For example, to access the weather conditions on November 12 at 1 p.m., the system could use weather[‘2020-11-12’]][‘13’].

The lighting condition data from the accident data may contain various lighting conditions, including artificial lighting as well as natural daylight conditions. Working on the assumption that artificial lighting conditions did not change during the study period (i.e., no additional lights were added, and there were no widespread outages), the study focused on only the natural daylight information. However, the present solution is not limited in this regard. The sunrise-and-sunset (Sunrise Sunset) dataset has timestamps at minute resolution for (i) civil, nautical, and astronomical twilight start, (ii) sunrise, (iii) solar noon, (iv) sunset, and (v) civil, nautical, and astronomical twilight end. For the study, civil twilight was selected because it accounts for the local topography which can affect actual lighting conditions. The data is aggregated into four light conditions, as listed in TABLE 7.

TABLE 7
Definition of light conditions based on
sunrise, sunset, and twilight times.

| Light Condition | Definition |
|---|---|
| Dawn | Civil twilight start until sunrise, |
| Daylight | Sunrise until sunset, |
| Dusk | Sunset until civil twilight end, and |
| Dark | Civil twilight end until civil twilight start. |

To prepare light data for more efficient access, a dictionary can be created which allows the system to look up light conditions by date and timestamp. For example, to access the weather conditions on November 12 at 13:14 p.m., one would use light[‘2020-11-12’][‘13:14’].

For each timestamp, the system checks which lighting condition it corresponds to by using the mapping provided in the list above. In addition, this data allowed the system to address the issue of missing a.m./p.m. information in the accident data. The light conditions may be cross-referenced between the originally reported lighting at the time of accident and synthesized lighting data. If the information matches in the morning, the time is kept as a.m., whereas if it matches in the evening, twelve hours may be added to move the timestamp into the p.m. range. Note that this strategy still maintains a bias for a.m. time because there can be more or less than twelve daylight hours, but the majority of daytime accidents are captured correctly. All timestamps in the resulting dataset are provided in twenty-four hour format to avoid future issues.

The sensor topology information is configured to (1) provide the previous (upstream) and next (downstream) sensors for each sensor, and (2) provide a geometry file that contains polygons that correspond to each road segment.

To generate the topology file, the radar sensor names are used which contain information about the road, heading, and mile marker. It is known that mile markers increase in travel direction for Northbound and Eastbound highways, and decrease for Southbound and Westbound highways. Based on this knowledge, the system can automatically generate most of the sensor topology. For instance, if there are two Northbound sensors at mile markers 2.0 and 2.5, with no sensors in between, they are considered neighbors. As Northbound traffic has increasing mile markers, 2.0 may be added as an upstream neighbor for 2.5, and 2.5 is added as a downstream sensor for 2.0. If these sensors were Southbound, the relationship would be reversed. There are two special cases. There may be no neighbors (end of detection range, or gap of more than 5 miles) and will leave the corresponding neighbor field empty. If there is more than one neighbor, as is the case at highway junctions, these neighborhoods may be resolved manually. One upstream neighbor, one downstream neighbor, and one neighbor may be defined or selected in the opposite travel direction. For the sensors with two neighbors, the system biases towards staying on the same road, or the direction with higher traffic volumes.

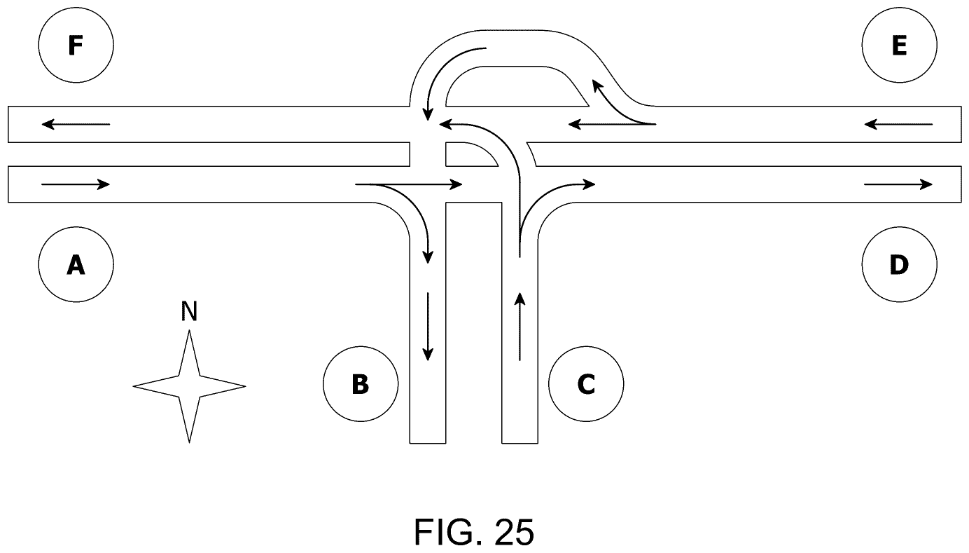

For example, consider the graphic in FIG. 25. Each sensor has either two visible upstream neighbors or two visible downstream neighbors. For sensors A, D, E, and F, one of the two neighbors is on the same road, which makes it a preferred neighbor. Sensor A has two downstream neighbors (B to the South, D to the East). As D is on the same road, it is a preferred neighbor. Sensor D has two upstream neighbors (A to the West, C to the South). As A is on the same road, it is a preferred neighbor. Sensor E has two downstream neighbors (B to the South, F to the West). As F is on the same road, it is a preferred neighbor. Sensor F has two upstream neighbors (C to the South, E to the East). As E is on the same road, it is a preferred neighbor. For sensors B and C, both visible neighbors are associated with a different road, so the decision of preferred neighbor must be made based on traffic volumes. Sensor B has two upstream neighbors (A from the West, E from the East). Sensor C has two downstream neighbors (D to the East, F to the West). The present solution is not limited to the particulars of this example.

The sensor topology file contains the columns summarized in TABLE 8.

TABLE 8
Description of the columns contained in the sensor topology CSV file.

| Column Name | Definition |
|---|---|
| Road | 5-character road name, buffered with leading zeros. |
| Mile | Nearest mile marker (0.1-mile precision). |
| Heading | Travel direction (single character for cardinal directions). |
| Name | Sensor name consisting of region code, road name, 5-character mile marker, |
| | and heading, E.g., R2G-00175-000.25 is a sensor located at mile marker 0.2 on |
| | 1-755. |
| Previous | Name of upstream sensor. |
| Next | Name of downstream sensor. |
| Opposite | Name of nearest sensor for opposite heading. |
| PrevDist, NextDist, OppoDist | Distance from previous/next/opposite sensor (in miles). |
| Latitude, Longitude | Geocoordinates. |

The Sensor Zones are polygons outlining each sensor's section of road for fast assignment of crashes to sensors. A GIS workflow may be created which maps individual sensor IDs to their relevant road geometry (e.g., using GDAL and QGIS software which are freely available open-source technologies). The workflow starts with the generic centerline geometry of individual highway segments and creates offset lines to represent two opposite driving directions. To further segment the space, Voronoi polygons may be created by using sensor locations as the Voronoi nodes. Each Voronoi polygon is a region of a plane that is closer to its Voronoi node (e.g., the sensor it corresponds to) than to any other sensor. Using these spatially partitioned polygons, the adjacent detection area of the sensors may be defined while avoiding the creation of overlapping detection areas between nearby sensors. Next, unidirectional highway line segments may be spatially clipped by using the boundary of the sensors' Voronoi polygons, and the sensor IDs may be mapped to these road segments. The resulting geometry may be saved as a GeoJSON file which contains the name of the corresponding sensor as one of its properties. Each polygon in the GeoJSON file may contain the properties listed in TABLE 9.

TABLE 9
Description of the properties associated with
each road segment in the GeojSON file.

| Property | Definition |
|---|---|
| RDS_Sensor | Sensor name. |
| NBR_LANES | Number of lanes. |
| SPD_LMT | Speed limit (mph). |
| uniqueID | Unique ID for the polygon. |

Finally, the tagged accident data is produced. This data consists of one file per accident (or non-accident). Each file contains the following types of columns summarized in TABLE 10.

TABLE 10
Contents of tagged accident data files.

| Column Type | Definition |
|---|---|
| Accident Status | A boolean signifies whether the event is an accident (i.e., 1) or a non-accident |
| | (i.e., 0). |
| Location Information | The road that the original accident occurred on and the mile marker it |
| | occurred at (e.g., 001755 and 4.8 if the original accident occurred near mile |
| | marker 4.8 on I-75 southbound) |
| Accident Information | The type of event (e.g., Prop Damage [over] for an accident with property |
| | damage over a predefined threshold). If the event is a non-accident, we set |
| | this column to None. |
| Accident Time | The event's date, time (e.g., 18:35) and hour (e.g., 18). These columns have the |
| | date/time/hour of the accident recorded in E-TRIMS, and they remain the same |
| | value for the entire file. |
| Traffic Data | The sensor data's time. This column contains the timestamp of the sensor data |
| | contained in each row. Triplets of speed(i), volume(i), and occupancy(i) for |
| | each sensor from 5 sensors upstream to 5 sensors downstream (e.g. |
| | speed(i − 5), volume(i − 5), occupancy(i − 5) . . ., speed(i), volume(i), occupancy(i), . . ., |
| | speed(i + 5), volume(i + 5), occupancy(i + 5)) from the data. |
| Environment | Weather and lighting conditions (e.g., Rain and Dusk). |

To create these files, the system first iterated over all events. For each event, a file is created with the attributes listed above. The first few columns (list items 1-4) are fixed for all time steps. The time is determined at which the event occurred (e.g., to illustrate, 18:35), and a list is created of the required time steps from X minutes (e.g., 15) before the event to X minutes after the given time. Because the system is unable to know the second at which the event occurred, it may use both thirty second time intervals for each minute, which results in sixty-two time steps (or rows) per file. For the illustrative event, this means that the system uses time steps from 18:20:00 to 18:50:30.

For the remaining columns (list items 5-7), the system collects information from multiple data sources. First, the system determines which sensor is closest to the event location by using a point-in-polygon test with the polygons from the geometry file. Next, the system determines the list of relevant sensors near the event by using the sensor topology information to find each sensor's upstream and downstream neighbors up to N (e.g., 5) hops away. The system sorts the sensors in the order the traffic passes them, starting at N sensors upstream, to the sensor nearest to the event, and continuing to N sensors downstream. For example, if N is five, then this gives a total of eleven sensors. For each of these sensors, the system aggregates speeds, volumes, and occupancies across all lanes. For vehicle speed and lane occupancy, the system may use the mean vehicle speed and lane occupancy across all lanes. If there were no vehicles, and no speed/occupancy was recorded, then the system sets the value to NaN. For volume, the system sums the vehicle counts across all lanes. If there were fewer than N sensors, or the data had gaps, then the corresponding cells remain empty. Finally, the system fetches the current weather and lighting data for each time step.

Referring again to FIG. 22, method 2200 continues with the operations of block 2212 which involve combining the accident data samples with the non-accident data samples to obtain the training dataset. The training dataset is used in block 2214 to train a machine learning model to detect patterns in test data indicating that a traffic accident has occurred on a particular segment of a road. The machine learning model can include, but is not limited to, a logistic regression classification model, a random forest classification model, an XGBoot classification model, or other machine learning classification model.

Next in block 2216, the system generates accident predictions using the trained machine learning model and test input data. The accident predictions are analyzed in block 2218 to obtain evaluation metrics. If the evaluation metrics meet a given criterion, then the trained machine learning model is implemented in the field as shown by block 2220. For example, if the evaluation metrics indicate that the trained machine learning model detected accidents with a threshold probability or likelihood, then the trained machine learning model may be implemented in the field. It should be noted that the trained machine learning model may be periodically or continuously further trained on new data while being implemented in the field.

Thereafter, the system obtains data in blocks 2222 and 2224. This data includes, but is not limited to, real time traffic flow data generated by roadside traffic sensors, weather data, and/or light data. This data is used in block 2226 of FIG. 22B as inputs to the trained machine learning model.

As shown in block 2228 of FIG. 22B, the system uses the output(s) of the machine learning model to determine whether there is likely or probably a traffic accident or indicant on a road segment (e.g., road segment S1, S2, . . . , or Sn of FIG. 21). This determination may be made, for example, by comparing a probability, likelihood or confidence value output from the trained machine learning model to one or more threshold values. If the probability, likelihood or confidence value exceeds a threshold value, then the system may determine that there is a likely or probably a traffic accident or incident on the road segment. If the probability, likelihood or confidence value is less than a threshold value, then the system may determine that there is likely or probably not a traffic accident or incident on the road segment. The present solution is not limited to particulars of this exemplary scenario.

When a determination is made that there is likely or probably not a traffic accident or incident on the road segment [2228:NO], method 2200 returns to 2222 of FIG. 22A as shown by block 2230. Otherwise [2228:YES], method 2200 continues to block 2231 where a robot (e.g., robot 2020 of FIG. 20) is dispatched and/or controlled. This is done to cause the robot to move to the road segment where the traffic accident or incident can be remotely monitored via sensor data collected by sensor(s) of the robot. The robot can include, but is not limited to, an unmanned vehicle. Movement of the robot can be autonomously performed, semi-autonomously performed, or performed under the control of an electronic control device (e.g., computing device 2008 of FIG. 20 and/or mobile device 2034 of FIG. 20) via wireless communications.

In block 2232, sensor data is optionally collected by the robot. This sensor data can include, but is not limited to, images, video streams, radar data, sounds, and/or heat maps. The sensor data may be optionally analyzed in block 2234 to validate an actual occurrence of the traffic accident or incident, and/or monitor the geographical area. When the traffic accident or incident occurrence is not validated [2236:NO], the machine learning model may be further trained with recent data as shown by block 2238. Otherwise [2236:YES], method 2200 continues to block 2240.

In block 2240, the system optionally automatically modifies content of a remote display to include a visual indicator of the detected accident/incident and the location of the closest roadside sensor. For example, the display may be part of a law enforcement system (e.g., law enforcement system 2022 of FIG. 20) and configured to display a map showing the locations of traffic accidents/incidents and/or other activities on or near roads (e.g., arterial(s) or road(s) 2002 of FIG. 20). The map may be updated to add a new visual indicator showing the geographic location or area at which the traffic accident or indicant is or has occurred. This map update may be automatically or autonomously performed by the system. The law enforcement, emergency response services, and/or robot(s) may optionally be dispatched to the accident/incident based on the modified content of the remote display, as shown by block 2242. This dispatching may also be automatically or autonomously performed by the system.

In block 2244, the system may optionally control operations of traffic signs and/or signals based on the location of the detected traffic accident or incident. Any known or to be known technique for controlling traffic signs and/or signals may be used here. The traffic signs and/or signals may be controlled to, for example, direct traffic to avoid or travel around the traffic accident or incident, or reduce speed to mitigate the risk of additional accidents.

In block 2246, the system may optionally perform operations to change a route of a vehicle and/or driving assistance device (e.g., Google maps and/or a GPS system). These operations can involve, for example, communicating command signals to an onboard computing device of the vehicle for modifying a current trajectory thereof or generating a new trajectory therefore. Any known technique for modifying and generating vehicle trajectories can be used here.

Subsequently, method 2200 continues to block 2248 where it ends or other operations are performed. For example, method 2200 may return to block 2202 of FIG. 22A.

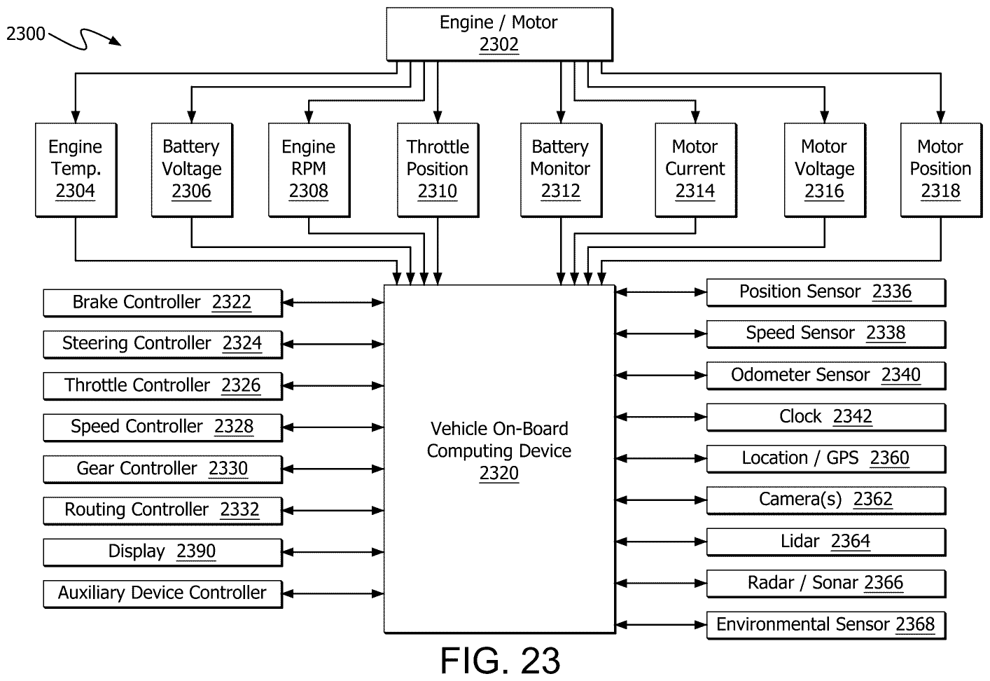

FIG. 23 provides an illustrative system architecture for a mobile platform 2300. Vehicle(s) 2330 of FIG. 20 and/or robot(s) 2020 of FIG. 20 can have the same or similar system architecture as that shown in FIG. 23. Thus, the following discussion of mobile platform 2300 is sufficient for understanding components(s) 2330, 2020 of FIG. 20.

Mobile platform 2300 includes an engine or motor 2302 and various sensors 2304-2318 for measuring various parameters of the mobile platform. The sensors may include, but are not limited to, an engine temperature sensor 2304, a battery voltage sensor 2306, an engine Rotations Per Minute (RPM) sensor 2308, a throttle position sensor 2310, a battery monitoring system 2312, a motor current sensor 2314, a motor voltage sensor 2316, and/or a motor position sensor (e.g., resolvers and encoders) 2318.

The mobile platform 2300 can also include, for example: a position sensor 2336 (e.g., an accelerometer, a gyroscope and/or an inertial measurement unit); a speed sensor 2338; and an odometer sensor 2340. The mobile platform 2300 may have a clock 2342 that the system uses to determine a time during operation.

The mobile platform 2300 may also include various sensors that operate to gather information about the environment in which the mobile platform is traveling. These sensors may include, for example: a location sensor 2348 (e.g., a Global Positioning System (GPS) device); image-based perception sensors such as one or more cameras 2362; and/or environmental sensors 2368 such as a precipitation sensor and/or ambient temperature sensor. The image-based perception sensors may enable the mobile platform to detect objects that are within a given distance range of the mobile platform 2300 in any direction, while the environmental sensors collect data about environmental conditions within the mobile platform's area of travel.

During operations, information is communicated from the sensors to the on-board computing device 2320. The on-board computing device 2320 can (i) cause the sensor information to be communicated from the mobile platform to an external device (e.g., computing device(s) 2008 of FIG. 20) and/or (ii) use the sensor information to control operations of the mobile platform. For example, the on-board computing device 2320 may control: braking via a brake controller 2322; direction via a steering controller 2324; speed and acceleration via a throttle controller 2326 (in a gas-powered vehicle) or a motor speed controller 2328 (such as a current level controller in an electric vehicle); a differential gear controller 2330 (in vehicles with transmissions); and/or other controllers. The on-board computing device 2320 may perform operations to cause the mobile platform 2300 to follow a given trajectory generated by a routing controller 2332 and/or perform a maneuver (e.g., brake, accelerate, or swerve) based on sensor data. Various information may be output via display 2390.

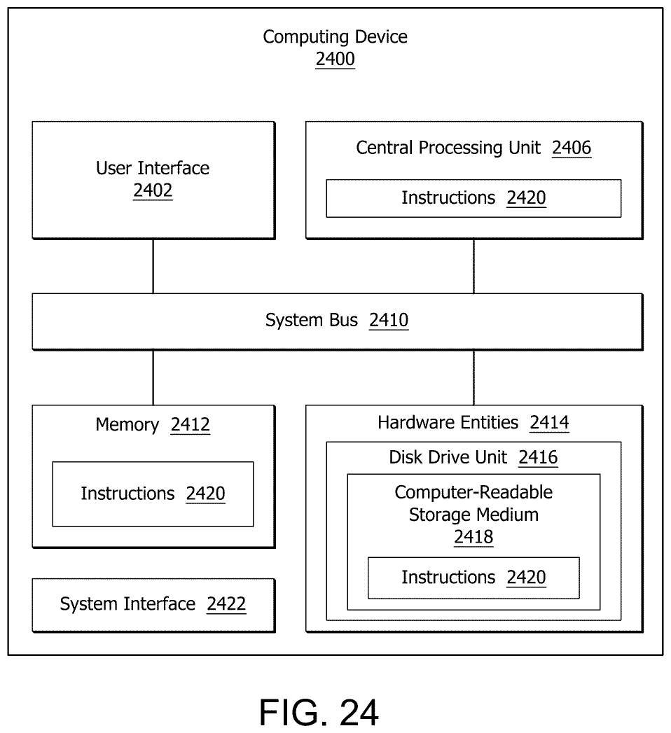

FIG. 24 provides a block diagram of an illustrative embodiment of a computing device 2400. Component(s) 2008, 2022, 2024, 2026, 2028, 2034 of FIG. 20 and/or component 2320 of FIG. 23 can be the same as or similar to computing device 2400. As such, the discussion of computing device 2400 is sufficient for understanding each of the listed devices.

Computing device 2400 can include, but is not limited to, a notebook, a desktop computer, a laptop computer, a personal digital assistant, a tablet PC, and/or a web server with an interface that is accessed from other network devices via a web application. Some or all the components of the computing device 2400 can be implemented as hardware, software and/or a combination of hardware and software. The hardware includes, but is not limited to, one or more electronic circuits.

Computing device 2400 may include more or less components than those shown in FIG. 24. However, the components shown are sufficient to disclose an illustrative embodiment implementing the present invention. The hardware architecture of FIG. 24 represents one embodiment of a representative computing device configured to facilitate control of traffic flow along arterials in an efficient manner. As such, the computing device 2400 of FIG. 24 implements improved methods for controlling traffic flow along arterials in accordance with embodiments of the present solution.

As shown in FIG. 24, computing device 2400 includes a system interface 2422, a user interface 2402, a central processing unit (CPU) 2406, a system bus 2410, a memory 2412 connected to and accessible by other portions of computing device 2400 through system bus 2410, and hardware entities 2414 connected to the system bus 2410. At least some of the hardware entities 2414 perform actions involving access to and use of memory 2412, which can be a random access memory (RAM), a disk driver and/or a universal serial bus (USB) drive.

System interface 2422 allows the computing device 2400 to communicate directly or indirectly with external communication devices. If the computing device 2400 is communicating indirectly with the external communication device, then the computing device 2400 is sending and receiving communications through a common network (e.g., the Internet or Intranet).

Hardware entities 2414 can include a disk drive unit 2416 comprising a computer-readable storage medium 2418 on which is stored one or more sets of instructions 2420 (e.g., software code) configured to implement one or more of the methodologies, procedures, or functions described herein. The instructions 2420 can also reside, completely or at least partially, within the memory 2412 and/or within the CPU 2406 during execution thereof by the computing device 2400. The memory 2412 and the CPU 2406 also can constitute machine-readable media. The term “machine-readable media”, as used here, refers to a single medium or multiple media (e.g., a centralized or distributed database, and/or associated caches and servers) that store the one or more sets of instructions 2420. The term “machine-readable media”, as used here, also refers to any medium that is capable of storing, encoding, or carrying a set of instructions 2420 for execution by the computing device 2400 and that cause the computing device 2400 to perform any one or more of the methodologies of the present disclosure.

As evident from the above discussion, the present solution concerns implementing systems and methods for training a machine learning model (e.g., machine learning classification model(s) 2014 of FIG. 20) for detecting traffic accidents and/or incidents. The methods comprise: obtaining, by a processor (e.g., computing device 2008 of FIG. 20 and/or central processing unit 2406 of FIG. 24), traffic flow data (e.g., traffic flow data 2050 of FIG. 20), traffic accident data (e.g., traffic accident data 2052 of FIG. 20) and topology data (e.g., topology data 2054 of FIG. 20) for roadside sensors (e.g., roadside sensors 2004 of FIG. 20); processing, by the processor, the traffic accident data and topology data to identify a number of roadside sensors that are closest to each traffic accident identified in the traffic accident data and obtain an order of the identified roadside sensors relative to a driving direction; fusing, by the processor, the traffic flow data, traffic accident data and topology data to produce accident data samples and non-accident data samples based on accident proximities to the roadside sensors (wherein each of the accident data samples and non-accident data samples comprises traffic flow data for ones of the roadside sensors that are neighboring sensors); combining, by the processor, the accident data samples and non-accident data samples to obtain a training dataset (e.g., training data 2056 of FIG. 20); and training, by the processor using the training dataset, the machine learning model for detecting patterns in input data indicating a probability or likelihood of a traffic accident or incident on a road segment (e.g., road segment S1, S2, . . . , or Sn of FIG. 21).

The methods may also comprise: obtaining weather data and/or light data; and fusing the weather data and/or light data with the traffic flow data, traffic accident data and topology data to obtain the accident data samples and non-accident data samples.

The traffic flow data can include, but is not limited to, vehicle speed, traffic volume, and lane occupancy. The machine learning model can include, but is not limited to, a logistic regression classifier, a random forest classifier, or an XBoost classifier.

The methods may further comprise: obtaining real time traffic flow data generated by the roadside sensors; inputting the real time traffic flow data into the trained machine learning model; determining whether there is likely or probably a traffic accident or incident on a road segment based on an output of the trained machine learning model; and/or selecting an action from a plurality of defined action that can be taken based on results of the determining. The defined actions can include, but are not limited to, dispatching a robot to a traffic accident or incident location, controlling movement of the robot, and or controlling operations of the robot to collect sensor data at the traffic accident or incident location. The methods may comprise: validating an actual occurrence of the traffic accident or incident based on the sensor data collected by the robot; and/or training the machine learning model using a new training dataset when the actual occurrence of the traffic accident or incident is not validated.

The present solution also concerns systems comprising: a processor; and a non-transitory computer-readable storage medium comprising programming instructions that are configured to cause the processor to implement a method for training a machine learning model for detecting traffic accidents. The programming instructions may comprise instructions to: obtain traffic flow data, traffic accident data and topology data for roadside sensors; process the traffic accident data and topology data to identify a number of roadside sensors that are closest to each traffic accident identified in the traffic accident data and obtain an order of the identified roadside sensors relative to a driving direction; fuse the traffic flow data, traffic accident data and topology data to produce accident data samples and non-accident data samples based on accident proximities to the roadside sensors (wherein each of the accident data samples and non-accident data samples comprises traffic flow data for ones of the roadside sensors that are neighboring sensors); combine the accident data samples and non-accident data samples to obtain a training dataset; and train, using the training dataset, the machine learning model for detecting patterns in input data indicating a probability or likelihood of a traffic accident or incident on a road segment.

The programming instructions may also comprise: instructions to obtain weather data and/or light data; and fuse the weather data and/or light data with the traffic flow data, traffic accident data and topology data to obtain the accident data samples and non-accident data samples.

Additionally or alternatively, the programming instructions may also comprise instructions to: obtain real time traffic flow data generated by the roadside sensors; input the real time traffic flow data into the trained machine learning model; determine whether there is likely or probably a traffic accident or incident on a road segment based on an output of the trained machine learning model; and select an action from a plurality of defined action that can be taken based on results of the determination as to whether there is likely or probably a traffic accident or incident on a road segment. The defined actions can include, but are not limited to, one or more of dispatching a robot to a traffic accident or incident location, controlling movement of the robot, and controlling operations of the robot to collect sensor data at the traffic accident or incident location.

Additionally or alternatively, the programming instructions may also comprise instructions to: validate an actual occurrence of the traffic accident or incident based on the sensor data collected by the robot; and/or train the machine learning model using a new training dataset when the actual occurrence of the traffic accident or incident is not validated.

The present solution also concerns a system (e.g., system 2000 of FIG. 20 and/or computing device 2008 of FIG. 20) for detecting traffic accidents along arterials (e.g., arterials 2002 of FIG. 20). The system comprises training circuitry (e.g., training module(s) 2012 of FIG. 20) configured to: obtain traffic-condition signals including traffic flow data (e.g., traffic flow data 2050 of FIG. 20) produced over a training time interval by sensors (e.g., roadside sensors 2004 of FIG. 5) that were within corresponding segments (e.g., segments S1, S2, . . . , Sn of FIG. 21) of the arterials during the training time interval; obtain spatiotemporal information (e.g., traffic accident data 2052 of FIG. 20) for accidents that have been detected along the arterials during the training time interval; and train a classification model (e.g., machine learning classification model 2014 of FIG. 20) for predicting whether traffic conditions at a given time and at a given segment of the arterials are associated with a traffic accident detection at the given time and at the given segment. The training comprises correlating each of the traffic accidents detected at a respective time and a respective segment to traffic-condition signals produced by some of the sensors that were, at the time, within the traffic accident's segment and a predetermined number of segments upstream and downstream therefrom.

The system also comprises a data processing apparatus (e.g., data processing module(s) 2010 of FIG. 20) communicatively coupled to the training circuitry (e.g., training module(s) 2012 of FIG. 20). The data processing apparatus is configured to: monitor current traffic-condition values produced by the sensors that are within corresponding segments of the arterials; access the trained classification model and selectively detect a traffic accident within a segment of the arterials by applying the trained classification model to the current traffic-condition values; and perform a corrective action in response to detecting the traffic accident.

The classification model can include, but is not limited to, an XGBoost classification model, a logistic regression classification model, or a random forest classification model. The predetermined number of upstream or downstream segments may be, for example, is in a range of three to six, one to ten, or any other range selected in accordance with a given application.

The traffic conditions can include, but is not limited to, traffic speed, traffic volume, lane occupancy, intersection performance, weather conditions, and/or light conditions. The sensors comprise one or more of radar detection sensors, or loop detectors. The sensors that produce (i) the traffic-condition signals during the training time interval and (ii) the current traffic-condition values may be onboard vehicles traveling along corresponding segments of the arterials. The onboard sensors may comprise one or more of GPS devices, mobile sensing apps, or IoT-connected cameras. The sensors may be configured to produce (i) the traffic-condition signals during the training time interval and (ii) the current traffic-condition values with a predetermined temporal resolution. The predetermined temporal resolution may be in a range of 0.5 to 5 seconds. The corrective action may comprises one or more of dispatching medical, fire fighting, and law enforcement resources to the segment associated with the detected accident, or rerouting drivers from the segment associated with the detected accident to accident-free segments.

The terms “processor” and “processing device” refer to a hardware component of an electronic device that is configured to execute programming instructions. Except where specifically stated otherwise, the singular terms “processor” and “processing device” are intended to include both single-processing device embodiments and embodiments in which multiple processing devices together or collectively perform a process.

The terms “memory,” “memory device,” “computer-readable medium,” “data store,” “data storage facility” and the like each refer to a non-transitory device on which computer-readable data, programming instructions or both are stored. Except where specifically stated otherwise, the terms “memory,” “memory device,” “computer-readable medium,” “data store,” “data storage facility” and the like are intended to include single device embodiments, embodiments in which multiple memory devices together or collectively store a set of data or instructions, as well as individual sectors within such devices. A computer program product is a memory device with programming instructions stored on it.

As used in this document, the singular form “a”, “an”, and “the” include plural references unless the context clearly dictates otherwise. Unless defined otherwise, all technical and scientific terms used herein have the same meanings as commonly understood by one of ordinary skill in the art. As used in this document, the term “comprising” means “including, but not limited to”.

The described features, advantages and characteristics disclosed herein may be combined in any suitable manner. One skilled in the relevant art will recognize, in light of the description herein, that the disclosed systems and/or methods can be practiced without one or more of the specific features. In other instances, additional features and advantages may be recognized in certain scenarios that may not be present in all instances.

Although the systems and methods have been illustrated and described with respect to one or more implementations, equivalent alterations and modifications will occur to others skilled in the art upon the reading and understanding of this specification and the annexed drawings. In addition, while a particular feature may have been disclosed with respect to only one of several implementations, such feature may be combined with one or more other features of the other implementations as may be desired and advantageous for any given or particular application. Thus, the breadth and scope of the disclosure herein should not be limited by any of the above descriptions. Rather, the scope of the invention should be defined in accordance with the following claims and their equivalents.

What is claimed is:

1. A method for training a machine learning model for detecting traffic accidents, comprising:
obtaining, by a processor, traffic flow data, traffic accident data and topology data for roadside sensors;
processing, by the processor, the traffic accident data and topology data to identify a number of roadside sensors that are closest to each traffic accident identified in the traffic accident data and obtain an order of the identified roadside sensors relative to a driving direction;
fusing, by the processor, the traffic flow data, traffic accident data and topology data to produce accident data samples and non-accident data samples based on accident proximities to the roadside sensors, wherein each of the accident data samples and non-accident data samples comprises traffic flow data for ones of the roadside sensors that are neighboring sensors;
combining, by the processor, the accident data samples and non-accident data samples to obtain a training dataset; and
training, by the processor using the training dataset, the machine learning model for detecting patterns in input data indicating a probability or likelihood of a traffic accident or incident on a road segment.

2. The method according to claim 1, further comprising obtaining weather data, and fusing the weather data with the traffic flow data, traffic accident data and topology data to obtain the accident data samples and non-accident data samples.

3. The method according to claim 1, further comprising obtaining light data, and fusing the light data with the traffic flow data, traffic accident data and topology data to obtain the accident data samples and non-accident data samples.

4. The method according to claim 1, wherein the traffic flow data comprises vehicle speed, traffic volume, and lane occupancy.

5. The method according to claim 1, wherein the machine learning model comprises a logistic regression classifier, a random forest classifier, or an XBoost classifier.

6. The method according to claim 1, further comprising:
obtaining real time traffic flow data generated by the roadside sensors;
inputting the real time traffic flow data into the trained machine learning model; and
determining whether there is likely or probably a traffic accident or incident on a road segment based on an output of the trained machine learning model.

7. The method according to claim 6, further comprising selecting an action from a plurality of defined action that can be taken based on results of the determining.

8. The method according to claim 7, wherein the defined actions comprise one or more of dispatching a robot to a traffic accident or incident location, controlling movement of the robot, and controlling operations of the robot to collect sensor data at the traffic accident or incident location.

9. The method according to claim 8, further comprising validating an actual occurrence of the traffic accident or incident based on the sensor data collected by the robot.

10. The method according to claim 9, further comprising training the machine learning model using a new training dataset when the actual occurrence of the traffic accident or incident is not validated.

11. A system, comprising:
a processor; and
a non-transitory computer-readable storage medium comprising programming instructions that are configured to cause the processor to implement a method for training a machine learning model for detecting traffic accidents, wherein the programming instructions comprise instructions to:
obtain traffic flow data, traffic accident data and topology data for roadside sensors;
process the traffic accident data and topology data to identify a number of roadside sensors that are closest to each traffic accident identified in the traffic accident data and obtain an order of the identified roadside sensors relative to a driving direction;
fuse the traffic flow data, traffic accident data and topology data to produce accident data samples and non-accident data samples based on accident proximities to the roadside sensors, wherein each of the accident data samples and non-accident data samples comprises traffic flow data for ones of the roadside sensors that are neighboring sensors;
combine the accident data samples and non-accident data samples to obtain a training dataset; and
train, using the training dataset, the machine learning model for detecting patterns in input data indicating a probability or likelihood of a traffic accident or incident on a road segment.

12. The system according to claim 11, wherein the programming instructions further comprise instructions to obtain weather data, and fuse the weather data with the traffic flow data, traffic accident data and topology data to obtain the accident data samples and non-accident data samples.

13. The system according to claim 11, wherein the programming instructions further comprise instructions to obtain light data, and fuse the light data with the traffic flow data, traffic accident data and topology data to obtain the accident data samples and non-accident data samples.

14. The system according to claim 11, wherein the traffic flow data comprises vehicle speed, traffic volume, and lane occupancy.

15. The system according to claim 11, wherein the machine learning model comprises a logistic regression classifier, a random forest classifier, or an XBoost classifier.

16. The system according to claim 11, wherein the programming instructions further comprise instructions to:
obtain real time traffic flow data generated by the roadside sensors;
input the real time traffic flow data into the trained machine learning model; and
determine whether there is likely or probably a traffic accident or incident on a road segment based on an output of the trained machine learning model.

17. The system according to claim 16, wherein the programming instructions further comprise instructions to select an action from a plurality of defined action that can be taken based on results of the determination as to whether there is likely or probably a traffic accident or incident on a road segment.

18. The system according to claim 17, wherein the defined actions comprise one or more of dispatching a robot to a traffic accident or incident location, controlling movement of the robot, and controlling operations of the robot to collect sensor data at the traffic accident or incident location.

19. The system according to claim 18, wherein the programming instructions further comprise instructions to validate an actual occurrence of the traffic accident or incident based on the sensor data collected by the robot.

20. The system according to claim 19, wherein the programming instructions further comprise instructions to retrain the machine learning model using an updated dataset when the actual occurrence of the traffic accident or incident is reported.

21. The system according to claim 20, wherein reinforcement learning is used to retrain the machine learning model.
